(19) United States
(12) Patent Application Publication
(10) Pub. No.: US 2016/0081385 A1
(43) Pub. Date: Mar. 24, 2016

(54) PROCESS

(71) Applicant: DUPONT NUTRITION BIOSCIENCES APS, Copenhagen (DK)

(72) Inventors: Liv Spangner Christiansen, Frederiksberg (DK); Jorn Borch Soe, Tilst (DK); Jesper Kampp, Skanderborg (DK)

(21) Appl. No.: 14/859,919

(22) Filed: Sep. 21, 2015

Related U.S. Application Data
(63) Continuation of application No. 12/906,439, filed on Oct. 18, 2010.
Application No. 12/906,439 is a continuation-in-part of application No. PCT/IB2009/005440, filed on Apr. 8, 2009.

(30) Foreign Application Priority Data
Apr. 18, 2008 (GB) 0807161.5

(51) Int. Cl. A23L 1/314; A23L 1/317

(52) U.S. Cl. CPC A23L 1/3149; A23L 1/3175; A23V 2002/00

(57) ABSTRACT

A method for reducing the amount of cholesterol and/or improving the texture and/or reducing weight loss and/or increasing the fat stability of a meat based food product comprising: a) contacting meat with a lipid acyltransferase; b) incubating the meat contacted with the lipid acyltransferase at a temperature between about 1° C. to about 70° C.; c) producing a food product from the meat; wherein step b) is conducted before, during or after step c). Use of a lipid acyltransferase to reduce cholesterol in a meat based food product.

### REFERENCE TO RELATED APPLICATIONS

This application is a continuation of U.S. application Ser. No. 12/906,439 filed Oct. 18, 2010, which is a continuation-in-part application of international patent application Serial No. PCT/IB2009/005440 filed Apr. 8, 2009, which published as PCT Publication No. WO 2009/127969 on Oct. 22, 2009, which claims benefit of United Kingdom patent application Serial No. GB 0807161.5 filed Apr. 18, 2008.

Reference is made to the following related applications: US 2002-0009518, US 2004-0091574, WO2004/064537, WO2004/064987, WO2005/066347, WO2005/066351, U.S. Application Ser. No. 60/764,430 filed on 2 Feb. 2006, WO2006/008508, International Patent Application Number PCT/IB2007/000558, U.S. application Ser. No. 11/671,953, GB 0716126.8, GB 0725035.0, U.S. Ser. No. 11/852,274, and PCT/GB2008/000676.

Each of these applications and each of the documents cited in each of these applications (“application cited documents”), and each document referenced or cited in the application cited documents, either in the text or during the prosecution of those applications, as well as all arguments in support of patentability advanced during such prosecution, are hereby incorporated herein by reference. Various documents are also cited in this text (“herein cited documents”). Each of the herein cited documents, and each document cited or referenced in the herein cited documents, is hereby incorporated herein by reference, and may be employed in the practice of the invention.

### FIELD OF THE PRESENT INVENTION

The present invention relates to methods of reducing the cholesterol content of and/or improving the properties of a meat based food product using a lipid acyltransferase and meat based food products derived therefrom.

### BACKGROUND OF THE PRESENT INVENTION

In the production of meat and sausage products, one of the major aims is to emulsify added fat and to bind, or immobilize, added water with activated protein from the meat matrix. As an example, the manufacturing technology of cooked sausages involves the impact of mechanical energy and additives, such as phosphates and salt, which activate the released protein. The end result should be a homogeneous, finely cut, smooth-textured product which can withstand treatment without separation of fat or water, showing firm texture and good bite (Feiner 2006 Meat products handbook. CRC Press, 239-312).

If the technological measures responsible for forming and stabilizing the emulsion of the meat product, i.e. quality fluctuations of the raw material (e.g. Pale, Soft, Exudative (PSE) and Dark, Firm, Dry (DFD) meat), recipe, processing conditions, such as time and temperature, are not properly observed, unstable products may be produced that no longer meet consumer demands (Fischer et al., 1991 Finely comminuted liver sausage—How the normal commercial emulsifiers work. Fleischwirtsch 71, 780-783).

Emulsifiers are used in the processing of meat and sausages to compensate for these quality fluctuations in the raw meat material, thereby securing consistent end product quality and facilitating the technical processes involved in the industrial production (Nau & Adams, 1992 Emulsifiers for use in sausage and meat products. Food marketing & technology June, 13-20.).

In emulsified meat products with a considerable fat content, e.g. fine paste sausages and pâtés, it is desirable to have fat stability so that fat losses are minimized and the amount of visible fat is reduced. Additionally, it is desirable that the loss of meat juice is low, and that the taste, texture and appearance are acceptable. Emulsifiers may be added to achieve these effects, and some of the most commonly known are isolated protein or protein concentrates like soy protein or Na-caseinate. However, these proteins are characterized by being relatively expensive and quantities allowed in meat products are limited. Additives, such as mono and di-glycerides and citric acid esters, can also be used as emulsifiers (Varnam & Sutherland, 1995 Meat and meat products. Technology, chemistry and microbiology. Chapman & Hall Vol 3, 244-250), but their application is often unwanted due to price or labelling (i.e. not having additives on the meat product label).

Enzymes are known to be advantageous in food applications. For example, lipid acyltransferases have been found to have significant acyltransferase activity in foodstuffs. This activity has surprising beneficial applications in methods of preparing foodstuffs (see for example WO2004/064537.

In the preparation of meat based food products the use of some enzymes may be disadvantageous as the treatment with the enzyme must take place at between about 10° C. to about 55° C. otherwise the enzyme may be deactivated or not working optimally. However at these temperatures the main spoilage bacteria, pathogens and fungi can proliferate. Therefore, it may be desirable to find a solution to problems associated with taste, texture and appearance which reduces the proliferation of spoilage bacteria, pathogens and fungi in the meat based food product during processing.

From meat consumption and cholesterol content data, it has been estimated that one third to one half of the daily recommended cholesterol intake is provided by meat (Chizzolini et al., 1999 Calorific value and cholesterol content of normal and low-fat meat and meat products. Trends in food science and technology, 10, 119-128).

One aim of the present invention is to reduce cholesterol in meat based food products. Alternatively or in addition to the reduction in cholesterol, maintenance and/or improvement of one or more of the following characteristics is desirable: fat stability so that fat losses are minimized and the amount of visible fat is reduced in meat based food products; taste, texture, weight loss and appearance.

An alternative aim is to prepare meat based food products with a reduced potential for the proliferation of spoilage bacteria, pathogens and fungi.

Citation or identification of any document in this application is not an admission that such document is available as prior art to the present invention.

### SUMMARY ASPECTS OF THE PRESENT INVENTION

Aspects of the present invention are presented in the claims and in the following commentary.

It has surprisingly been found that by adding a lipid acyltransferase to meat for preparing a meat based food product a significant reduction in the cholesterol content of the meat based food product can be achieved. In addition it has been surprisingly found that the reduction in cholesterol content of the meat based food product can be achieved without any adverse effect on one or more of the following: texture, weight loss, fat stability (including greasiness and/or reduced fat separation during thermal processing), taste and appearance.

Even more surprisingly it has been found that by adding a lipid acyltransferase to meat for preparing a meat based food product a significant reduction in the cholesterol content of the meat based food product can be achieved as well one or more of the following: improved texture; reduced weight loss, increased fat stability (including reduced greasiness and/or reduced fat separation during thermal processing), taste and appearance.

Even more surprisingly it has been found that by adding a lipid acyltransferase to meat for preparing a meat based food product the meat can be processed at a low temperature (e.g. less than 10° C.) or at higher temperatures (e.g. above 65° C.)—thus at temperatures which are less likely to lead to the proliferation of spoilage bacteria, pathogens and fungi. Thus this may lead to a reduced loading of spoilage bacteria, pathogens and/or fungi in the final meat based food product.

In one embodiment the present invention provides a method of producing a meat based food product comprising:
(a) contacting meat with a lipid acyltransferase;
(b) incubating the meat contacted with the lipid acyltransferase at a temperature between about 1° C. to about 75° C.;
(c) producing a food product from the meat;
wherein step (b) is conducted before, during or after step (c).

In another embodiment the present invention provides a method for reducing the cholesterol content and/or improving one or more characteristic (such as one or more of the following: improving texture and/or reducing weight loss and/or increasing fat stability and/or improving taste and/or improving the appearance) of a meat based food product comprising:
(a) contacting meat with a lipid acyltransferase;
(b) incubating the meat contacted with the lipid acyltransferase at a temperature between about 1° C. to about 75° C.;
(c) producing a food product from the meat;
wherein step (b) is conducted before, during or after step (c).

In a yet further embodiment the present invention provides the use of a lipid acyltransferase for producing a meat based food product.

In a yet further embodiment the present invention provides the use of a lipid acyltransferase for producing a meat based food product wherein the technical effect is a reduction in the amount of cholesterol in the meat based food product compared with a comparative meat based food product where the meat had not been treated with the lipid acyltransferase.

In a yet further embodiment the present invention provides the use of a lipid acyltransferase for producing a meat based food product wherein the technical effect is a reduction in the amount of cholesterol in the meat based food product compared with a comparative meat based food product where the meat had not been treated with the lipid acyltransferase and/or one or more of the following: an improvement in the texture and/or a reduction in weight loss and/or an increased fat stability and/or an improved taste and/or an improved appearance of the meat based food product compared with a comparative meat based food product where the meat has not been treated with the lipid acyltransferase.

In a further embodiment of the present invention there is provided a cholesterol reduced or a cholesterol free meat based food product comprising at least 30% meat and an inactivated lipid acyltransferase.

The present invention also provides a meat based food product obtainable (e.g. obtained) by the method according to the present invention.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

### BRIEF DESCRIPTION OF DRAWINGS

The detailed description, given by way of example, but not intended to limit the invention solely to the specific embodiments described, may best be understood in conjunction with the accompanying drawings, in which:

FIG. 1 shows the amino acid sequence of a mutant Aeromonas salmonicida mature lipid acyltransferase (GCAT) with a mutation of Asn80Asp (notably, amino acid 80 is in the mature sequence) (SEQ ID No. 15);

FIG. 2 shows an amino acid sequence (SEQ ID No. 1) a lipid acyl transferase from Aeromonas hydrophila (ATCC #7965);

FIG. 3 shows a pfam00657 consensus sequence from database version 6 (SEQ ID No. 2);

FIG. 4 shows an amino acid sequence (SEQ ID No. 3) obtained from the organism Aeromonas hydrophila (P10480; GI:121051);

FIG. 5 shows an amino acid sequence (SEQ ID No. 4) obtained from the organism Aeromonas salmonicida (AAG098404; GI:9964017);

FIG. 6 shows an amino acid sequence (SEQ ID No. 5) obtained from the organism Streptomyces coelicolor A3(2) (Genbank accession number NP_631558);

FIG. 7 shows an amino acid sequence (SEQ ID No. 6) obtained from the organism Streptomyces coelicolor A3(2) (Genbank accession number: CAC42140);

FIG. 8 shows an amino acid sequence (SEQ ID No. 7) obtained from the organism Saccharomyces cerevisiae (Genbank accession number P41734);

FIG. 9 shows an amino acid sequence (SEQ ID No. 8) obtained from the organism Ralstonia (Genbank accession number: AL646052);

FIG. 10 shows SEQ ID No. 9. Scoe1 NCBI protein accession code CAB39707.1 GI:4539178 conserved hypothetical protein [Streptomyces coelicolor A3(2)];

FIG. 11 shows an amino acid shown as SEQ ID No. 10. Scoe2 NCBI protein accession code CAC01477.1 GI:9716139 conserved hypothetical protein [Streptomyces coelicolor A3(2)];

FIG. 12 shows an amino acid sequence (SEQ ID No. 11) Scoe4 NCBI protein accession code CAB89450.1 GI:7672261 putative secreted protein. [Streptomyces coelicolor A3 (2)];

FIG. 13 shows an amino acid sequence (SEQ ID No. 12) Scoe5 NCBI protein accession code CAB62724.1 GI:6562793 putative lipoprotein [Streptomyces coelicolor A3(2)];

FIG. 14 shows an amino acid sequence (SEQ ID No. 13) Srim1 NCBI protein accession code AAK84028.1 GI:15082088 GDSL-lipase [Streptomyces rimosus];

FIG. 15 shows an amino acid sequence (SEQ ID No. 14) of a lipid acyltransferase from Aeromonas salmonicida subsp. Salmonicida (ATCC#14174);

FIG. 16 shows a nucleotide sequence (SEQ ID No. 16) encoding an enzyme from Aeromonas hydrophila including a xylanase signal peptide;

FIG. 17 shows an amino acid sequence (SEQ ID No. 17) of the fusion construct used for mutagenesis of the Aeromonas hydrophila lipid acyltransferase gene. The underlined amino acids is a xylanase signal peptide;

FIG. 18 shows a polypeptide of a lipid acyltransferase enzyme from Corynebacterium efficiens GDSx 300 amino acid (SEQ ID No. 18);

FIG. 19 shows an amino acid sequence (SEQ ID No. 19) obtained from the organism Aeromonas hydrophila (P10480; GI:121051) (notably, this is the mature sequence);

FIG. 20 shows the amino acid sequence (SEQ ID No. 20) of an Aeromonas salmonicida mature lipid acyltransferase (GCAT) (notably, this is the mature sequence);

FIG. 21 shows a nucleotide sequence (SEQ ID No. 21) from Streptomyces thermosacchari;

FIG. 22 shows an amino acid sequence (SEQ ID No. 22) from Streptomyces thermosacchari;

FIG. 23 shows an amino acid sequence (SEQ ID No. 23) from Thermobifida fusca/GDSx 548 amino acid;

FIG. 24 shows an amino acid sequence (SEQ ID No. 24) from Corynebacterium efficiens/GDSx 300 amino acid;

FIG. 25 shows a nucleotide sequence (SEQ ID No. 25) from Corynebacterium efficiens;

FIG. 26 shows an alignment of the L131 and homologues from S. avermitilis and T. fusca illustrates that the conservation of the GDSx motif (GDSY in L131 and S. avermitilis and T. fusca), the GANDY box, which is either GGNDA or GGNDL, and the HPT block (considered to be the conserved catalytic histidine). These three conserved blocks are highlighted;

FIG. 27 shows a ribbon representation of the 1IVN.PDB crystal structure which has glycerol in the active site. The Figure was made using the Deep View Swiss-PDB viewer;

FIG. 28 shows 1IVN.PDB Crystal Structure—Side View using Deep View Swiss-PDB viewer, with glycerol in active site—residues within 10 \acute{Å} of active site glycerol are coloured black;

FIG. 29 shows 1IVN.PDB Crystal Structure—Top View using Deep View Swiss-PDB viewer, with glycerol in active site—residues within 10 \acute{Å} of active site glycerol are coloured black;

FIG. 30 shows alignment 1;

FIG. 31 shows alignment 2;

FIGS. 32A-B and 33 show an alignment of 1IVN to P10480 (P10480 is the database sequence for A. hydrophila enzyme), this alignment was obtained from the PFAM database and used in the model building process;

FIG. 34 shows an alignment where P10480 is the database sequence for Aeromonas hydrophila. This sequence is used for the model construction and the site selection. Note that the full protein (SEQ ID No. 3) is depicted, the mature protein (equivalent to SEQ ID No. 19) starts at residue 19. A. sal is Aeromonas salmonicida (SEQ ID No. 4) GDSX lipase, A. hyd is Aeromonas hydrophila (SEQ ID No. 19) GDSX lipase. The consensus sequence contains a * at the position of a difference between the listed sequences;

FIG. 35 shows a gene construct used in Example 1;

FIG. 36 shows a codon optimized gene construct (No. 052907) used in Example 1; and

FIG. 37 shows the sequence of the XhoI insert containing the LAT-KLM3′ precursor gene, the -35 and -10 boxes are underlined;

FIG. 38 shows BML780-KLM3′CAP50 (comprising SEQ ID No. 15—upper colony) and BML780 (the empty host strain—lower colony) after 48 h growth at 37° C. on 1% tributyrin agar;

FIG. 39 shows a nucleotide sequence from Aeromonas salmonicida (SEQ ID No. 26) including the signal sequence (preLAT—positions 1 to 87);

FIG. 40 shows a nucleotide sequence (SEQ ID No. 27) encoding a lipid acyl transferase according to the present invention obtained from the organism Aeromonas hydrophila;

FIG. 41 shows a nucleotide sequence (SEQ ID No. 28) encoding a lipid acyl transferase according to the present invention obtained from the organism Aeromonas salmonicida;

FIG. 42 shows a nucleotide sequence (SEQ ID No. 29) encoding a lipid acyl transferase according to the present invention obtained from the organism Ralstonia;

FIG. 43 shows a nucleotide sequence shown as SEQ ID No. 30 encoding NCBI protein accession code CAB39707.1 GI:4539178 conserved hypothetical protein [Streptomyces coelicolor A3 (2)];

FIG. 44 shows a nucleotide sequence shown as SEQ ID No. 31 encoding Scoe2 NCBI protein accession code CAC01477.1 GI:9716139 conserved hypothetical protein [Streptomyces coelicolor A3(2)];

FIG. 45 shows a nucleotide sequence shown as SEQ ID No. 32 encoding Scoe4 NCBI protein accession code CAB89450.1 GI:7672261 putative secreted protein. [Streptomyces coelicolor A3 (2)];

FIG. 46 shows a nucleotide sequence shown as SEQ ID No. 33, encoding Scoe5 NCBI protein accession code CAB62724.1 GI:6562793 putative lipoprotein [Streptomyces coelicolor A3 (2)];

FIG. 47 shows a nucleotide sequence shown as SEQ ID No. 34 encoding Srim1 NCBI protein accession code AAK84028.1 GI:15082088 GDSL-lipase [Streptomyces rimosus];

FIG. 48 shows a nucleotide sequence (SEQ ID No. 35) encoding a lipid acyltransferase from Aeromonas hydrophile (ATCC #7965);

FIG. 49 shows a nucleotide sequence (SEQ ID No 36) encoding a lipid acyltransferase from Aeromonas salmonicida subsp. Salmonicida (ATCC#14174);

FIG. 50 shows the amino acid sequence of a mutant Aeromonas salmonicida mature lipid acyltransferase (GCAT) with a mutation of Asn80Asp (notably, amino acid 80 is in the mature sequence)—shown herein as SEQ ID No. 15—and after undergoing post-translational modification as SEQ ID No. 37. The post-translational modification of the mature polypeptide SEQ ID No. 15 comprises cleavage at position 235-A to (and including) position 273-R. 38 amino acids are therefore missing. -amino acid residues 235 and 236 of SEQ ID No. 37 are not covalently linked following post-translational modification. The two peptides formed are held together by one or more S-S bridges. Amino acid 236 in SEQ ID No. 37 corresponds with the amino acid residue number 274 in SEQ ID No. 15 shown herein;

FIG. 51 shows a nucleotide sequence (SEQ ID No. 38) encoding a lipid acyl transferase according to the present invention obtained from the organism Streptomyces coelicolor A3(2) (Genbank accession number NC 003888.1:8327480 . . . 8328367);

FIG. 52 shows a nucleotide sequence (SEQ ID No. 39) encoding a lipid acyl transferase according to the present invention obtained from the organism Streptomyces coelicolor A3(2) (Genbank accession number AL939131.1:265480 . . . 266367);

FIG. 53 shows a nucleotide sequence (SEQ ID No. 40) encoding a lipid acyl transferase according to the present invention obtained from the organism Saccharomyces cerevisiae (Genbank accession number Z75034);

FIG. 54 shows an amino acid sequence (SEQ ID No. 41) Scoe3 NCBI protein accession code CAB88833.1 GI:7635996 putative secreted protein. [Streptomyces coelicolor A3 (2)];

FIG. 55 shows SEQ ID No 42 which is the amino acid sequence of a lipid acyltransferase from Candida parapsilosis;

FIG. 56 shows a polypeptide sequence of a lipid acyltransferase enzyme from Thermobifida (SEQ ID No. 43);

FIG. 57 shows a polypeptide of a lipid acyltransferase enzyme from Novosphingobium aromaticivorans 284 amino acid (SEQ ID No. 44);

FIG. 58 shows a polypeptide of a lipid acyltransferase enzyme from Streptomyces coelicolor 268 aa (SEQ ID No. 45);

FIG. 59 shows a polypeptide of a lipid acyltransferase enzyme from Streptomyces avermitilis \ GDSx 269 amino acid (SEQ ID No. 46);

FIG. 60 shows a nucleotide sequence (SEQ ID No. 47) from Thermobifida fusca;

FIG. 61 shows a nucleotide sequence (SEQ ID No. 48) from S. coelicolor;

FIG. 62 shows an amino acid sequence (SEQ ID No. 49) from S. avermitilis;

FIG. 63 shows a nucleotide sequence (SEQ ID No. 50) from S. avermitilis;

FIG. 64 shows a nucleotide sequence (SEQ ID No. 51) from Thermobifida fusca/GDSx;

FIG. 65 shows a nucleotide sequence shown as SEQ ID No. 52 encoding Scoe3 NCBI protein accession code CAB88833.1 GI:7635996 putative secreted protein. [Streptomyces coelicolor A3 (2)];

FIG. 66 shows an amino acid sequence (SEQ ID No. 53) from Thermobifida fusca/;

FIG. 67 shows a schematic of the reaction catalyzed by a lipid acyltransferase with phosphatidylcholine and cholesterol as substrates

FIG. 68 shows texture measurements of fine paste meat batter incubated at 40° C. for 1 hr (see darker block) or at 2° C. for 20 hrs (see lighter block) followed by heat treatment at 75° C. for 1 hr; wherein #1) is a control without enzyme addition #2) is with enzyme KLM3′ in a dosage of 0.84 TrU/g #3) is with enzyme KLM3′ in a dosage of 4.2 TrU/g and #4) is with the phospholipase Lipomod™ in a dosage of 3 LEU/g.

FIG. 69 shows the results of a TLC analysis (solvent 6) of lipids from meat samples. PE=phosphatidylethanolamine. PA=phosphatidic acid, PI=phosphatidylinositol, PC=phosphatidylcholine.

FIG. 70 shows the results of a TLC analysis (solvent 5) of lipids from meat samples. CHL=cholesterol. FFA=free fatty acids;

FIG. 71 shows a photograph of German liver sausages treated with a control emulsifier Citrem, the lipid acyltransferase of the present invention (KLM3′) or a negative control (without either enzyme or emulsifier); and

FIG. 72 shows the free-cholesterol from HPTLC analysis in liver sausage; 1=control; 2=KLM3—lipid acyltransferase (dosed as per example 3); and 3=citrem, all % based on dry weight.

### DETAILED ASPECTS OF THE PRESENT INVENTION

In one embodiment, suitably the meat may be incubated with the lipid acyltransferase for between about 30 minutes to 24 hours, suitably between about 1 hour and 21 hours.

In another embodiment the meat may be incubated with the lipid acyltransferase at a temperature of less than about 10° C., for example between about 1° C. to about 9° C., suitably between about 1° C. to about 6° C., suitably between about 2° C. to about 6° C., preferably between about 2° C. to about 5° C.

When the meat is incubated with the lipid acyltransferase at a temperature of less than about 10° C., for example between about 1° C. to about 9° C., suitably between about 1° C. to about 6° C., suitably between about 2° C. to about 6° C., preferably between about 2° C. to about 5° C., preferably the lipid acyltransferase is incubated for between about 10 to about 24 hours.

In a further embodiment the meat may be incubated with the lipid acyltransferase at a temperature between about 60° C. to about 75° C., suitably between about 62° C. to about 70° C., suitably between about 60° C. to about 78° C., suitably between about 65° C. to about 70° C.

When the meat is incubated with the lipid acyltransferase at a temperature between about 60° C. to about 75° C., suitably between about 62° C. to about 70° C., suitably between about 60° C. to about 78° C., suitably between about 65° C. to about 70° C., the meat contacted with the lipid acyltransferase is incubated for between about 30 minutes to about 2 hours, preferably about 1 hours to 1.5 hours

In one embodiment the meat contacted with the lipid acyltransferase and/or the food product derived therefrom is further heated to a temperature and for a sufficient time to inactivate the enzyme, for example to a temperature in the range of about 80° C. to about 140° C., preferably 90° C. to about 120° C.

The term “incubated” or “incubating” as used herein means holding the meat and the lipid acyltransferase under conditions where the enzyme is active, i.e. is capable of carrying out a lipid acyltransferase reaction (in particular is capable of transferring a fatty acid from a phospholipid donor to a cholesterol acceptor). The term “incubated” or “incubating” as used herein is not meant to encompass holding meat and the enzyme under conditions where: the enzyme is inactive; the enzyme is deactivated and/or the enzyme is in the process of being deactivated or denatured.

In some aspects of the present invention, the terms “increased” or “reduced” or “improved” (or other relative terms used herein) compare a meat or meat based food product treated with a lipid acyltransferase in accordance with the present invention compared with a comparable meat or a comparable meat based food product (i.e. one produced from the same ingredients and in the same way) which has not been treated with the lipid acyltransferase in accordance with the present invention.

For instance in one embodiment of the present invention “reducing the amount of cholesterol” or “cholesterol reduced” means that the amount of cholesterol in the lipid acyltransferase treated meat or meat based food product in accordance with the present invention is reduced or lower when compared with the same meat or meat based food product (i.e. produced from the same ingredients and in the same way) but without the addition of the lipid acyltransferase in accordance with the present invention.

Preferably, the cholesterol is reduced by at least about 15%, preferably at least about 20%, more preferably by at least about 40%, suitably by at least 50% or by at least 60% in the meat based food product compared with a comparable meat based food product which was not treated in accordance with the present invention with a lipid acyltransferase.

In one embodiment, suitably the cholesterol in the meat based food product may be reduced by between about 40% and about 70%.

When we refer to “cholesterol” we mean “free, non-esterified cholesterol”. Therefore when we refer herein to a reduction in the amount of cholesterol we mean a reduction in the amount of free, non-esterified cholesterol.

In some embodiments the meat based food product in accordance with the present invention may be considered “cholesterol free”. By the term “cholesterol free” it is meant that all or substantially all of the cholesterol in the meat or meat based food product has been converted to a cholesterol ester. In some embodiments suitably more than 80%, suitably more than 90% of the free, non-esterified cholesterol may be converted to a cholesterol ester. In one embodiment a “cholesterol free” product may be one where at least 90% of the free, non-esterified cholesterol has been converted to a cholesterol ester.

In one embodiment a phospholipid (such as a phospholipid from soyabean and/or egg) may be added to the meat or meat based food product. The phospholipid(s) may be added before, with or after treatment with the lipid acyltransferase. Suitably the addition of the phospholipid(s) may result in a yet further reduction of the cholesterol level in the meat based food product.

In some embodiments, the relative terms used herein may compare a meat or meat based food product treated with a lipid acyltransferase in accordance with the present invention with a comparable meat or a comparable meat based food product which has been treated with an enzyme other than a lipid acyltransferase, such as for example as compared with a comparable meat or a comparable meat based food product treated with a conventional phospholipase enzyme, e.g. Lecitase Ultra™ (Novozymes A/S, Denmark) or Lipomod 699L, Biocatalyst, UK.

For the ease of reference, these and further aspects of the present invention are now discussed under appropriate section headings. However, the teachings under each section are not necessarily limited to each particular section.

### Transferase Assay (Cholesterol:Phospholipid) for Determining Transferase Activity (TrU)

Substrate: 50 mg Cholesterol (Sigma C8503) and 450 mg Soya phosphatidylcholine(PC), Avanti #441601 is dissolved in chloroform, and chloroform is evaporated at 40° C. under vacuum.

300 mg PC:cholesterol 9:1 is dispersed at 40° C. in 10 ml 50 mM HEPES buffer pH 7.

Enzymation:

250 μl substrate is added in a glass with lid at 40° C.

25 μl enzyme solution is added and incubated during agitation for 10 minutes at 40° C.

The enzyme added should esterify 2-5% of the cholesterol in the assay.

Also a blank with 25 μl water instead of enzyme solution is analyzed.

After 10 minutes 5 ml Hexan:Isopropanol 3:2 is added.

The amount of cholesterol ester is analyzed by HPTLC using Cholesteryl stearate (Sigma C3549) standard for calibration.

Transferase activity is calculated as the amount of cholesterol ester formation per minute under assay conditions.

One Transferase Unit (TrU) is defined as μmol cholesterol ester produced per minute at 40° C. and pH 7 in accordance with the transferase assay given above.

Preferably, the lipid acyltransferase used in the method and uses of the present invention will have a specific transferase unit (TrU) per mg enzyme of at least 25 TrU/mg enzyme protein.

Suitably the lipid acyltransferase for use in the present invention may be dosed in amount of 0.05 to 50 TrU per g meat based food product, suitably in an amount of 0.5 to 5 TrU per g meat based food product.

Suitably the incubation time is effective to ensure that there is at least 5% transferase activity, preferably at least 10% transferase activity, preferably at least 15%, 20%, 25% 26%, 28%, 30%, 40% 50%, 60% or 75% transferase activity.

The % transferase activity (i.e. the transferase activity as a percentage of the total enzymatic activity) may be determined by the following protocol:

### Protocol for the Determination of % Transferase Activity

Meat samples were lyophilized and the dry sample was ground in a coffee mill. 0.5 gram dry meat powder was extracted with Chloroform: Methanol 2:1 for 30 minutes.

The organic phase was isolated, and analyzed by GLC.

### GLC Analysis

Perkin Elmer Autosystem 9000 Capillary Gas Chromatograph equipped with WCOT fused silica column 12.5 m×0.25 mm ID×0.1μ film thickness 5% phenyl-methyl-silicone (CP Sil 8 CB from Chrompack).

| | |
|---|---|
| Carrier gas: | Helium. |
| Injector. | PSSI cold split injection (initial temp 50° C. heated |
| | to 385° C.), volume 1.0 μl |
| Detector FID: | 95° C. |

| | | | |
|---|---|---|---|
| Oven program (used since | 1 | 2 | 3 |
| 30.10.2003): | | | |
| Oven temperature, ° C. | 90 | 280 | 350 |
| Isothermal, time, min. | 1 | 0 | 10 |
| Temperature rate, ° C./min. | 15 | 4 | |

Sample preparation: Lipids extracted from meat samples were dissolved in 0.5 ml Heptane:Pyridine, 2:1 containing internal standard heptadecane, 0.5 mg/ml. 300 μl sample solution is transferred to a crimp vial, 300 μl MSTFA (N-Methyl-N-trimethylsilyl-trifluoraceamid) is added and reacted for 20 minutes at 60° C.

Calculation: Response factors for Free Fatty Acid (FFA), Cholesterol, Cholesteryl palmitate and Cholesteryl stearate were determined from pure reference material.

Based on response factors for free fatty acids, cholesterol and cholesterol esters the amount in % of these components in meat samples was calculated.

% Transferase activity of lipid acyltransferase in a meat product was calculated as the % of cholesterol reduction in enzyme treated meat relative to the amount of cholesterol in the same meat product without enzyme treatment.

### EXAMPLE

Control meat product: 0.075% cholesterol.

Lipid acyltransferase treated meat product: 0.030% cholesterol.

Transferase activity=(0.075−0.030)×100/0.075=60% transferase activity.

### Meat Based Food Product

A meat based food product according to the present invention is any product based on meat.

The meat based food product is suitable for human and/or animal consumption as a food and/or a feed. In one embodiment of the invention the meat based food product is a feed product for feeding animals, such as for example a pet food product. In another embodiment of the invention the meat based food product is a food product for humans.

A meat based food product may comprise non-meat ingredients such as for example water, salt, flour, milk protein, vegetable protein, starch, hydrolyzed protein, phosphate, acid, spices, colouring agents and/or texturising agents.

A meat based food product in accordance with the present invention preferably comprises between 5-90% (weight/weight) meat. In some embodiments the meat based food product may comprise at least 30% (weight/weight) meat, such as at least 50%, at least 60% or at least 70% meat.

In some embodiments the meat based food product is a cooked meat, such as ham, loin, picnic shoulder, bacon and/or pork belly for example.

The meat based food product may be one or more of the following: dry or semi-dry cured meats—such as fermented products, dry-cured and fermented with starter cultures, for example dry sausages, salami, pepperoni and dry ham; emulsified meat products (e.g. for cold or hot consumption), such as mortadella, frankfurter, luncheon meat and pâté; fish and seafood, such as shrimps, salmon, reformulated fish products, frozen cold-packed fish; fresh meat muscle, such as whole injected meat muscle, for example loin, shoulder ham, marinated meat; ground and/or restructured fresh meat—or reformulated meat, such as upgraded cut-away meat by cold setting gel or binding, for example raw, uncooked loin chops, steaks, roasts, fresh sausages, beef burgers, meat balls, pelmeni; poultry products—such as chicken or turkey breasts or reformulated poultry, e.g. chicken nuggets and/or chicken sausages; retorted products—autoclaved meat products, for example picnic ham, luncheon meat, emulsified products.

In one embodiment of the present invention the meat based food product is a processed meat product, such as for example a sausage, bologna, meat loaf, comminuted meat product, ground meat, bacon, polony, salami or pate.

A processed meat product may be for example an emulsified meat product, manufactured from a meat based emulsion, such as for example mortadella, bologna, pepperoni, liver sausage, chicken sausage, wiener, frankfurter, luncheon meat, meat pate.

The meat based emulsion may be cooked, sterilized or baked, e.g. in a baking form or after being filled into a casing of for example plastic, collagen, cellulose or a natural casing. A processed meat product may also be a restructured meat product, such a for example restructured ham. A meat product of the invention may undergo processing steps such as for example salting, e.g. dry salting; curing, e.g. brine curing; drying; smoking; fermentation; cooking; canning; retorting; slicing and/or shredding.

In one embodiment the meat to be contacted with the lipid acyltransferase may be minced meat.

In another embodiment the food product may be an emulsified meat product.

### Meat

The term “meat” as used herein means any kind of tissue derived from any kind of animal.

The term meat as used herein may be tissue comprising muscle fibres derived from an animal. The meat may be an animal muscle, for example a whole animal muscle or pieces cut from an animal muscle.

In another embodiment the meat may comprise inner organs of an animal, such as heart, liver, kidney, spleen, thymus and brain for example.

The term meat encompasses meat which is ground, minced or cut into smaller pieces by any other appropriate method known in the art.

The meat may be derived from any kind of animal, such as from cow, pig, lamb, sheep, goat, chicken, turkey, ostrich, pheasant, deer, elk, reindeer, buffalo, bison, antelope, camel, kangaroo; any kind of fish e.g. sprat, cod, haddock, tuna, sea eel, salmon, herring, sardine, mackerel, horse mackerel, saury, round herring, Pollack, flatfish, anchovy, pilchard, blue whiting, pacific whiting, trout, catfish, bass, capelin, marlin, red snapper, Norway pout and/or hake; any kind of shellfish, e.g. clam, mussel, scallop, cockle, periwinkle, snail, oyster, shrimp, lobster, langoustine, crab, crayfish, cuttlefish, squid, and/or octopus.

In one embodiment the meat is beef, pork, chicken, lamb and/or turkey.

### Lipid Acyl Transferase

In some aspects, the lipid acyltransferase for use in any one of the methods and/or uses of the present invention may comprise a GDSx motif and/or a GANDY motif.

Preferably, the lipid acyltransferase enzyme is characterized as an enzyme which possesses acyltransferase activity and which comprises the amino acid sequence motif GDSX, wherein X is one or more of the following amino acid residues L, A, V, I, F, Y, H, Q, T, N, M or S.

Suitably, the nucleotide sequence encoding a lipid acyltransferase or lipid acyltransferase for use in any one of the methods and/or uses of the present invention may be obtainable, preferably obtained, from an organism from one or more of the following genera: Aeromonas, Streptomyces, Saccharomyces, Lactococcus, Mycobacterium, Streptococcus, Lactobacillus, Desulfitobacterium, Bacillus, Campylobacter, Vibrionaceae, Xylella, Sulfolobus, Aspergillus, Schizosaccharomyces, Listeria, Neisseria, Mesorhizobium, Ralstonia, Xanthomonas and Candida. Preferably, the lipid acyltransferase is obtainable, preferably obtained, from an organism from the genus Aeromonas.

In some aspects of the present invention, the nucleotide sequence encoding a lipid acyltransferase for use in any one of the methods and/or uses of the present invention encodes a lipid acyltransferase that comprises an aspartic acid residue at a position corresponding to N-80 in the amino acid sequence of the Aeromonas salmonicida lipid acyltransferase shown as SEQ ID No. 20.

In some aspects of the present invention, the lipid acyltransferase for use in any one of the methods and/or uses of the present invention is a lipid acyltransferase that comprises an aspartic acid residue at a position corresponding to N-80 in the amino acid sequence of the Aeromonas salmonicida lipid acyltransferase shown as SEQ ID No. 20.

The lipid acyltransferase for use in the any one of the methods and/or uses of the present invention may be a polypeptide having lipid acyltransferase activity which polypeptide comprises any one of the amino acid sequences shown as SEQ ID No. 37, SEQ ID No. 15, SEQ ID No. 1, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 41, SEQ ID No. 11, SEQ ID No. 12, SEQ ID No. 13, SEQ ID No. 14, SEQ ID No. 42, SEQ ID No. 19, SEQ ID No. 20, or an amino acid sequence which as has 75% or more identity therewith.

In addition or in the alternative, the nucleotide sequence encoding a lipid acyltransferase for use in any one of the methods and/or uses of the present invention encodes a lipid acyltransferase that may comprise the amino acid sequence shown as SEQ ID No. 37, or an amino acid sequence which has 75% or more homology thereto. Suitably, the nucleotide sequence encoding a lipid acyltransferase encodes a lipid acyltransferase that may comprise the amino acid sequence shown as SEQ ID No. 37.

In addition or in the alternative, the nucleotide sequence encoding a lipid acyltransferase for use in any one of the methods and/or uses of the present invention encodes a lipid acyltransferase that may comprise the amino acid sequence shown as SEQ ID No. 15, or an amino acid sequence which has 75% or more homology thereto. Suitably, the nucleotide sequence encoding a lipid acyltransferase encodes a lipid acyltransferase that may comprise the amino acid sequence shown as SEQ ID No. 15.

In one embodiment the lipid acyltransferase for use in any on of the methods and/or uses of the present invention has an amino acid sequence shown in SEQ ID No. 37 or SEQ ID No. 15, or has an amino acid sequence which has at least 75% identity therewith, preferably at least 80%, preferably at least 85%, preferably at least 95%, preferably at least 98% identity therewith.

In one embodiment the lipid acyltransferase for use in any on of the methods and/or uses of the present invention is encoded by a nucleotide sequence shown in SEQ ID No. 26, or is encoded by a nucleotide sequence which has at least 75% identity therewith, preferably at least 80%, preferably at least 85%, preferably at least 95%, preferably at least 98% identity therewith.

The nucleotide sequence encoding a lipid acyl transferase for use in any one of the methods and/or uses of the present invention may encode a natural lipid acyl transferase or a variant lipid acyl transferase.

The lipid acyl transferase for use in any one of the methods and/or uses of the present invention may be a natural lipid acyl transferase or a variant lipid acyl transferase.

For instance, the nucleotide sequence encoding a lipid acyl transferase for use in the present invention may be one as described in WO2004/064537, WO2004/064987, WO2005/066347, or WO2006/008508. These documents are incorporated herein by reference.

The term “lipid acyl transferase” as used herein preferably means an enzyme that has acyltransferase activity (generally classified as E.C. 2.3.1.x, for example 2.3.1.43), whereby the enzyme is capable of transferring an acyl group from a lipid to a sterol, such as cholesterol.

Preferably, the lipid acyl transferase for use in any one of the methods and/or uses of the present invention is a lipid acyltransferase that is capable of transferring an acyl group from a phospholipid (as defined herein) to a sterol (e.g. cholesterol).

In another aspect, the lipid acyltransferase for use in the methods and/or uses of the present invention may, as well as being able to transfer an acyl group from a lipid to a sterol (e.g. cholesterol), additionally be able to transfer the acyl group from a lipid to one or more of the following: a carbohydrate, a protein, a protein subunit, glycerol.

Preferably, the lipid substrate upon which the lipid acyl acts is one or more of the following lipids: a phospholipid, such as a lecithin, e.g. phosphatidylcholine and/or phosphatidylethanolamine.

This lipid substrate may be referred to herein as the “lipid acyl donor”. The term lecithin as used herein encompasses phosphatidylcholine, phosphatidylethanolamine, phosphatidylinositol, phosphatidylserine and phosphatidylglycerol.

As detailed above, other acyl-transferases suitable for use in the methods of the invention may be identified by identifying the presence of the GDSx, GANDY and HPT blocks either by alignment of the pFam00657 consensus sequence (SEQ ID No 1), and/or alignment to a GDSx acyltransferase, for example SEQ ID No 28. In order to assess their suitability for use in the present invention, i.e. identify those enzymes which have a transferase activity of at least 5%, more preferably at least 10%, more preferably at least 20%, more preferably at least 30%, more preferably at least 40%, more preferably 50%, more preferably at least 60%, more preferably at least 70%, more preferably at least 80%, more preferably at least 90% and more preferably at least 98% of the total enzyme activity, such acyltransferases are tested using the “Protocol for the determination of % acyltransferase activity” assay detailed hereinabove.

For some aspects, preferably the lipid acyl transferase for use in any one of the methods and/or uses of the present invention is a lipid acyltransferase that is incapable, or substantially incapable, of acting on a triglyceride and/or a 1-monoglyceride and/or 2-monoglyceride.

For some aspects, preferably the lipid acyl transferase for use in any one of the methods and/or uses of the present invention is a lipid acyltransferase that does not exhibit triacylglycerol lipase activity (E.C. 3.1.1.3) or does not exhibit significant triacylglycerol lipase activity (E.C. 3.1.1.3).

The ability to hydrolyse triglyceride (E.C. 3.1.1.3 activity) may be determined by lipase activity is determined according to Food Chemical Codex (3rd Ed., 1981, pp 492-493) modified to sunflower oil and pH 5.5 instead of olive oil and pH 6.5. The lipase activity is measured as LUS (lipase units sunflower) where 1 LUS is defined as the quantity of enzyme which can release 1 [mu]mol of fatty acids per minute from sunflower oil under the above assay conditions. Alternatively the LUT assay as defined in WO9845453 may be used. This reference is incorporated herein by reference.

The lipid acyl transferase for use in any one of the methods and/or uses of the present invention may be a lipid acyltransferase which is substantially incapable of acting on a triglyceride may have a LUS/mg of less than 1000, for example less than 500, such as less than 300, preferably less than 200, more preferably less than 100, more preferably less than 50, more preferably less than 20, more preferably less than 10, such as less than 5, less than 2, more preferably less than 1 LUS/mg. Alternatively LUT/mg activity is less than 500, such as less than 300, preferably less than 200, more preferably less than 100, more preferably less than 50, more preferably less than 20, more preferably less than 10, such as less than 5, less than 2, more preferably less than 1 LUT/mg.

The lipid acyl transferase for use in any one of the methods and/or uses of the present invention may be a lipid acyltransferase which is substantially incapable of acting on a monoglyceride. This may be determined by using mono-oleate (M7765 1-Oleoyl-rac-glycerol 99%) in place of the sunflower oil in the LUS assay. 1 MGHU is defined as the quantity of enzyme which can release 1 [mu]mol of fatty acids per minute from monoglyceride under the assay conditions.

The lipid acyl transferase for use in any one of the methods and/or uses of the present invention is a lipid acyltransferase which is preferably substantially incapable of acting on a triglyceride may have a MGHU/mg of less than 5000, for example less than 1000, for example less than 500, such as less than 300, preferably less than 200, more preferably less than 100, more preferably less than 50, more preferably less than 20, more preferably less than 10, such as less than 5, less than 2, more preferably less than 1 MGHU/mg.

Suitably, the lipid acyltransferase for use in any one of the methods and/or uses of the present invention is a lipid acyltransferase that may exhibit one or more of the following phospholipase activities: phospholipase A2 activity (E.C. 3.1.1.4) and/or phospholipase A1 activity (E.C. 3.1.1.32). The lipid acyl transferase may also have phospholipase B activity (E.C. 3.1.1.5).

Thus, in one embodiment the “acyl acceptor” according to the present invention may be a plant sterol/stanol, preferably cholesterol.

Preferably, the lipid acyltransferase enzyme may be characterized using the following criteria:
the enzyme possesses acyl transferase activity which may be defined as ester transfer activity whereby the acyl part of an original ester bond of a lipid acyl donor is transferred to an acyl acceptor to form a new ester; and
the enzyme comprises the amino acid sequence motif GDSX, wherein X is one or more of the following amino acid residues L, A, V, I, F, Y, H, Q, T, N, M or S.

The GDSX motif is comprised of four conserved amino acids. Preferably, the serine within the motif is a catalytic serine of the lipid acyl transferase enzyme. Suitably, the serine of the GDSX motif may be in a position corresponding to Ser-16 in Aeromonas hydrophile lipid acyltransferase enzyme taught in Brumlik & Buckley (Journal of Bacteriology April 1996, Vol. 178, No. 7, p 2060-2064).

To determine if a protein has the GDSX motif according to the present invention, the sequence is preferably compared with the hidden markov model profiles (HMM profiles) of the pfam database in accordance with the procedures taught in WO2004/064537 or WO2004/064987, incorporated herein by reference.

Preferably the lipid acyl transferase enzyme can be aligned using the Pfam00657 consensus sequence (for a full explanation see WO2004/064537 or WO2004/064987).

Preferably, a positive match with the hidden markov model profile (HMM profile) of the pfam00657 domain family indicates the presence of the GDSL or GDSX domain according to the present invention.

Preferably when aligned with the Pfam00657 consensus sequence the lipid acyltransferase for use in the methods or uses of the invention may have at least one, preferably more than one, preferably more than two, of the following, a GDSx block, a GANDY block, a HPT block. Suitably, the lipid acyltransferase may have a GDSx block and a GANDY block. Alternatively, the enzyme may have a GDSx block and a HPT block. Preferably the enzyme comprises at least a GDSx block. See WO2004/064537 or WO2004/064987 for further details.

Preferably, residues of the GANDY motif are selected from GANDY, GGNDA, GGNDL, most preferably GANDY.

The pfam00657 GDSX domain is a unique identifier which distinguishes proteins possessing this domain from other enzymes.

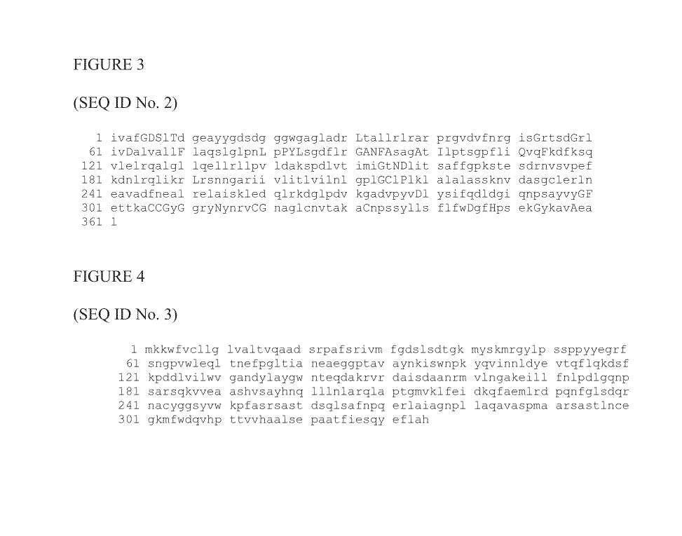

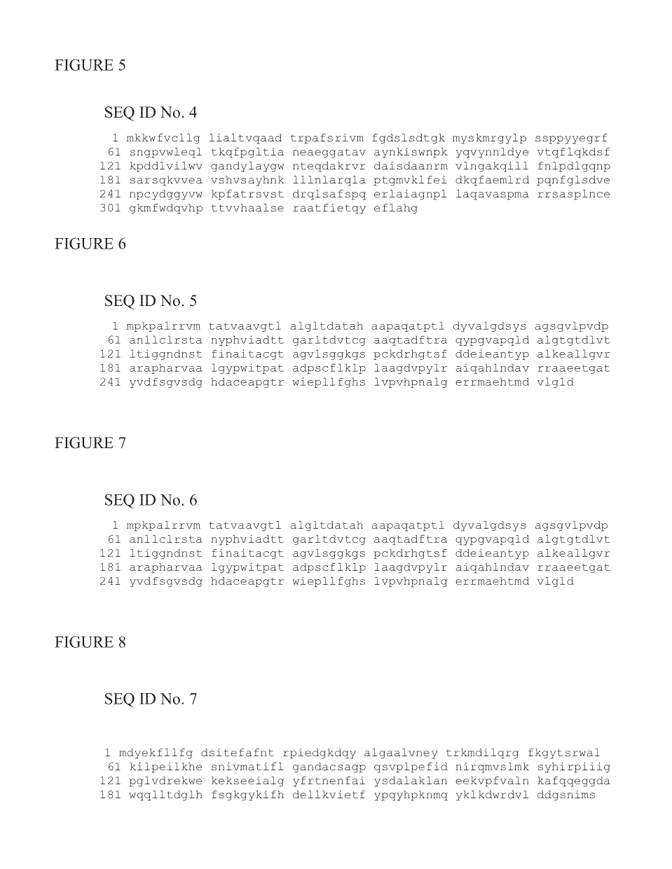

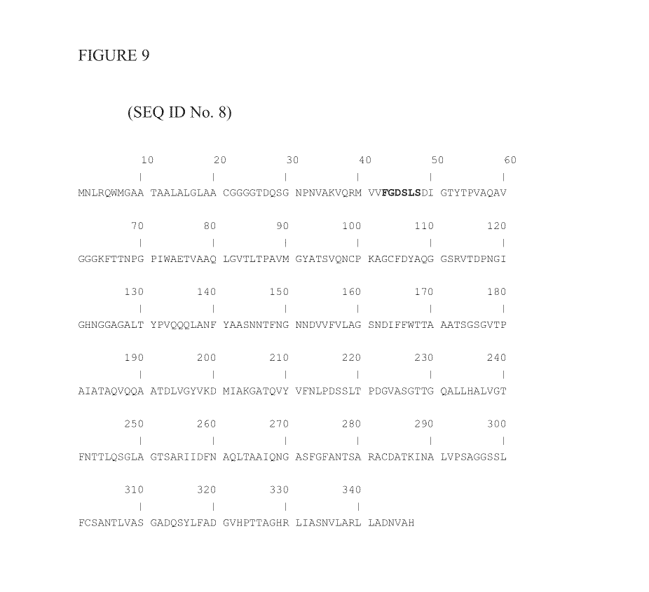

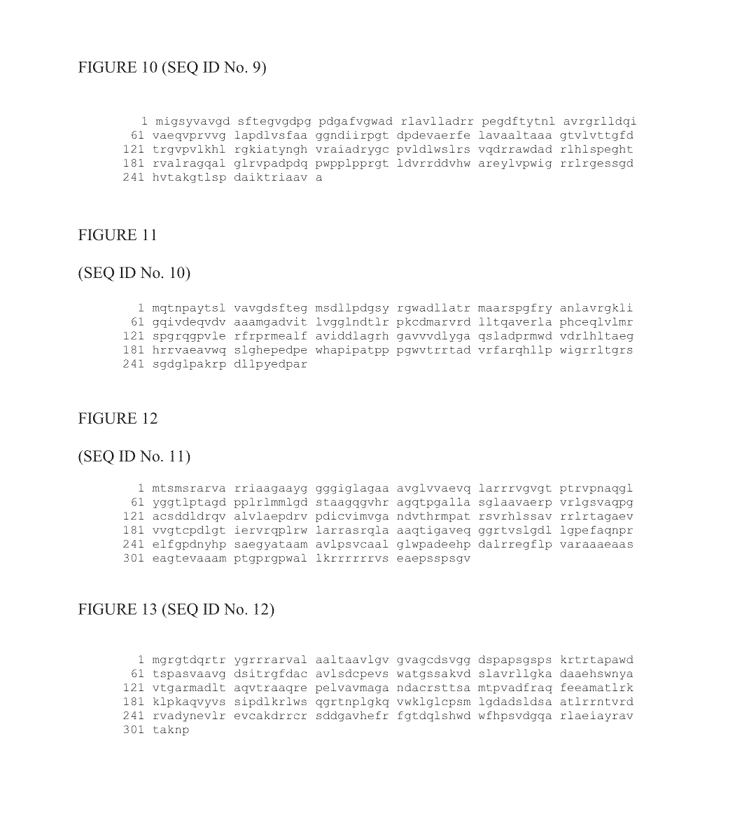

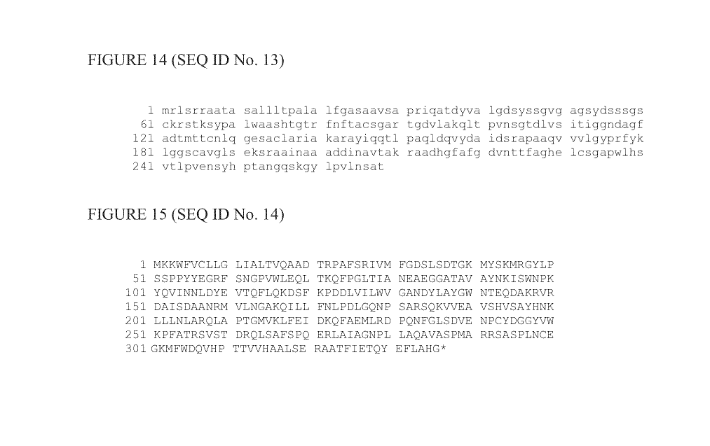

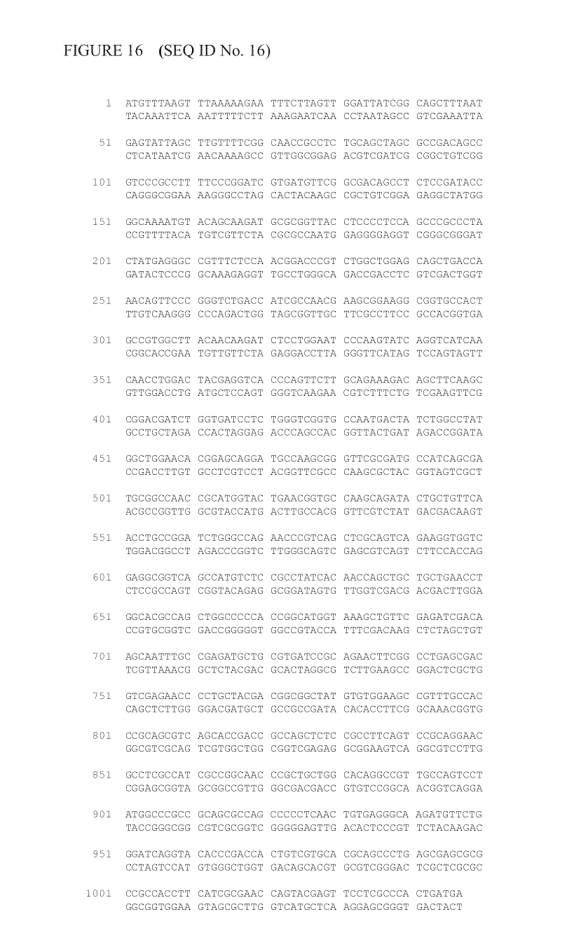

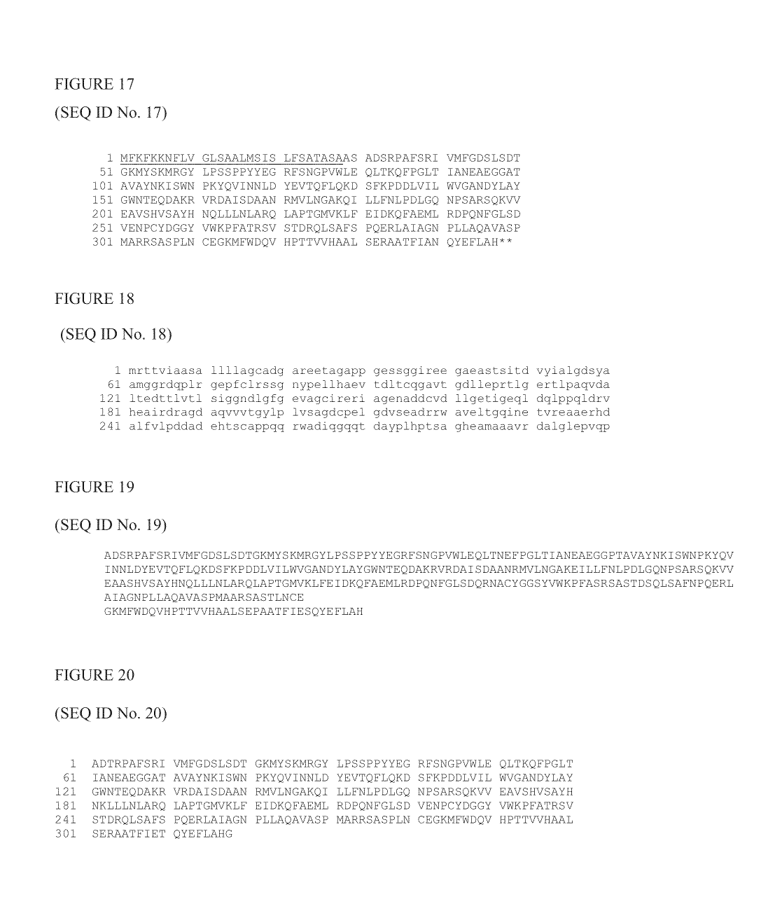

The pfam00657 consensus sequence is presented in FIG. 3 as SEQ ID No. 2. This is derived from the identification of the pfam family 00657, database version 6, which may also be referred to as pfam00657.6 herein.

The consensus sequence may be updated by using further releases of the pfam database (for example see WO2004/064537 or WO2004/064987).

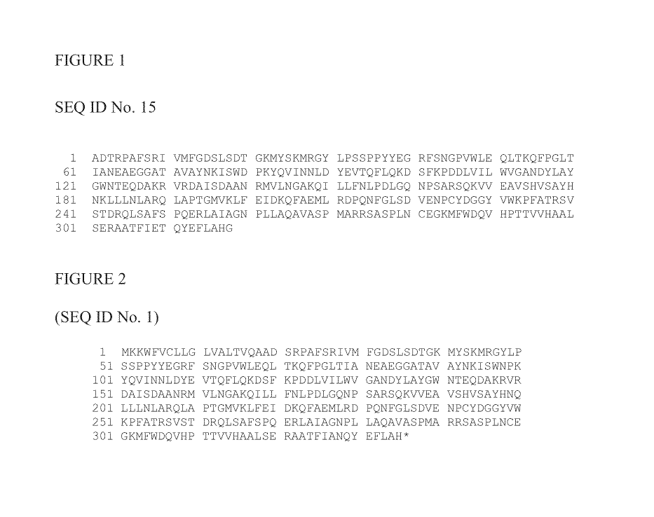

In one embodiment, the lipid acyl transferase enzyme for use in any one of the methods and/or uses of the present invention is a lipid acyltransferase that may be characterized using the following criteria:
(i) the enzyme possesses acyl transferase activity which may be defined as ester transfer activity whereby the acyl part of an original ester bond of a lipid acyl donor is transferred to acyl acceptor to form a new ester;
(ii) the enzyme comprises the amino acid sequence motif GDSX, wherein X is one or more of the following amino acid residues L, A, V, I, F, Y, H, Q, T, N, M or S.;
(iii) the enzyme comprises His-309 or comprises a histidine residue at a position corresponding to His-309 in the Aeromonas hydrophile lipid acyltransferase enzyme shown in FIGS. 2 and 4 (SEQ ID No. 1 or SEQ ID No. 3).

Preferably, the amino acid residue of the GDSX motif is L.

In SEQ ID No. 3 or SEQ ID No. 1 the first 18 amino acid residues form a signal sequence. His-309 of the full length sequence, that is the protein including the signal sequence, equates to His-291 of the mature part of the protein, i.e. the sequence without the signal sequence.

In one embodiment, the lipid acyl transferase enzyme for use any one of the methods and uses of the present invention is a lipid acyltransferase that comprises the following catalytic triad: Ser-34, Asp-306 and His-309 or comprises a serine residue, an aspartic acid residue and a histidine residue, respectively, at positions corresponding to Ser-34, Asp-306 and His-309 in the Aeromonas hydrophila lipid acyl transferase enzyme shown in FIG. 4 (SEQ ID No. 3) or FIG. 2 (SEQ ID No. 1). As stated above, in the sequence shown in SEQ ID No. 3 or SEQ ID No. 1 the first 18 amino acid residues form a signal sequence. Ser-34, Asp-306 and His-309 of the full length sequence, that is the protein including the signal sequence, equate to Ser-16, Asp-288 and His-291 of the mature part of the protein, i.e. the sequence without the signal sequence. In the pfam00657 consensus sequence, as given in FIG. 3 (SEQ ID No. 2) the active site residues correspond to Ser-7, Asp-345 and His-348.

In one embodiment, the lipid acyl transferase enzyme for use any one of the methods and/or uses of the present invention is a lipid acyltransferase that may be characterized using the following criteria:
the enzyme possesses acyl transferase activity which may be defined as ester transfer activity whereby the acyl part of an original ester bond of a first lipid acyl donor is transferred to an acyl acceptor to form a new ester; and
the enzyme comprises at least Gly-32, Asp-33, Ser-34, Asp-134 and His-309 or comprises glycine, aspartic acid, serine, aspartic acid and histidine residues at positions corresponding to Gly-32, Asp-33, Ser-34, Asp-306 and His-309, respectively, in the Aeromonas hydrophila lipid acyltransferase enzyme shown in SEQ ID No. 3 or SEQ ID No. 1.

Suitably, the lipid acyltransferase for use in any one of the methods and/or uses of the present invention is a polypeptide having lipid acyltransferase activity which polypeptide is obtained by expression of any one of the nucleotide sequences shown as SEQ ID No. 21, SEQ ID No. 47, SEQ ID No. 25, SEQ ID No. 48, SEQ ID No. 50, SEQ ID No. 51, SEQ ID No. 26, SEQ ID No. 27, SEQ ID No. 28, SEQ ID No. 38, SEQ ID No. 39, SEQ ID No. 40, SEQ ID No. 29, SEQ ID No. 30, SEQ ID No. 31, SEQ ID No. 52, SEQ ID No. 32, SEQ ID No. 33, SEQ ID No. 34, SEQ ID No. 35 or SEQ ID No. 36 or a nucleotide sequence which as has 75% or more identity therewith.

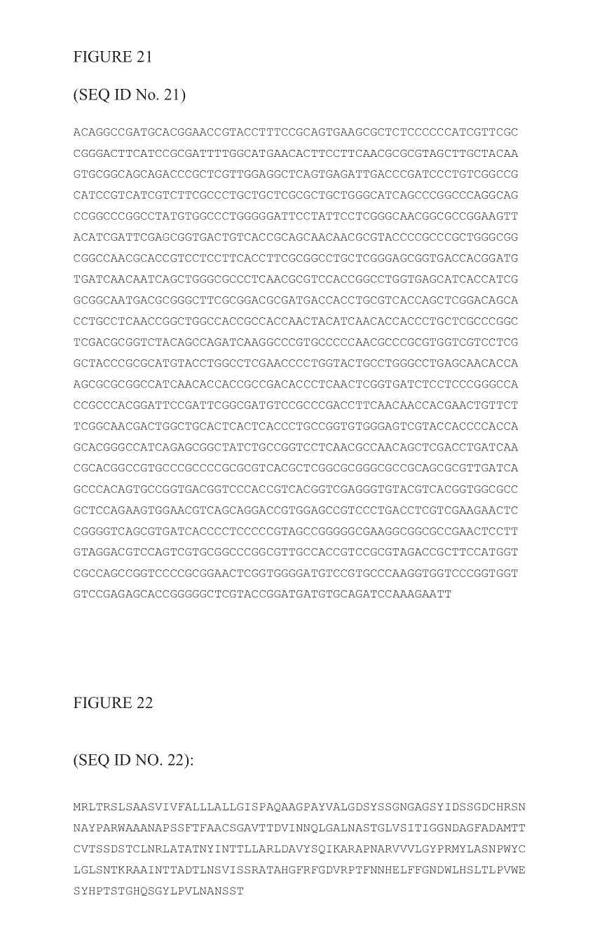

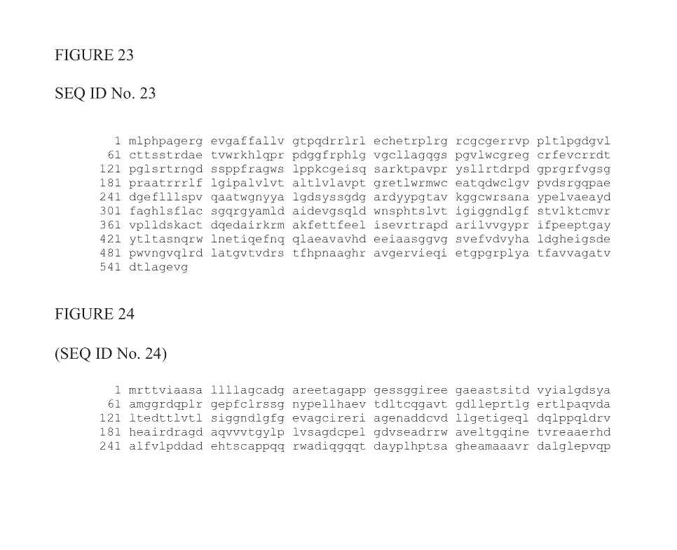

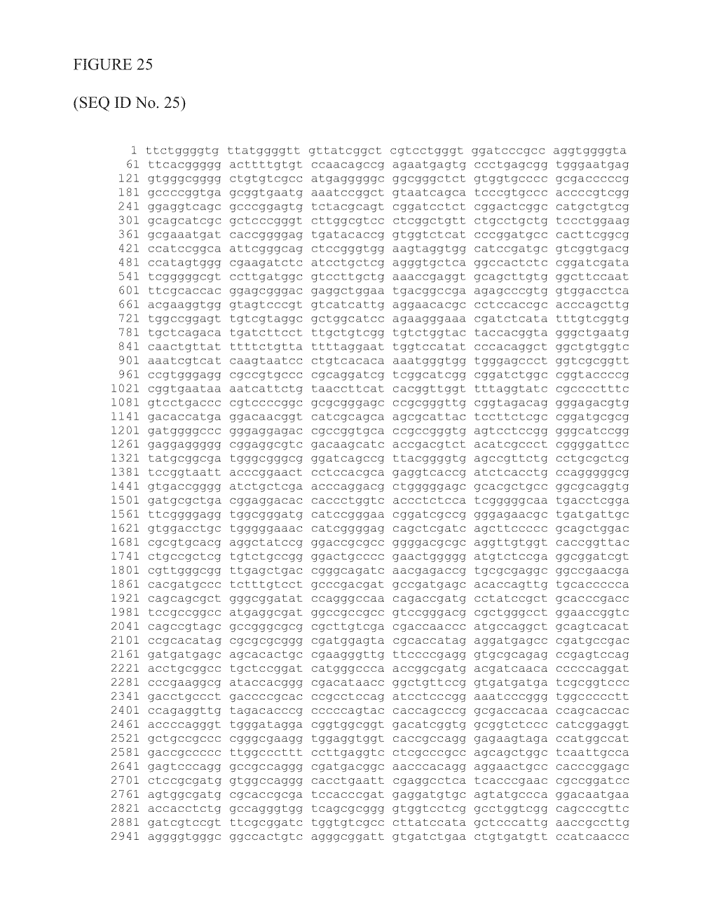

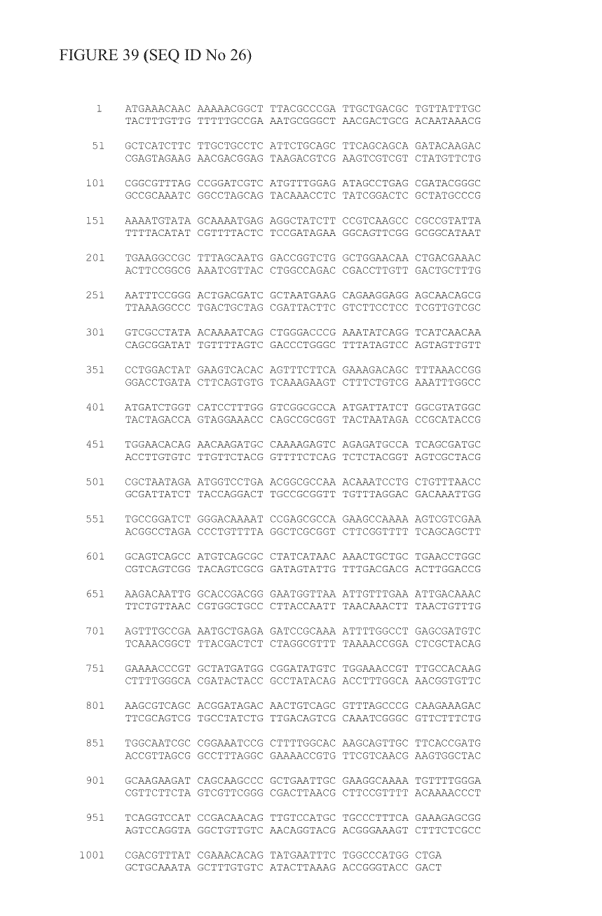

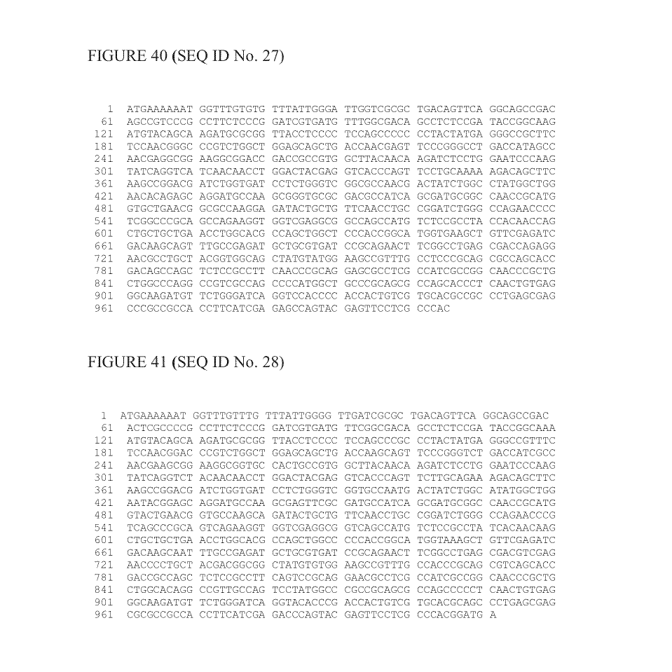

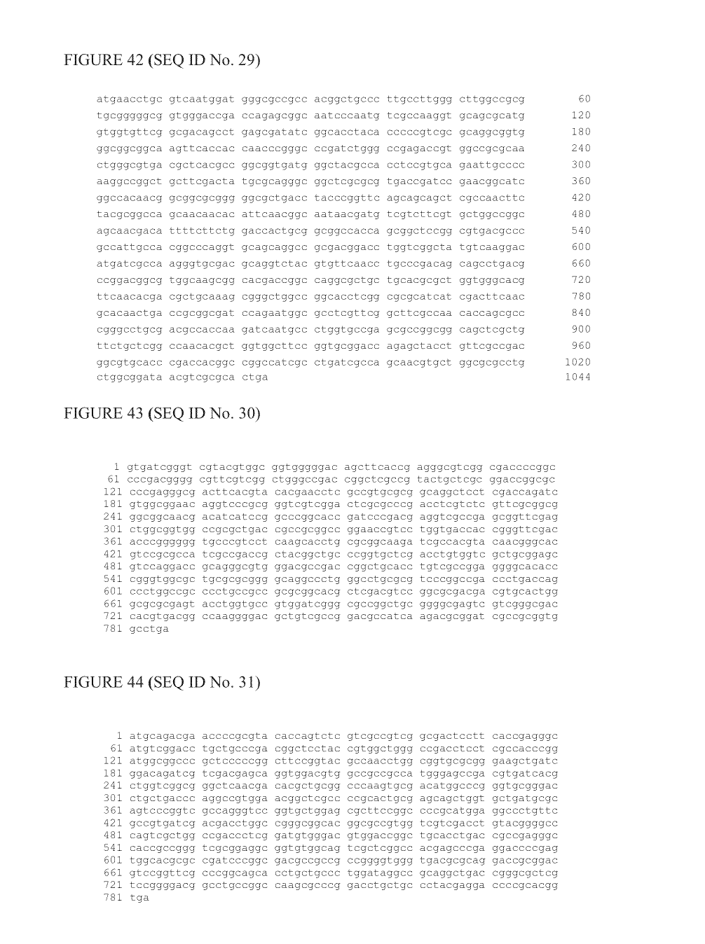

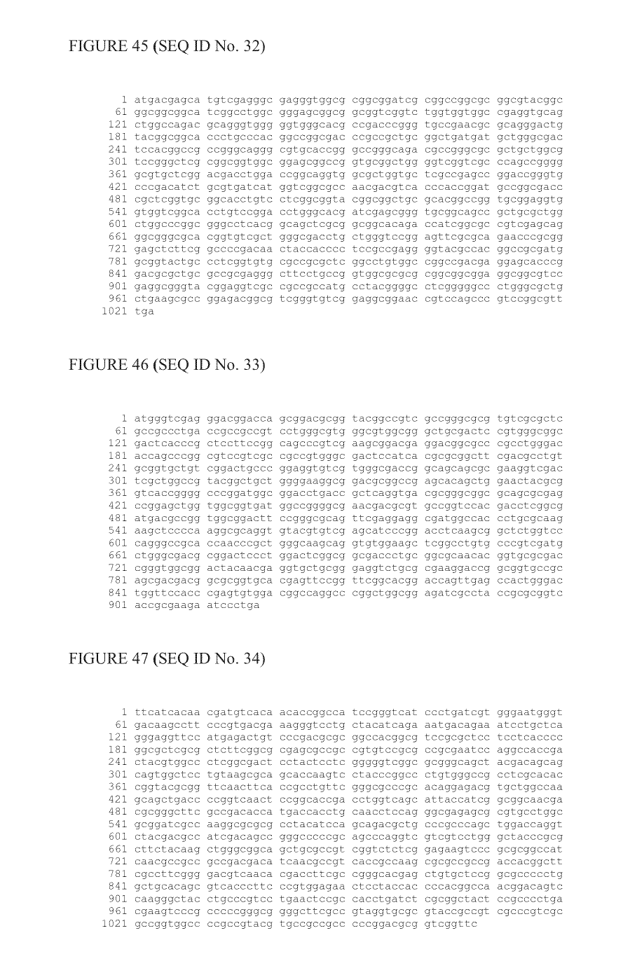

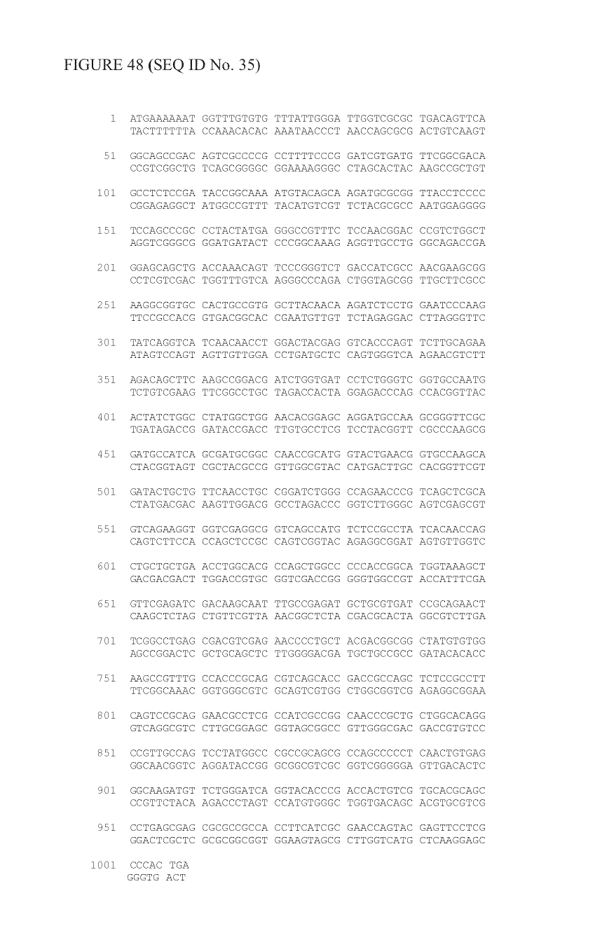

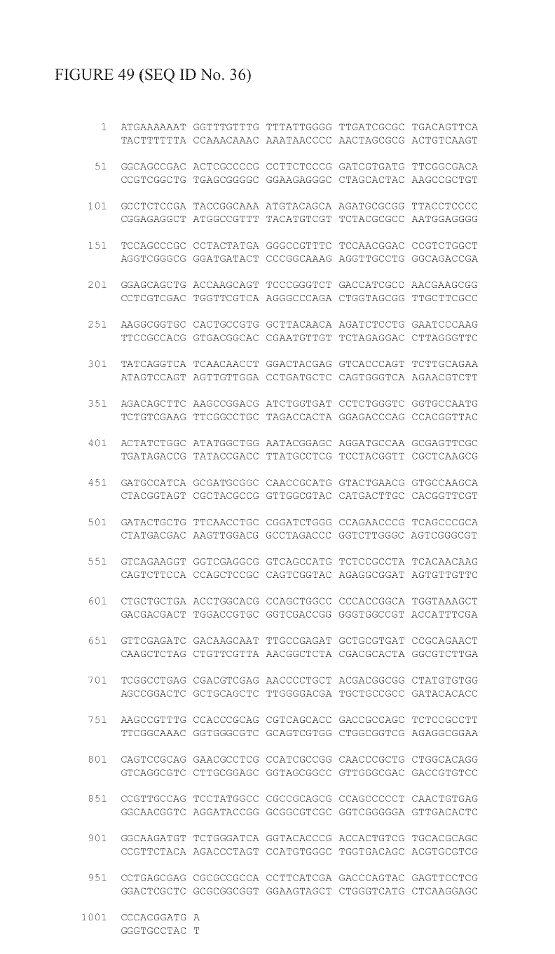

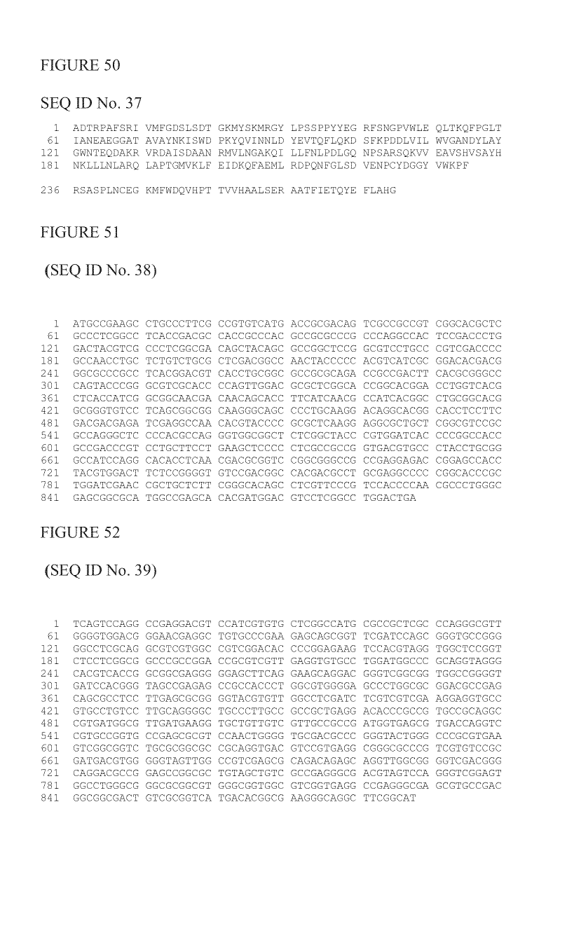

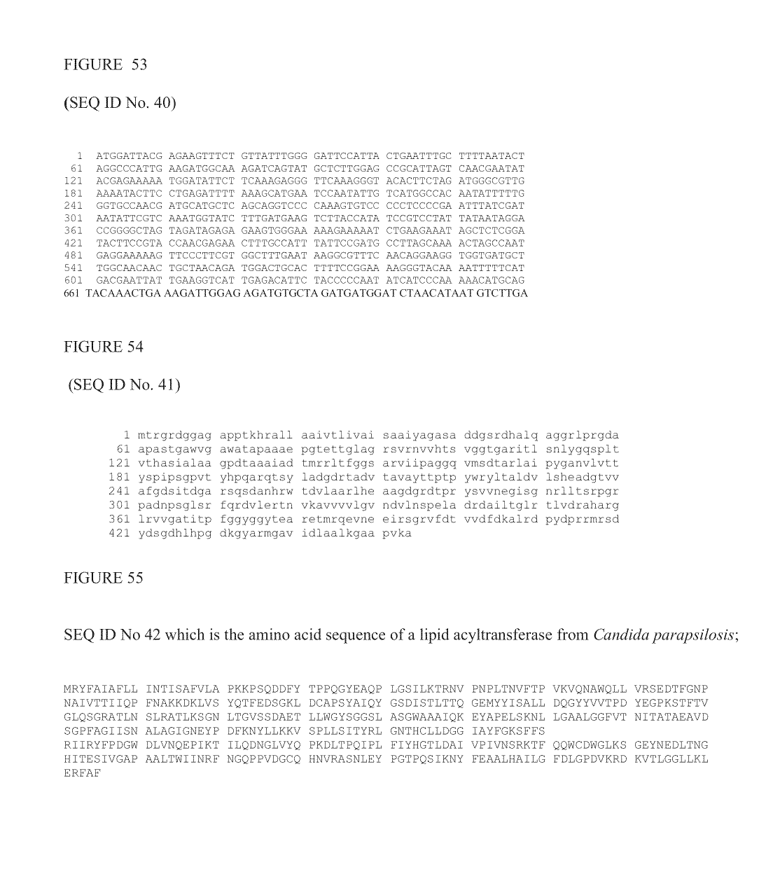

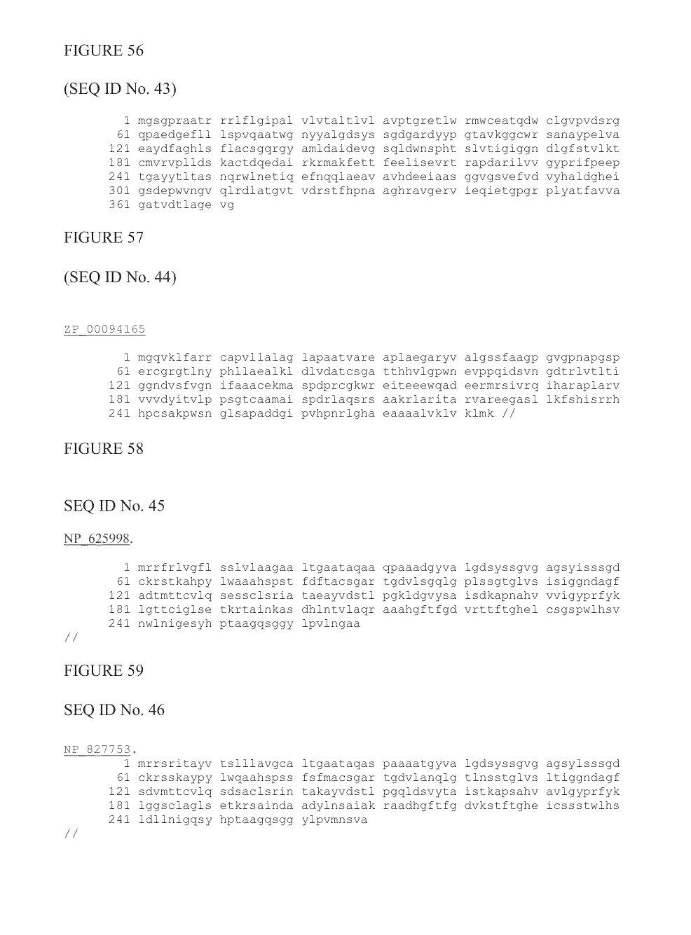

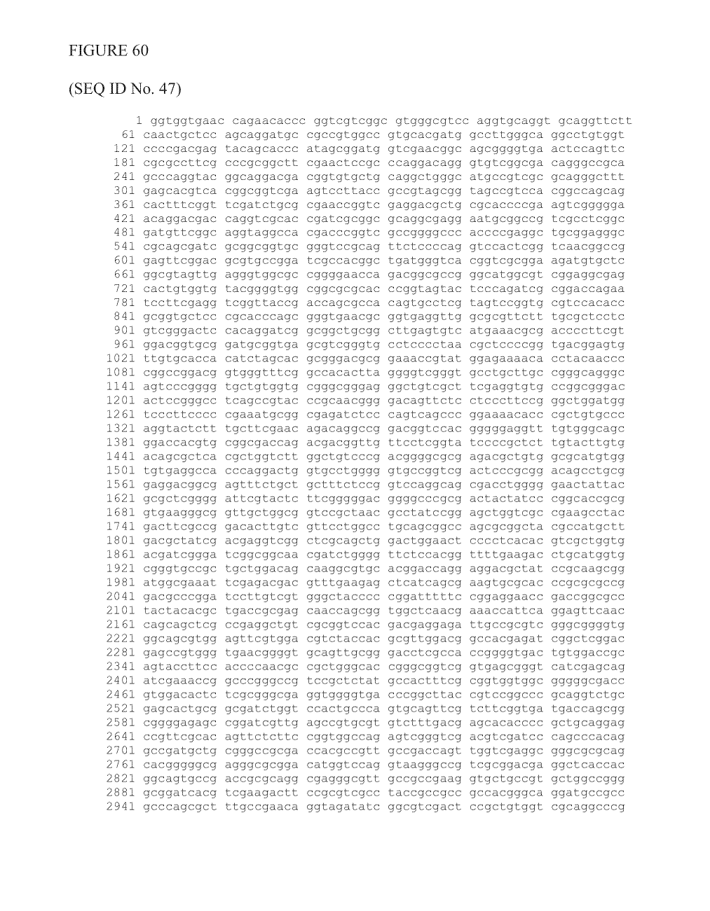

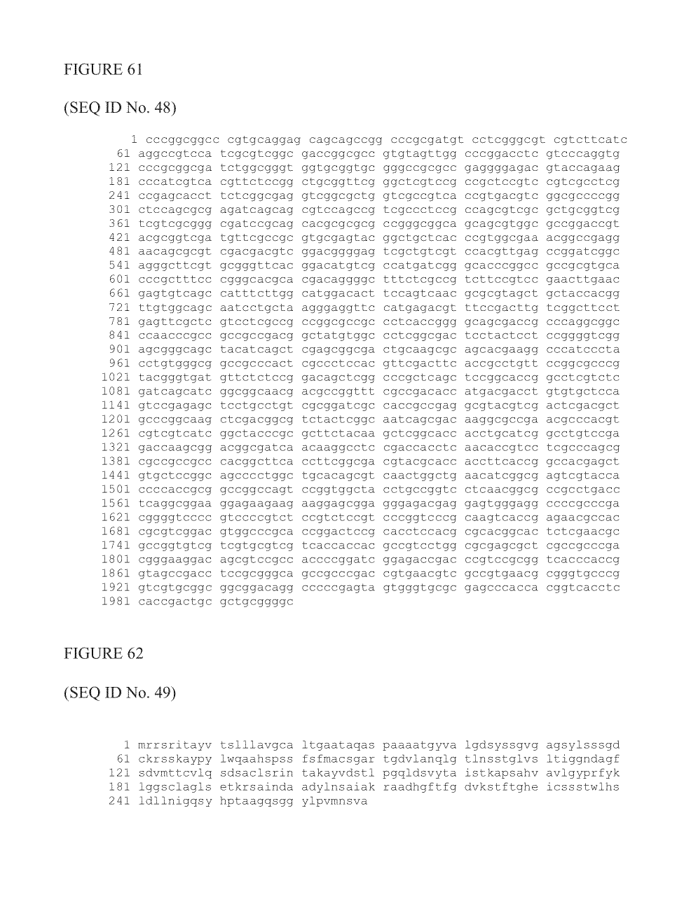

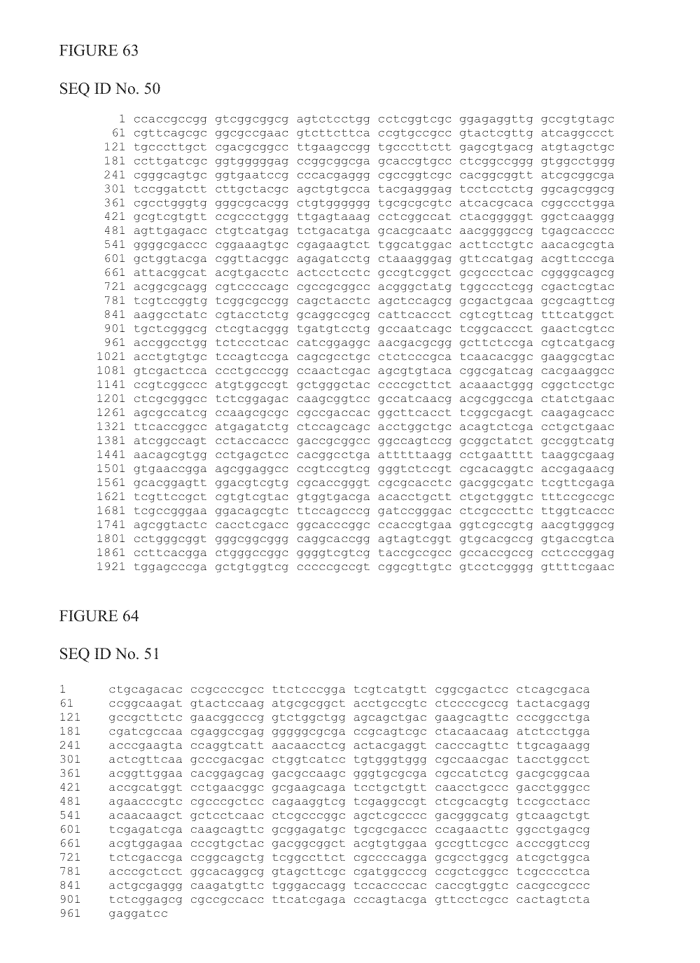

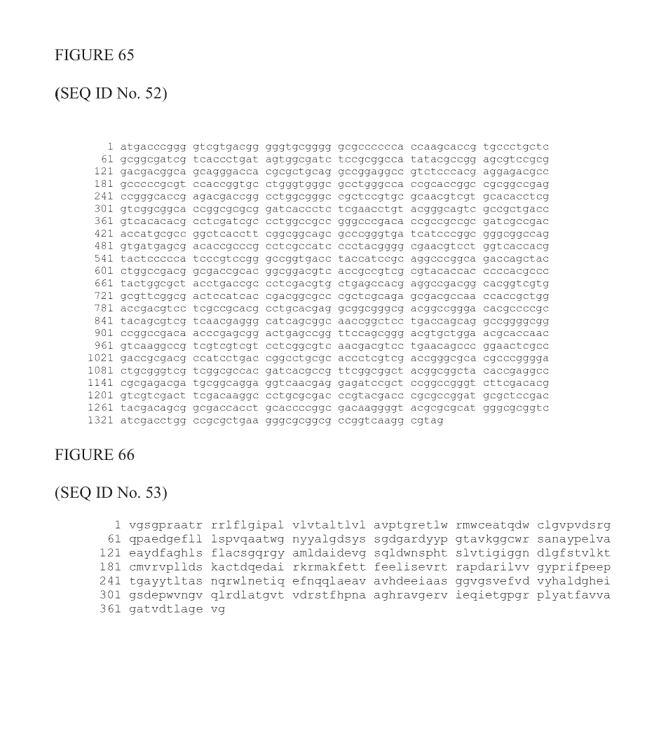

Suitably, the lipid acyltransferase enzyme for use in any one of the methods and/or uses of the present invention may be encoded by one of the following nucleotide sequences:
(a) the nucleotide sequence shown as SEQ ID No. 21 (see FIG. 21);
(b) the nucleotide sequence shown as SEQ ID No. 47 (see FIG. 60);
(c) the nucleotide sequence shown as SEQ ID No. 25 (see FIG. 25);
(d) the nucleotide sequence shown as SEQ ID No. 48 (see FIG. 50);
(e) the nucleotide sequence shown as SEQ ID No. 50 (see FIG. 63);
(f) the nucleotide sequence shown as SEQ ID No. 51 (see FIG. 64);
(g) the nucleotide sequence shown as SEQ ID No. 26 (see FIG. 39);
(h) the nucleotide sequence shown as SEQ ID No. 27 (see FIG. 40);
(i) the nucleotide sequence shown as SEQ ID No. 28 (see FIG. 41);
(j) the nucleotide sequence shown as SEQ ID No. 38 (see FIG. 51);
(k) the nucleotide sequence shown as SEQ ID No. 39 (see FIG. 52);
(l) the nucleotide sequence shown as SEQ ID No. 40 (see FIG. 53);
(m) the nucleotide sequence shown as SEQ ID No. 29 (see FIG. 42);
(n) the nucleotide sequence shown as SEQ ID No. 30 (see FIG. 43);
(o) the nucleotide sequence shown as SEQ ID No. 31 (see FIG. 44);
(p) the nucleotide sequence shown as SEQ ID No. 52 (see FIG. 65);
(q) the nucleotide sequence shown as SEQ ID No. 32 (see FIG. 45);
(r) the nucleotide sequence shown as SEQ ID No. 33 (see FIG. 46);
(s) the nucleotide sequence shown as SEQ ID No. 34 (see FIG. 47);
(t) the nucleotide sequence shown as SEQ ID No. 35 (see FIG. 48);
(u) the nucleotide sequence shown as SEQ ID No. 36 (see FIG. 49); or
(v) a nucleotide sequence which has 70% or more, preferably 75% or more, identity with any one of the sequences shown as SEQ ID No. 21, SEQ ID No. 25, SEQ ID No. 26, SEQ ID No. 27, SEQ ID No. 28, SEQ ID No. 29, SEQ ID No. 30, SEQ ID No. 31, SEQ ID No. 32, SEQ ID No. 33, SEQ ID No. 34, SEQ ID No. 35, SEQ ID No. 36, SEQ ID No. 38, SEQ ID No. 39, SEQ ID No. 40, SEQ ID No. 47, SEQ ID No. 48, SEQ ID No. 50, SEQ ID No. 51 or SEQ ID No. 52; or

a nucleic acid which is related by the degeneration of the genetic code identity with any one of the sequences shown as SEQ ID No. 21, SEQ ID No. 25, SEQ ID No. 26, SEQ ID No. 27, SEQ ID No. 28, SEQ ID No. 29, SEQ ID No. 30, SEQ ID No. 31, SEQ ID No. 32, SEQ ID No. 33, SEQ ID No. 34, SEQ ID No. 35, SEQ ID No. 36, SEQ ID No. 38, SEQ ID No. 39, SEQ ID No. 40, SEQ ID No. 47, SEQ ID No. 48, SEQ ID No. 50, SEQ ID No. 51 or SEQ ID No. 52.

Suitably the nucleotide sequence may have 80% or more, preferably 85% or more, more preferably 90% or more and even more preferably 95% or more identity with any one of the sequences shown as SEQ ID No. 21, SEQ ID No. 25, SEQ ID No. 26, SEQ ID No. 27, SEQ ID No. 28, SEQ ID No. 29, SEQ ID No. 30, SEQ ID No. 31, SEQ ID No. 32, SEQ ID No. 33, SEQ ID No. 34, SEQ ID No. 35, SEQ ID No. 36, SEQ ID No. 38, SEQ ID No. 39, SEQ ID No. 40, SEQ ID No. 47, SEQ ID No. 48, SEQ ID No. 50, SEQ ID No. 51 or SEQ ID No. 52.

In one embodiment, the nucleotide sequence encoding a lipid acyltransferase enzyme for use any one of the methods and uses of the present invention is a nucleotide sequence which has 70% or more, preferably 75% or more, identity with any one of the sequences shown as: SEQ ID No. 26, SEQ ID No. 27, SEQ ID No. 28, SEQ ID No. 35, and SEQ ID No. 36. Suitably the nucleotide sequence may have 80% or more, preferably 85% or more, more preferably 90% or more and even more preferably 95% or more identity with any one of the sequences shown as: SEQ ID No. 26, SEQ ID No. 27, SEQ ID No. 28, SEQ ID No. 35, and SEQ ID No. 36.

In one embodiment, the nucleotide sequence encoding a lipid acyltransferase enzyme for use in any one of the methods and uses of the present invention is a nucleotide sequence which has 70% or more, 75% or more, 80% or more, preferably 85% or more, more preferably 90% or more and even more preferably 95% or more identity the sequence shown as SEQ ID No. 26.

Suitably, the lipid acyl transferase enzyme for use any one of the methods and/or uses of the present invention may be a lipid acyltransferase that comprises one or more of the following amino acid sequences:
(i) the amino acid sequence shown as SEQ ID No. 37;
(ii) the amino acid sequence shown as SEQ ID No. 1;
(iii) the amino acid sequence shown as SEQ ID No. 3;
(iv) the amino acid sequence shown as SEQ ID No. 4;
(v) the amino acid sequence shown as SEQ ID No. 5;
(vi) the amino acid sequence shown as SEQ ID No. 6;
(vii) the amino acid sequence shown as SEQ ID No. 7;
(viii) the amino acid sequence shown as SEQ ID No. 8;
(ix) the amino acid sequence shown as SEQ ID No. 9;
(x) the amino acid sequence shown as SEQ ID No. 10;
(xi) the amino acid sequence shown as SEQ ID No. 11;
(xii) the amino acid sequence shown as SEQ ID No. 12;
(xiii) the amino acid sequence shown as SEQ ID No. 13;
(xiv) the amino acid sequence shown as SEQ ID No. 14;
(xv) the amino acid sequence shown as SEQ ID No. 15;
(xvi) the amino acid sequence shown as SEQ ID No. 18;
(xvii) the amino acid sequence shown as SEQ ID No. 19;
(xviii) the amino acid sequence shown as SEQ ID No. 20;
(xix) the amino acid sequence shown as SEQ ID No. 21;
(xx) the amino acid sequence shown as SEQ ID No. 22;
(xxi) the amino acid sequence shown as SEQ ID No. 23;
(xxii) the amino acid sequence shown as SEQ ID No. 24;
(xxiii) the amino acid sequence shown as SEQ ID No. 41;
(xxiv) or an amino acid sequence which has 75%, 80%, 85%, 90%, 95%, 98% or more identity with any one of the sequences shown as SEQ ID No. 37, SEQ ID No. 1, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 15, SEQ ID No. 18, SEQ ID No. 19, SEQ ID No. 20, SEQ ID No. 21, SEQ ID No. 22, SEQ ID No. 23, SEQ ID No. 24, or SEQ ID No. 41.

Suitably, the lipid acyl transferase enzyme for use any one of the methods and uses of the present invention may be a lipid acyltransferase that comprises either the amino acid sequence shown as SEQ ID No. 37, or as SEQ ID No. 3 or as SEQ ID No. 4 or SEQ ID No. 1 or SEQ ID No. 14 or SEQ ID No. 15, or SEQ ID No. 19 or SEQ ID No. 20 or comprises an amino acid sequence which has 75% or more, preferably 80% or more, preferably 85% or more, preferably 90% or more, preferably 95% or more, identity with the amino acid sequence shown as SEQ ID No. 37 or the amino acid sequence shown as SEQ ID No. 3 or the amino acid sequence shown as SEQ ID No. 4 or the amino acid sequence shown as SEQ ID No. 1 or the amino acid sequence shown as SEQ ID No. 14 or the amino acid sequence shown as SEQ ID No. 15 or the amino acid sequence shown as SEQ ID No. 19 or the amino acid sequence shown as SEQ ID No. 20.

Suitably the lipid acyl transferase enzyme for use any one of the methods and/or uses of the present invention may be a lipid acyltransferase that comprises an amino acid sequence which has 80% or more, preferably 85% or more, more preferably 90% or more and even more preferably 95% or more identity with any one of the sequences shown as SEQ ID No. 37, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 41, SEQ ID No. 11, SEQ ID No. 12, SEQ ID No. 13, SEQ ID No. 1, SEQ ID No. 14, SEQ ID No. 15, SEQ ID No. 19 or SEQ ID No. 20.

Suitably, the lipid acyltransferase enzyme for use any one of the methods and/or uses of the present invention may be a lipid acyltransferase that comprises one or more of the following amino acid sequences:
(a) an amino acid sequence shown as amino acid residues 1-100 of SEQ ID No. 3 or SEQ ID No. 1;
(b) an amino acid sequence shown as amino acids residues 101-200 of SEQ ID No. 3 or SEQ ID No. 1;
(c) an amino acid sequence shown as amino acid residues 201-300 of SEQ ID No. 3 or SEQ ID No. 1; or
(d) an amino acid sequence which has 75% or more, preferably 85% or more, more preferably 90% or more, even more preferably 95% or more identity to any one of the amino acid sequences defined in (a)-(c) above.

Suitably, the lipid acyl transferase enzyme for use in methods and uses of the present invention may comprise one or more of the following amino acid sequences:
(a) an amino acid sequence shown as amino acid residues 28-39 of SEQ ID No. 3 or SEQ ID No. 1;
(b) an amino acid sequence shown as amino acids residues 77-88 of SEQ ID No. 3 or SEQ ID No. 1;
(c) an amino acid sequence shown as amino acid residues 126-136 of SEQ ID No. 3 or SEQ ID No. 1;
(d) an amino acid sequence shown as amino acid residues 163-175 of SEQ ID No. 3 or SEQ ID No. 1;
(e) an amino acid sequence shown as amino acid residues 304-311 of SEQ ID No. 3 or SEQ ID No. 1; or
(f) an amino acid sequence which has 75% or more, preferably 85% or more, more preferably 90% or more, even more preferably 95% or more identity to any one of the amino acid sequences defined in (a)-(e) above.

In one aspect, the lipid acyl transferase enzyme for use any one of the methods and/or uses of the present invention is a lipid acyltransferase that may be the lipid acyl transferase from Candida parapsilosis as taught in EP 1 275 711. Thus in one aspect the lipid acyl transferase for use in the method and uses of the present invention may be a lipid acyl transferase comprising the amino acid sequence taught in SEQ ID No. 42.

Much by preference, the lipid acyl transferase enzyme for use in any one of the methods and uses of the present invention is a lipid acyltransferase that may be a lipid acyl transferase comprising the amino acid sequence shown as SEQ ID No. 15 or SEQ ID No. 37, or an amino acid sequence which has 75% or more, preferably 85% or more, more preferably 90% or more, even more preferably 95% or more, even more preferably 98% or more, or even more preferably 99% or more identity to SEQ ID No. 15 or SEQ ID No. 37. This enzyme could be considered a variant enzyme.

In one aspect, the lipid acyltransferase enzyme for use any one of the methods and/or uses of the present invention is a lipid acyltransferase that may be a lecithin:cholesterol acyltransferase (LCAT) or variant thereof (for example a variant made by molecular evolution)

Suitable LCATs are known in the art and may be obtainable from one or more of the following organisms for example: mammals, rat, mice, chickens, Drosophila melanogaster, plants, including Arabidopsis and Oryza sativa, nematodes, fungi and yeast.

In one embodiment the lipid acyltransferase enzyme for use any one of the methods and/or uses of the present invention is a lipid acyltransferase that may be the lipid acyltransferase obtainable, preferably obtained, from the E. coli strains TOP 10 harbouring pPet12aAhydro and pPet12aASalmo deposited by Danisco A/S of Langebrogade 1, DK-1001 Copenhagen K, Denmark under the Budapest Treaty on the International Recognition of the Deposit of Microorganisms for the purposes of Patent Procedure at the National Collection of Industrial, Marine and Food Bacteria (NCIMB) 23 St. Machar Street, Aberdeen Scotland, GB on 22 Dec. 2003 under accession numbers NCIMB 41204 and NCIMB 41205, respectively.

A lipid acyltransferase enzyme for use in any one of the methods and/or uses of the present invention may be a phospholipid glycerol acyl transferase. Phospholipid glycerol acyl transferases include, but are not limited to those isolated from Aeromonas spp., preferably Aeromonas hydrophile or A. salmonicida, most preferably A. salmonicida or variants thereof.

Lipid acyl transferases for use in the present invention may be encoded by SEQ ID Nos. 1, 3, 4, 14, 19 and 20. It will be recognized by the skilled person that it is preferable that the signal peptides of the acyl transferase has been cleaved during expression of the transferase. The signal peptide of SEQ ID No.s 1, 3, 4 and 14 are amino acids 1-18. Therefore the most preferred regions are amino acids 19-335 for SEQ ID No. 1 and SEQ ID No. 3 (A. hydrophilia) and amino acids 19-336 for SEQ ID No. 4 and SEQ ID No. 14 (A. salmonicida). When used to determine the homology of identity of the amino acid sequences, it is preferred that the alignments as herein described use the mature sequence.

Therefore the most preferred regions for determining homology (identity) are amino acids 19-335 for SEQ ID No. 1 and 3 (A. hydrophilia) and amino acids 19-336 for SEQ ID No.s 4 and 14 (A. salmonicida). SEQ ID No.s 19 and 20 are mature protein sequences of a lipid acyltransferase from A. hydrophilia and A. salmonicida respectively which may or may not undergo further post-translational modification.

A lipid acyltransferase enzyme for use any one of the methods and uses of the present invention may be a lipid acyltransferase that may also be isolated from Thermobifida, preferably T. fusca, most preferably that encoded by SEQ ID No. 43.

Suitable lipid acyltransferases for use in accordance with the present invention and/or in the methods of the present invention may comprise any one of the following amino acid sequences and/or be encoded by the following nucleotide sequences:
(a) a nucleic acid which encodes a polypeptide exhibiting lipid acyltransferase activity and is at least 70% identical (preferably at least 80%, more preferably at least 90% identical) with the polypeptide sequence shown in SEQ ID No. 15 or with the polypeptide shown in SEQ ID No. 37;
(b) a (isolated) polypeptide comprising (or consisting of) an amino acid sequence as shown in SEQ ID No. 15 or SEQ ID No. 37 or an amino acid sequence which is at least 70% identical (preferably at least 80% identical, more preferably at least 90% identical) with SEQ ID No. 15 or SEQ ID No. 37;
(c) a nucleic acid encoding a lipid acyltransferase, which nucleic acid comprises (or consists of) a nucleotide sequence shown as SEQ ID No. 26 or a nucleotide sequence which is at least 70% identical (preferably at least 80%, more preferably at least 90% identical) with the nucleotide sequence shown as SEQ ID No. 26;
(d) a nucleic acid which hybridizes under medium or high stringency conditions to a nucleic acid probe comprising the nucleotide sequence shown as SEQ ID No. 26 and encodes for a polypeptide exhibiting lipid acyltransferase activity;
(e) a nucleic acid which is a fragment of the nucleic acid sequences specified in a), c) or d); or
(f) a polypeptide which is a fragment of the polypeptide specified in b).

A lipid acyltransferase enzyme for use any one of the methods and uses of the present invention may be a lipid acyltransferase that may also be isolated from Streptomyces, preferable S. avermitis, most preferably that encoded by SEQ ID No. 32. Other possible enzymes for use in the present invention from Streptomyces include those encoded by SEQ ID No.s 5, 6, 9, 10, 11, 12, 13, 31, 33 and 41.

An enzyme for use in the invention may also be isolated from Corynebacterium, preferably C. efficiens, most preferably that encoded by SEQ ID No. 18.

Suitably, the lipid acyltransferase enzyme for use any one of the methods and/or uses of the present invention may be a lipid acyltransferase that comprises any one of the amino acid sequences shown as SEQ ID No.s 22, 23, 24, 48, 44, 50, or 53 or an amino acid sequence which has at least 70%, 75%, 80%, 85%, 90%, 95%, 96%, 97% or 98% identity therewith, or may be encoded by any one of the nucleotide sequences shown as SEQ ID No.s 36, 39, 42, 44, 46, or 48 or a nucleotide sequence which has at least 70%, 75%, 80%, 85%, 90%, 95%, 96%, 97% or 98% identity therewith.

In a further embodiment the lipid acyltransferase enzyme for use any one of the methods and/or uses of the present invention may be a lipid acyltransferase comprising any one of the amino acid sequences shown as SEQ ID No. 22, 23, 24, 43, 45, 49 or 53 or an amino acid sequence which has at least 70%, 75%, 80%, 85%, 90%, 95%, 96%, 97% or 98% identity therewith, or may be encoded by any one of the nucleotide sequences shown as SEQ ID No. 25, 47, 48, 50 or 51 or a nucleotide sequence which has at least 70%, 75%, 80%, 85%, 90%, 95%, 96%, 97% or 98% identity therewith.

In a further embodiment the lipid acyltransferase enzyme for use any one of the methods and/or uses of the present invention may be a lipid acyltransferase comprising any one of amino sequences shown as SEQ ID No. 23, 24, 45, 49 or 53 or an amino acid sequence which has at least 70%, 75%, 80%, 85%, 90%, 95%, 96%, 97% or 98% identity therewith for the uses described herein.

In a further embodiment the lipid acyltransferase for use in any one of the methods and/or uses of the present invention may be a lipid acyltransferase comprising any one of amino sequences shown as SEQ ID No. 23, 45, or 53 or an amino acid sequence which has at least 70%, 75%, 80%, 85%, 90%, 95%, 96%, 97% or 98% identity therewith for the uses described herein.

More preferably in one embodiment the lipid acyltransferase for use in any one of the methods and/or uses of the present invention may be a lipid acyltransferase comprising the amino acid sequence shown as SEQ ID No. 45 or an amino acid sequence which has at least 70%, 75%, 80%, 85%, 90%, 95%, 96%, 97% or 98% identity therewith.

In one embodiment the lipid acyltransferase according to the present invention may be a lipid acyltransferase obtainable, preferably obtained, from the Streptomyces strains L130 or L131 deposited by Danisco A/S of Langebrogade 1, DK-1001 Copenhagen K, Denmark under the Budapest Treaty on the International Recognition of the Deposit of Microorganisms for the purposes of Patent Procedure at the National Collection of Industrial, Marine and Food Bacteria (NCIMB) 23 St. Machar Street, Aberdeen Scotland, GB on 25 Jun. 2004 under accession numbers NCIMB 41226 and NCIMB 41227, respectively.

A suitable lipid acyltransferases for use in any one of the methods and/or uses of the present invention may be an amino acid sequence which may be identified by alignment to the L131 (SEQ ID No. 22) sequence using Align X, the Clustal W pairwise alignment algorithm of VectorNTI using default settings.

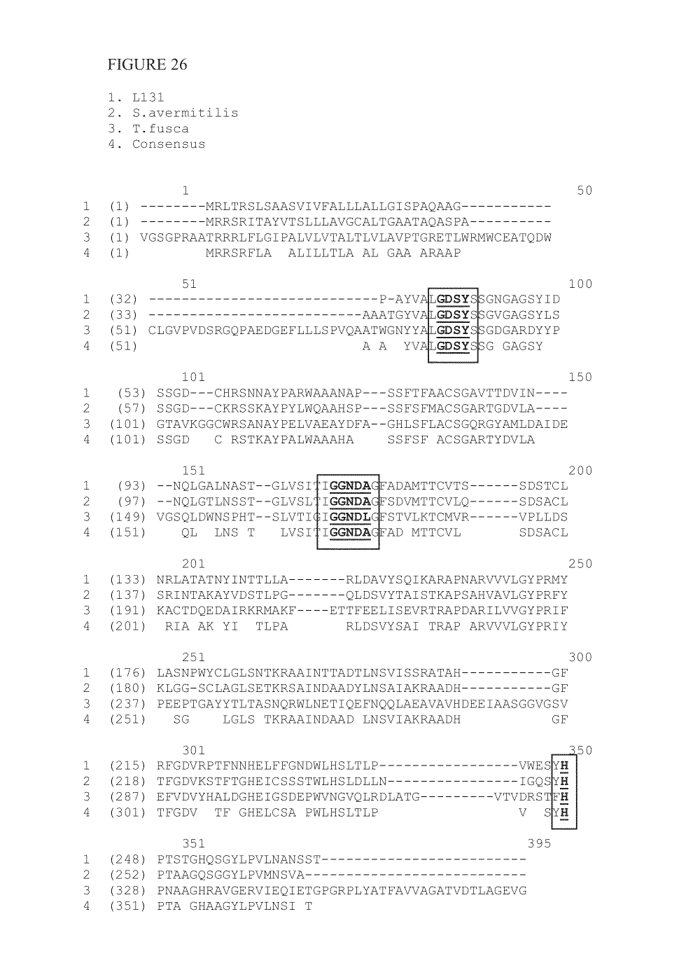

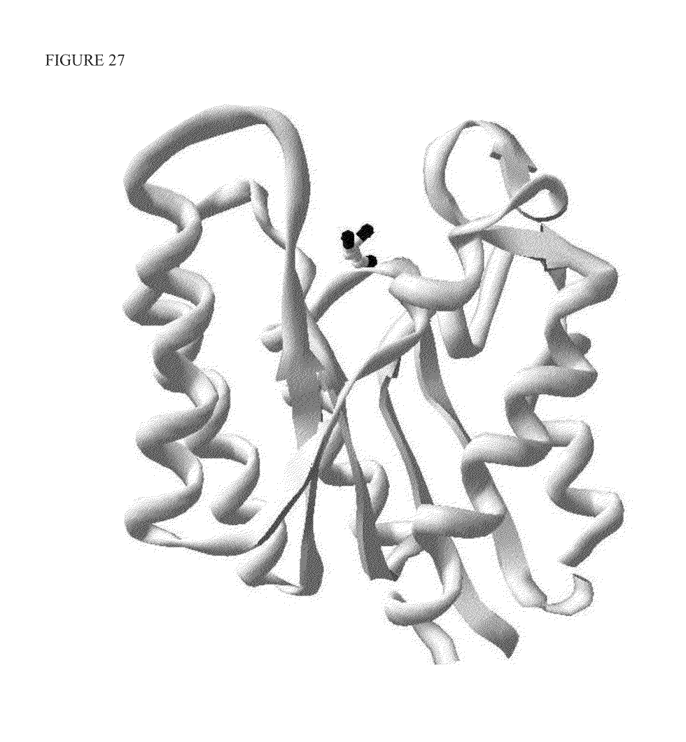

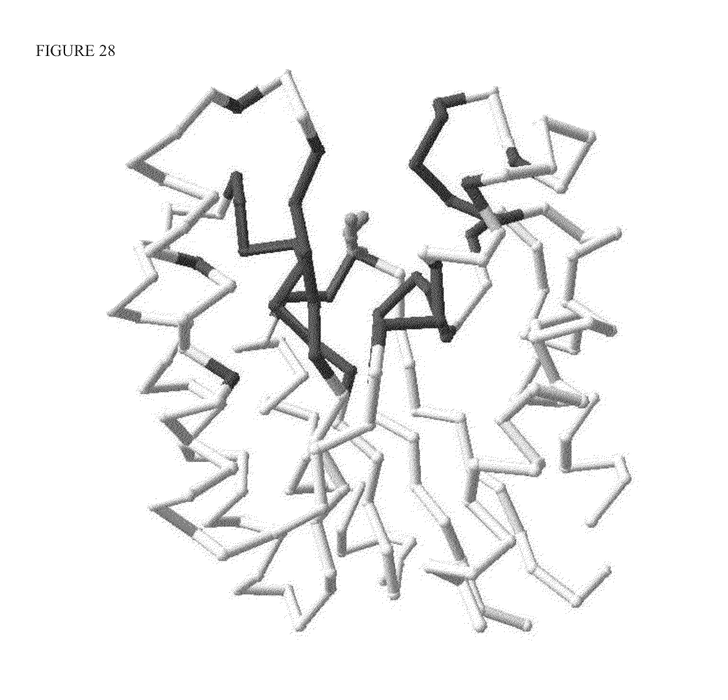

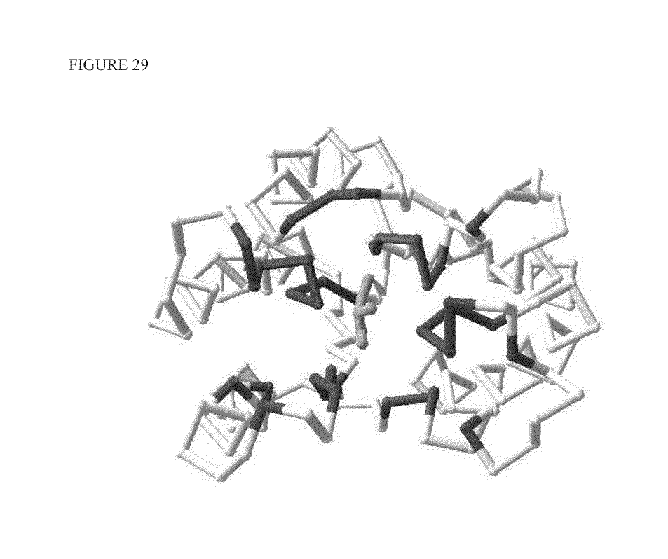

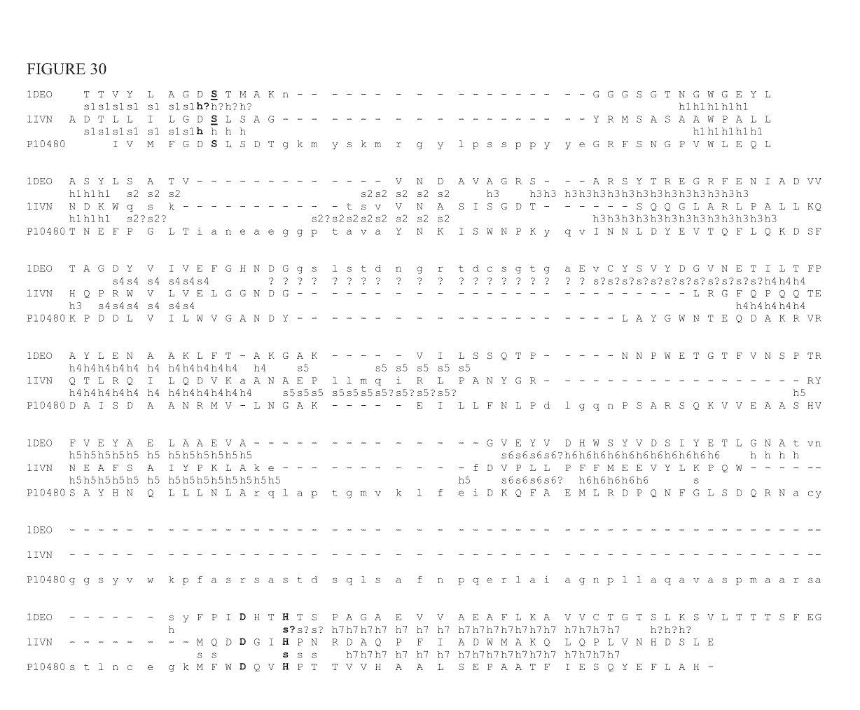

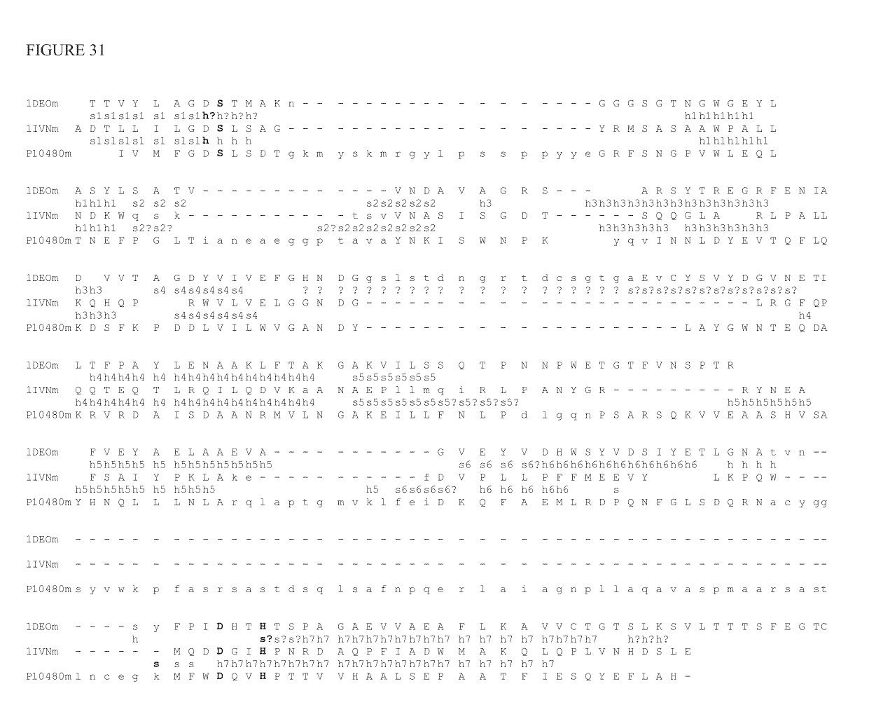

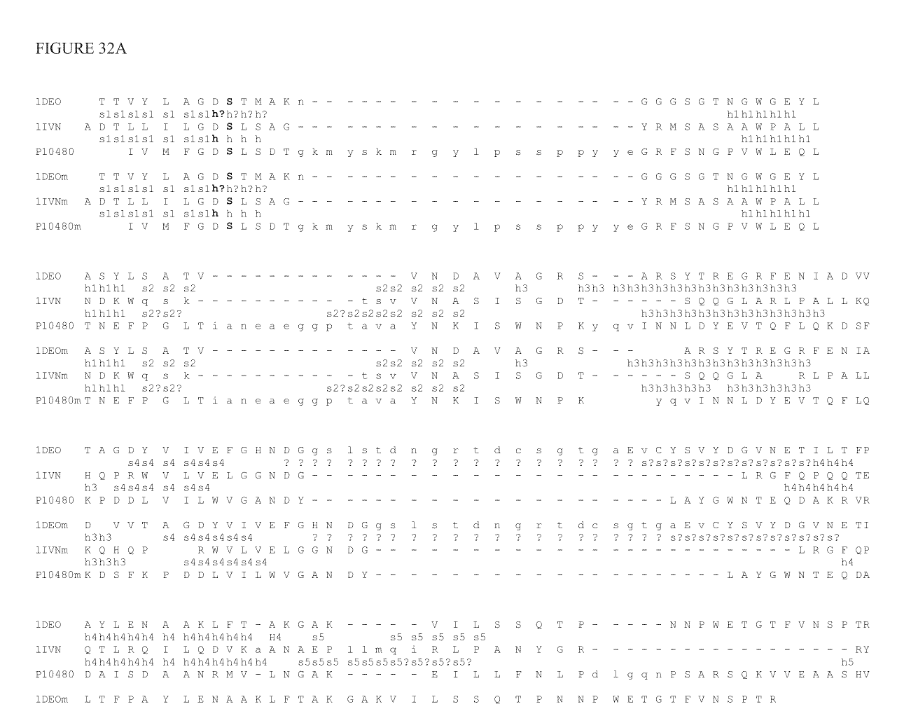

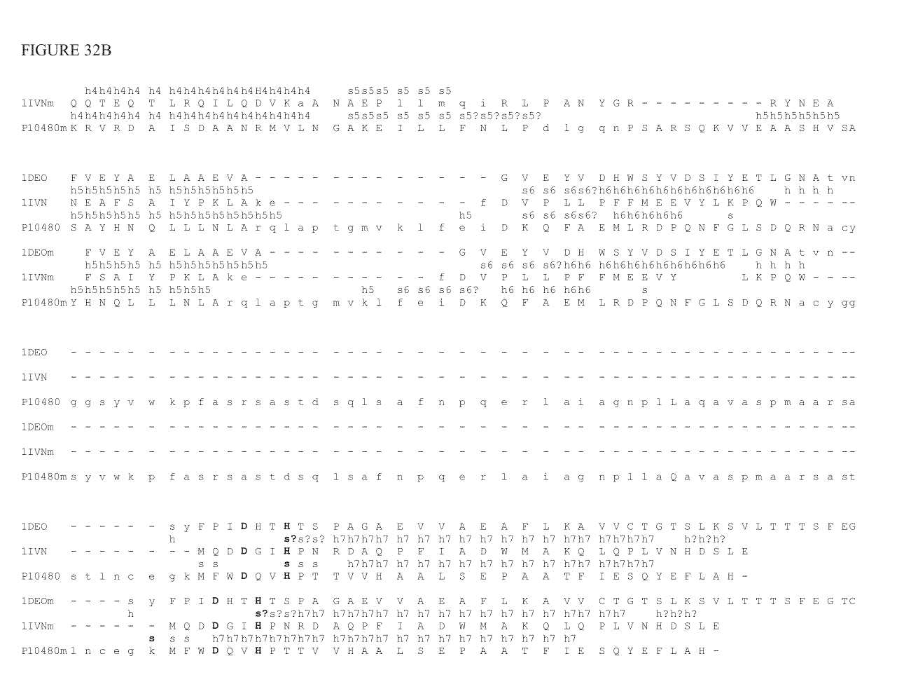

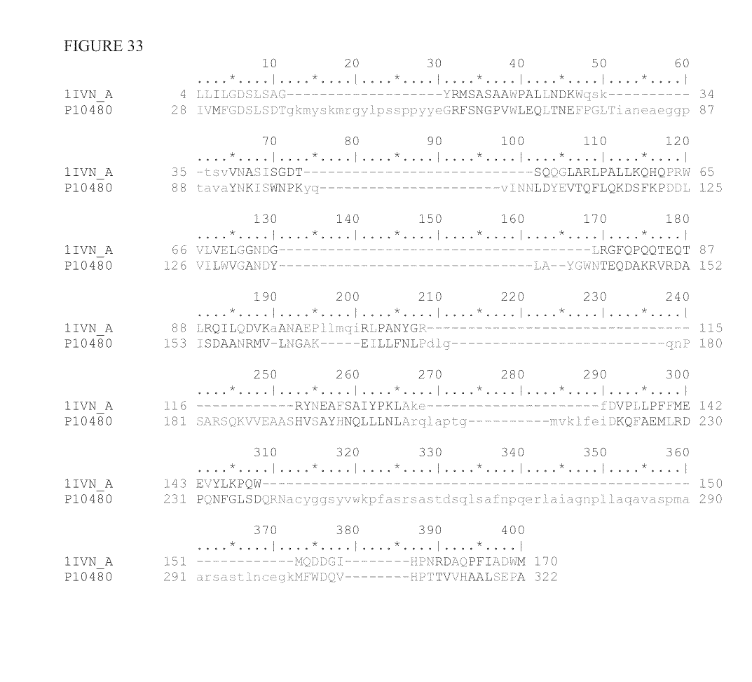

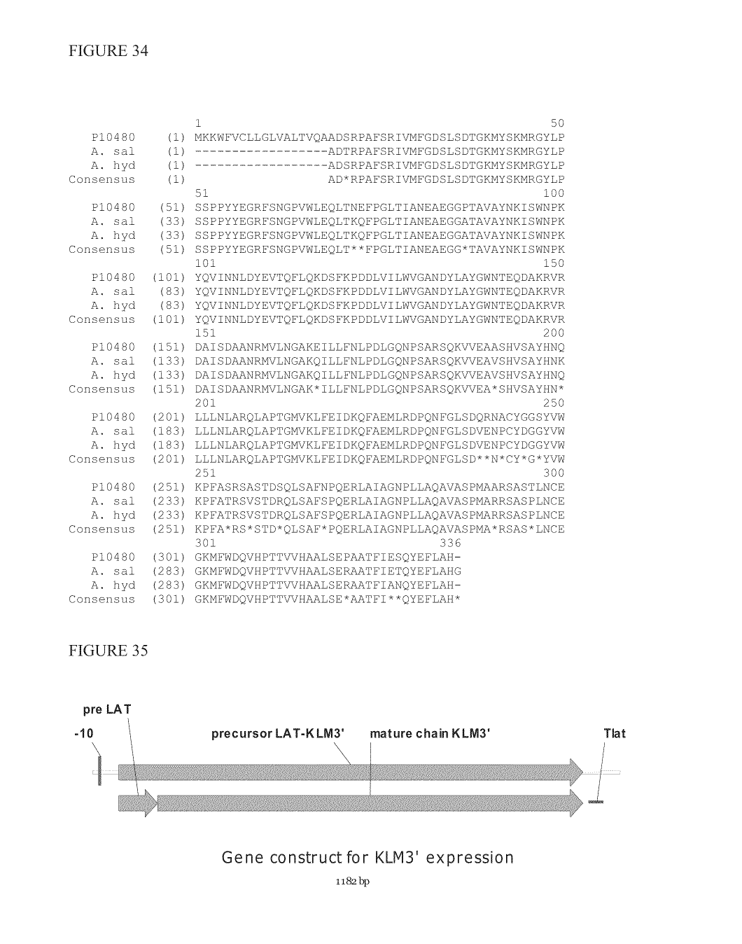

An alignment of the L131 and homologues from S. avermitilis and T. fusca illustrates that the conservation of the GDSx motif (GDSY in L131 and S. avermitilis and T. fusca), the GANDY box, which is either GGNDA or GGNDL, and the HPT block (considered to be the conserved catalytic histidine). These three conserved blocks are highlighted in FIG. 26.

When aligned to either the pfam Pfam00657 consensus sequence (as described in WO04/064987) and/or the L131 sequence herein disclosed (SEQ ID No. 22) it is possible to identify three conserved regions, the GDSx block, the GANDY block and the HTP block (see WO04/064987 for further details).

When aligned to either the pfam Pfam00657 consensus sequence (as described in WO04/064987) and/or the L131 sequence herein disclosed (SEQ ID No. 22):
(i) the lipid acyltransferase for use in any one of the methods and uses of the present invention may be a lipid acyltransferase that has a GDSx motif, more preferably a GDSx motif selected from GDSL or GDSY motif; and/or
(ii) the lipid acyltransferase for use in any one of the methods and uses of the present invention may be a lipid acyltransferase that, has a GANDY block, more preferably a GANDY block comprising GGNDx, more preferably GGNDA or GGNDL; and/or
(iii) the lipid acyltransferase for use in any one of the methods and uses of the present invention may be a lipid acyltransferase that has preferably an HTP block; and preferably
(iv) the lipid acyltransferase for use in any one of the methods and uses of the present invention may be a lipid acyltransferase that has preferably a GDSx or GDSY motif, and a GANDY block comprising amino GGNDx, preferably GGNDA or GGNDL, and a HTP block (conserved histidine).

In one embodiment the enzyme according to the present invention may be preferably not a phospholipase enzyme, such as a phospholipase A1 classified as E.C. 3.1.1.32 or a phospholipase A2 classified as E.C. 3.1.1.4.

### Advantages

One advantage of the present invention is that the use of a lipid acyltransferase in accordance with the present invention results in a reduction in cholesterol in meat based food products.

A further advantage of the present invention is the reduction of cholesterol in the meat based food product whilst maintaining and/or improving one or more of the following characteristics: fat stability so that fat losses are minimized and the amount of visible fat is reduced in meat based food products; taste, texture, weight loss and appearance

A further advantage of the present invention is the production of a meat based food product with an increased fat stability (i.e. a reduction in the amount of visible fat and/or a reduction in greasiness and/or a reduction in fat separation during thermal processing) and/or an improved texture and/or a reduced weight loss.

Another advantage of the present invention is that the process is such that the proliferation of spoilage bacteria, pathogens and fungi in the meat and/or meat based food product during processing is reduced or kept to a minimum.

It is a further advantage of the present invention (for example when used with emulsified meat products with a considerable fat content, e.g. fine paste sausages and pâtés) that the fat stability is increased so that fat losses are minimized and the amount of visible fat is reduced. Additionally, the loss of meat juice may be kept low, and/or that the taste, texture and/or appearance are acceptable.

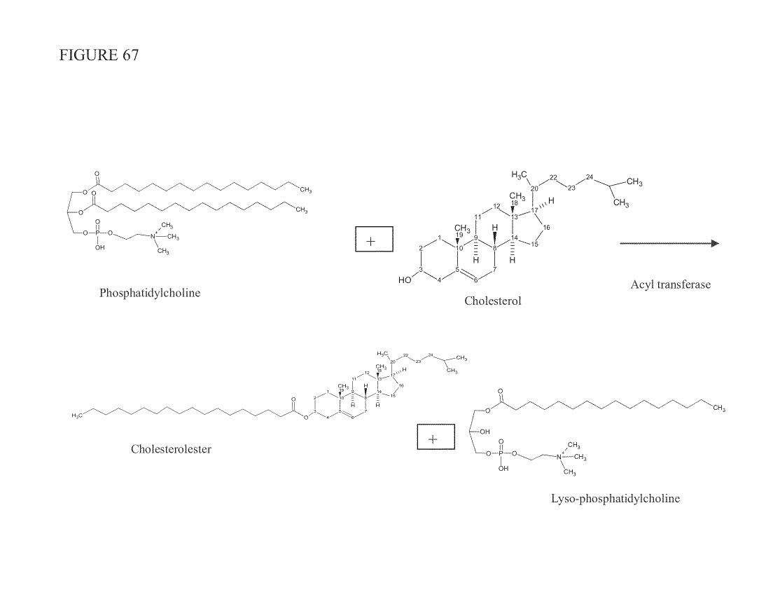

Lipid acyltransferases transfer the sn-2 ester bond of phospholipids and/or triglycerides and/or galactolipids to an acyl acceptor, such as cholesterol; resulting in the formation of lysophospholipids, and/or mono- and/or di-glycerides, and/or lysogalactolipids, respectively, and cholesterol ester (FIG. 67 illustrates this with phospholipase by way of example). The transferase leads to the release of less hydrophobic and thus more water-soluble lysophospholipids (when the substrate is a phospholipid), which have a higher dynamic surface activity because of the higher unimer concentration in the aqueous phase.

Besides its emulsifying properties, lipid acyltransferases are also able to reduce the cholesterol levels in meat by producing cholesterol ester (i.e. using the cholesterol as an acyl acceptor thus forming a cholesterol ester and reducing the amount of “free” cholesterol). Polyunsaturated fatty acids and cholesterol may undergo oxidation during preparation and prolonged storage of meat products. This oxidation produces numerous compounds (hydroperoxides, aldehydes, ketones, cholesterol oxides, such as oxysterols, etc.) some of which are believed to have mutagenic and carcinogenic effects, and cytotoxic properties. (Jiménez-Colmenero et al 2001: Healthier meat and meat products: their role as functional foods. Meat science 59, 5-13). Therefore the reduction of cholesterol is advantageous as it potentially reduces the potentially harmful compounds being formed from its oxidation. In addition, the meat based food product can be used as part of a diet to reduce cholesterol as they will constitute a reduced cholesterol product, which is often recommended in a healthy diet.

A further advantage of the present invention is that it results in a meat or meat based food product with improved (increased) heat stability.

### Host Cell

The lipid acyltransferase for use in the present invention may be produced recombinantly in a host cell or organism.

The host organism can be a prokaryotic or a eukaryotic organism.

In one embodiment of the present invention the lipid acyl transferase according to the present invention in expressed in a host cell, for example a bacterial cell, such as a Bacillus spp, for example a Bacillus licheniformis host cell.

Alternative host cells may be fungi, yeasts or plants for example.

It has been found that the use of a Bacillus licheniformis host cell results in increased expression of a lipid acyltransferase when compared with other organisms, such as Bacillus subtilis.

A lipid acyltransferase from Aeromonas salmonicida has been inserted into a number of conventional expression vectors, designed to be optimal for the expression in Bacillus subtilis, Hansenula polymorpha, Schizosaccharomyces pombe and Aspergillus tubigensis, respectively. Only very low levels were, however, detected in Hansenula polymorpha, Schizosaccharomyces pombe and Aspergillus tubigensis. The expression levels were below 1 μg/ml, and it was not possible to select cells which yielded enough protein to initiate a commercial production (results not shown). In contrast, Bacillus licheniformis was able to produce protein levels, which are attractive for an economically feasible production.

In particular, it has been found that expression in B. licheniformis is approximately 100-times greater than expression in B. subtilis under the control of aprE promoter or is approximately 100-times greater than expression in S. lividans under the control of an A4 promoter and fused to cellulose (results not shown herein).

The host cell may be any Bacillus cell other than B. subtilis. Preferably, said Bacillus host cell being from one of the following species: Bacillus licheniformis; B. alkalophilus; B. amyloliquefaciens; B. circulans; B. clausii; B. coagulans; B. firmus; B. lautus; B. lentus; B. megaterium; B. pumilus or B. stearothermophilus.

The term “host cell”—in relation to the present invention includes any cell that comprises either a nucleotide sequence encoding a lipid acyltransferase as defined herein or an expression vector as defined herein and which is used in the recombinant production of a lipid acyltransferase having the specific properties as defined herein.

Suitably, the host cell may be a protease deficient or protease minus strain and/or an α-amylase deficient or α-amylase minus strain.

The term “heterologous” as used herein means a sequence derived from a separate genetic source or species. A heterologous sequence is a non-host sequence, a modified sequence, a sequence from a different host cell strain, or a homologous sequence from a different chromosomal location of the host cell.

A “homologous” sequence is a sequence that is found in the same genetic source or species i.e. it is naturally occurring in the relevant species of host cell.

The term “recombinant lipid acyltransferase” as used herein means that the lipid acyltransferase has been produced by means of genetic recombination. For instance, the nucleotide sequence encoding the lipid acyltansferase has been inserted into a cloning vector, resulting in a B. licheniformis cell characterized by the presence of the heterologous lipid acyltransferase.

### Regulatory Sequences

In some applications, a lipid acyltransferase sequence for use in the methods and/or uses of the present invention may be obtained by operably linking a nucleotide sequence encoding same to a regulatory sequence which is capable of providing for the expression of the nucleotide sequence, such as by the chosen host cell (such as a B. licheniformis cell).

By way of example, a vector comprising the nucleotide sequence of the present invention operably linked to such a regulatory sequence, i.e. the vector is an expression vector, may be used.

The term “operably linked” refers to a juxtaposition wherein the components described are in a relationship permitting them to function in their intended manner. A regulatory sequence “operably linked” to a coding sequence is ligated in such a way that expression of the coding sequence is achieved under conditions compatible with the control sequences.

The term “regulatory sequences” includes promoters and enhancers and other expression regulation signals.

The term “promoter” is used in the normal sense of the art, e.g. an RNA polymerase binding site.

Enhanced expression of the nucleotide sequence encoding the enzyme having the specific properties as defined herein may also be achieved by the selection of regulatory regions, e.g. promoter, secretion leader and terminator regions that are not regulatory regions for the nucleotide sequence encoding the enzyme in nature.

Suitably, the nucleotide sequence of the present invention may be operably linked to at least a promoter.

Suitably, the nucleotide sequence encoding a lipid acyltransferase may be operably linked to at a nucleotide sequence encoding a terminator sequence. Examples of suitable terminator sequences for use in any one of the vectors, host cells, methods and/or uses of the present invention include: an α-amylase terminator sequence (for instance, CGGGACTTACCGAAAGAAACCATCAATGATGGTTTCTTTTTTGTTCATAAA—SEQ ID No. 57), an alkaline protease terminator sequence (for instance, CAAGACTAAAGACCGTTCGCCCGTTTTTGCAATAAGCGGGCGAATCTTACATAAAAA TA—SEQ ID No. 58), a glutamic-acid specific terminator sequence (for instance, ACGGCCGTTAGATGTGACAGCCCGTTCCAAAAGGAAGCGGGCTGTCTTCGTGTATTA TTGT—SEQ ID No. 59), a levanase terminator sequence (for instance, TCTTTTAAAGGAAAGGCTGGAATGCCCGGCATTCCAGCCACATGATCATCGTTT—SEQ ID No. 60) and a subtilisin E terminator sequence (for instance, GCTGACAAATAAAAAGAAGCAGGTATGGAGGAACCTGCTTCTTTTTACTATTATTG—SEQ ID No. 61).

Suitably, the nucleotide sequence encoding a lipid acyltransferase may be operably linked to an α-amylase terminator, such as a B. licheniformis α-amylase terminator.

### Promoter

The promoter sequence to be used in accordance with the present invention may be heterologous or homologous to the sequence encoding a lipid acyltransferase.

The promoter sequence may be any promoter sequence capable of directing expression of a lipid acyltransferase in the host cell of choice.

Suitably, the promoter sequence may be homologous to a Bacillus species, for example B. licheniformis. Preferably, the promoter sequence is homologous to the host cell of choice.

Suitably the promoter sequence may be homologous to the host cell. “Homologous to the host cell” means originating within the host organism; i.e. a promoter sequence which is found naturally in the host organism.

Suitably, the promoter sequence may be selected from the group consisting of a nucleotide sequence encoding: an α-amylase promoter, a protease promoter, a subtilisin promoter, a glutamic acid-specific protease promoter and a levansucrase promoter.

Suitably the promoter sequence may be a nucleotide sequence encoding: the LAT (e.g. the alpha-amylase promoter from B. licheniformis, also known as AmyL), AprL (e.g. subtilisin Carlsberg promoter), EndoGluC (e.g. the glutamic-acid specific promoter from B. licheniformis), AmyQ (e.g. the alpha amylase promoter from B. amyloliquefaciens alpha-amylase promoter) and SacB (e.g. the B. subtilis levansucrase promoter).

Other examples of promoters suitable for directing the transcription of a nucleic acid sequence in the methods of the present invention include, but are not limited to: the promoter of the Bacillus lentus alkaline protease gene (aprH); the promoter of the Bacillus subtilis alpha-amylase gene (amyE); the promoter of the Bacillus stearothermophilus maltogenic amylase gene (amyM); the promoter of the Bacillus licheniformis penicillinase gene (penP); the promoters of the Bacillus subtilis xylA and xylB genes; and/or the promoter of the Bacillus thuringiensis subsp. tenebrionis CryIIIA gene.

In a preferred embodiment, the promoter sequence is an α-amylase promoter (such as a Bacillus licheniformis α-amylase promoter). Preferably, the promoter sequence comprises the -35 to -10 sequence of the B. licheniformis α-amylase promoter—see FIGS. 53 and 55.

The “-35 to -10 sequence” describes the position relative to the transcription start site. Both the “-35” and the “-10” are boxes, i.e. a number of nucleotides, each comprising 6 nucleotides and these boxes are separated by 17 nucleotides. These 17 nucleotides are often referred to as a “spacer”. This is illustrated in FIG. 55, where the -35 and the -10 boxes are underlined. For the avoidance of doubt, where “-35 to -10 sequence” is used herein it refers to a sequence from the start of the -35 box to the end of the -10 box i.e. including both the -35 box, the 17 nucleotide long spacer and the -10 box.

### Signal Peptide

The lipid acyltransferase produced by a host cell by expression of the nucleotide sequence encoding the lipid acyltransferase may be secreted or may be contained intracellularly depending on the sequence and/or the vector used.

A signal sequence may be used to direct secretion of the coding sequences through a particular cell membrane. The signal sequences may be natural or foreign to the lipid acyltransferase coding sequence. For instance, the signal peptide coding sequence may be obtained form an amylase or protease gene from a Bacillus species, preferably from Bacillus licheniformis.

Suitable signal peptide coding sequences may be obtained from one or more of the following genes: maltogenic α-amylase gene, subtilisin gene, beta-lactamase gene, neutral protease gene, prsA gene, and/or acyltransferase gene.

Preferably, the signal peptide is a signal peptide of B. licheniformis α-amylase, Aeromonas acyltransferase (for instance, mkkwfvcllglialtvqa—SEQ ID No. 54), B. subtilis subtilisin (for instance, mrskklwisllfaltliftmafsnmsaqa—SEQ ID No. 55) or B. licheniformis subtilisin (for instance, mmrkksfwfgmltafmlvftmefsdsasa—SEQ ID No. 56). Suitably, the signal peptide may be the signal peptide of B. licheniformis α-amylase.

However, any signal peptide coding sequence capable of directing the expressed lipid acyltransferase into the secretory pathway of a Bacillus host cell (preferably a B. licheniformis host cell) of choice may be used.

In some embodiments of the present invention, a nucleotide sequence encoding a signal peptide may be operably linked to a nucleotide sequence encoding a lipid acyltransferase of choice.

The lipid acyltransferase of choice may be expressed in a host cell as defined herein as a fusion protein.

### Expression Vector

The term “expression vector” means a construct capable of in vivo or in vitro expression.

Preferably, the expression vector is incorporated in the genome of the organism, such as a B. licheniformis host. The term “incorporated” preferably covers stable incorporation into the genome.

The nucleotide sequence encoding a lipid acyltransferase as defined herein may be present in a vector, in which the nucleotide sequence is operably linked to regulatory sequences such that the regulatory sequences are capable of providing the expression of the nucleotide sequence by a suitable host organism (such as B. licheniformis), i.e. the vector is an expression vector.

The vectors of the present invention may be transformed into a suitable host cell as described above to provide for expression of a polypeptide having lipid acyltransferase activity as defined herein.

The choice of vector, e.g. plasmid, cosmid, virus or phage vector, genomic insert, will often depend on the host cell into which it is to be introduced. The present invention may cover other forms of expression vectors which serve equivalent functions and which are, or become, known in the art.

Once transformed into the host cell of choice, the vector may replicate and function independently of the host cell's genome, or may integrate into the genome itself.

The vectors may contain one or more selectable marker genes—such as a gene which confers antibiotic resistance e.g. ampicillin, kanamycin, chloramphenicol or tetracyclin resistance. Alternatively, the selection may be accomplished by co-transformation (as described in WO91/17243).

Vectors may be used in vitro, for example for the production of RNA or used to transfect or transform a host cell.

The vector may further comprise a nucleotide sequence enabling the vector to replicate in the host cell in question. Examples of such sequences are the origins of replication of plasmids pUC19, pACYC177, pUB110, pE194, pAMB1 and pIJ702.

### Variant Lipid Acyltransferase

In one embodiment the nucleotide sequence encoding a lipid acyltransferase or the lipid acyltransferase for use in any one of the methods and/or uses of the present invention may encode or be a variant lipid acyltransferase.

Variants which have an increased activity on phospholipids, such as increased transferase activity on phospholipids may be used.

Suitable methods for modifying lipid acyltransferases to produce variant lipid acyltransferases are taught in WO2005/066347 (which is incorporated herein by reference).

One preferred modification is N80D. This is particularly the case when using the sequence SEQ ID No. 20 as the backbone. Thus, the sequence may be SEQ ID No. 15 or SEQ ID No. 37. This modification may be in combination with one or more further modifications.

As noted above, when referring to specific amino acid residues herein the numbering is that obtained from alignment of the variant sequence with the reference sequence shown as SEQ ID No. 19 or SEQ ID No. 20.

Much by preference, the nucleotide sequence encoding a lipid acyltransferase for use in any one of the methods and uses of the present invention may encode a lipid comprising the amino acid sequence shown as SEQ ID No. 15 or the amino acid sequence shown as SEQ ID No. 37, or an amino acid sequence which has 70% or more, preferably 75% or more, preferably 85% or more, more preferably 90% or more, even more preferably 95% or more, even more preferably 98% or more, or even more preferably 99% or more identity to SEQ ID No. 16 or SEQ ID No. 68. This enzyme may be considered a variant enzyme.

### DEFINITIONS

The term “transferase” as used herein is interchangeable with the term “lipid acyltransferase”.

Suitably, the lipid acyltransferase as defined herein catalyses one or more of the following reactions: interesterification, transesterification, alcoholysis, hydrolysis.

The term “interesterification” refers to the enzymatic catalyzed transfer of acyl groups between a lipid donor and lipid acceptor, wherein the lipid donor is not a free acyl group.

The term “transesterification” as used herein means the enzymatic catalyzed transfer of an acyl group from a lipid donor (other than a free fatty acid) to an acyl acceptor (other than water). The lipid acyltransferase for use in the methods and/or uses of the present invention is one which preferably undergoes a transesterification reaction between a lipid (preferably a phospholipid) and a sterol (preferably cholesterol).

As used herein, the term “alcoholysis” refers to the enzymatic cleavage of a covalent bond of an acid derivative by reaction with an alcohol ROH so that one of the products combines with the H of the alcohol and the other product combines with the OR group of the alcohol.

As used herein, the term “hydrolysis” refers to the enzymatic catalyzed transfer of an acyl group from a lipid to the OH group of a water molecule.

Combination with Other Enzymes

In one preferred embodiment the lipid acyltransferase is used in combination with a lipase having one or more of the following enzyme activities: glycolipase activity (E.C. 3.1.1.26, phospholipase A2 activity (E.C. 3.1.1.4) or phospholipase A1 activity (E.C. 3.1.1.32). Suitably, lipase enzymes are well known within the art and include, but are not limited to, by way of example the following lipases: a phospholipase A1 LECITASE® ULTRA (Novozymes A/S, Denmark), phospholipase A2 (e.g. phospholipase A2 from LIPOMOD™ 22L from Biocatalysts, LIPOMAX™ and LysoMax PLA2™ from Genecor), LIPOLASE® (Novozymes A/S, Denmark).

In some embodiments it may be beneficial to combine the use of lipid acyltransferase with a phospholipase, such as phospholipase A1, phospholipase A2, phospholipase B, Phospholipase C and/or phospholipase D.

The combined use may be performed sequentially or concurrently, e.g. the lipid acyl transferase treatment may occur prior to or during the further enzyme treatment.

Alternatively, the further enzyme treatment may occur prior to or during the lipid acyltransferase treatment.

In the case of sequential enzyme treatments, in some embodiments it may be advantageous to remove the first enzyme used, e.g. by heat deactivation or by use of an immobilised enzyme, prior to treatment with the second (and/or third etc.) enzyme.

### Post-Transcription and Post-Translational Modifications

Suitably the lipid acyltransferase in accordance with the present invention may be encoded by any one of the nucleotide sequences taught herein.

Depending upon the host cell used post-transcriptional and/or post-translational modifications may be made. It is envisaged that the lipid acyltransferase for use in the present methods and/or uses encompasses lipid acyltransferases which have undergone post-transcriptional and/or post-translational modification.

By way of example only, the expression of the nucleotide sequence shown herein as SEQ ID No. 26 (see FIG. 39) in a host cell (such as Bacillus licheniformis for example) results in post-transcriptional and/or post-translational modifications which lead to the amino acid sequence shown herein as SEQ ID No. 37 (see FIG. 50).

SEQ ID No. 37 is the same as SEQ ID No. 15 (shown herein in FIG. 1) except that SEQ ID No. 37 has undergone post-translational and/or post-transcriptional modification to remove 38 amino acids.

### Isolated

In one aspect, the lipid acyltransferase is a recovered/isolated lipid acyltransferase. Thus, the lipid acyltransferase produced may be in an isolated form.

In another aspect, the nucleotide sequence encoding a lipid acyltransferase for use in the present invention may be in an isolated form.

The term “isolated” means that the sequence or protein is at least substantially free from at least one other component with which the sequence or protein is naturally associated in nature and as found in nature.

### Purified

In one aspect, the lipid acyltransferase may be in a purified form.

In another aspect, the nucleotide sequence encoding a lipid acyltransferase for use in the present invention may be in a purified form.

The term “purified” means that the sequence is in a relatively pure state—e.g. at least about 51% pure, or at least about 75%, or at least about 80%, or at least about 90% pure, or at least about 95% pure or at least about 98% pure.

### Cloning a Nucleotide Sequence Encoding a Polypeptide According to the Present Invention

A nucleotide sequence encoding either a polypeptide which has the specific properties as defined herein or a polypeptide which is suitable for modification may be isolated from any cell or organism producing said polypeptide. Various methods are well known within the art for the isolation of nucleotide sequences.

For example, a genomic DNA and/or cDNA library may be constructed using chromosomal DNA or messenger RNA from the organism producing the polypeptide. If the amino acid sequence of the polypeptide is known, labeled oligonucleotide probes may be synthesized and used to identify polypeptide-encoding clones from the genomic library prepared from the organism. Alternatively, a labeled oligonucleotide probe containing sequences homologous to another known polypeptide gene could be used to identify polypeptide-encoding clones. In the latter case, hybridization and washing conditions of lower stringency are used.

Alternatively, polypeptide-encoding clones could be identified by inserting fragments of genomic DNA into an expression vector, such as a plasmid, transforming enzyme-negative bacteria with the resulting genomic DNA library, and then plating the transformed bacteria onto agar containing an enzyme inhibited by the polypeptide, thereby allowing clones expressing the polypeptide to be identified.

In a yet further alternative, the nucleotide sequence encoding the polypeptide may be prepared synthetically by established standard methods, e.g. the phosphoroamidite method described by Beucage S. L. et al (1981) Tetrahedron Letters 22, p 1859-1869, or the method described by Matthes et al (1984) EMBO J. 3, p 801-805. In the phosphoroamidite method, oligonucleotides are synthesized, e.g. in an automatic DNA synthesizer, purified, annealed, ligated and cloned in appropriate vectors.

The nucleotide sequence may be of mixed genomic and synthetic origin, mixed synthetic and cDNA origin, or mixed genomic and cDNA origin, prepared by ligating fragments of synthetic, genomic or cDNA origin (as appropriate) in accordance with standard techniques. Each ligated fragment corresponds to various parts of the entire nucleotide sequence. The DNA sequence may also be prepared by polymerase chain reaction (PCR) using specific primers, for instance as described in U.S. Pat. No. 4,683,202 or in Saiki R K et at (Science (1988) 239, pp 487-491).

### Nucleotide Sequences

The present invention also encompasses nucleotide sequences encoding polypeptides having the specific properties as defined herein. The term “nucleotide sequence” as used herein refers to an oligonucleotide sequence or polynucleotide sequence, and variant, homologues, fragments and derivatives thereof (such as portions thereof). The nucleotide sequence may be of genomic or synthetic or recombinant origin, which may be double-stranded or single-stranded whether representing the sense or antisense strand.

The term “nucleotide sequence” in relation to the present invention includes genomic DNA, cDNA, synthetic DNA, and RNA. Preferably it means DNA, more preferably cDNA for the coding sequence.

In a preferred embodiment, the nucleotide sequence per se encoding a polypeptide having the specific properties as defined herein does not cover the native nucleotide sequence in its natural environment when it is linked to its naturally associated sequence(s) that is/are also in its/their natural environment. For ease of reference, we shall call this preferred embodiment the “non-native nucleotide sequence”. In this regard, the term “native nucleotide sequence” means an entire nucleotide sequence that is in its native environment and when operatively linked to an entire promoter with which it is naturally associated, which promoter is also in its native environment. Thus, the polypeptide of the present invention can be expressed by a nucleotide sequence in its native organism but wherein the nucleotide sequence is not under the control of the promoter with which it is naturally associated within that organism.

Preferably the polypeptide is not a native polypeptide. In this regard, the term “native polypeptide” means an entire polypeptide that is in its native environment and when it has been expressed by its native nucleotide sequence.

Typically, the nucleotide sequence encoding polypeptides having the specific properties as defined herein is prepared using recombinant DNA techniques (i.e. recombinant DNA). However, in an alternative embodiment of the invention, the nucleotide sequence could be synthesized, in whole or in part, using chemical methods well known in the art (see Caruthers M H et at (1980) Nuc Acids Res Symp Ser 215-23 and Horn T et at (1980) Nuc Acids Res Symp Ser 225-232).

### Molecular Evolution

Once an enzyme-encoding nucleotide sequence has been isolated, or a putative enzyme-encoding nucleotide sequence has been identified, it may be desirable to modify the selected nucleotide sequence, for example it may be desirable to mutate the sequence in order to prepare an enzyme in accordance with the present invention.

Mutations may be introduced using synthetic oligonucleotides. These oligonucleotides contain nucleotide sequences flanking the desired mutation sites.

A suitable method is disclosed in Morinaga et at (Biotechnology (1984) 2, p 646-649). Another method of introducing mutations into enzyme-encoding nucleotide sequences is described in Nelson and Long (Analytical Biochemistry (1989), 180, p 147-151).

Instead of site directed mutagenesis, such as described above, one can introduce mutations randomly for instance using a commercial kit such as the GeneMorph PCR mutagenesis kit from Stratagene, or the Diversify PCR random mutagenesis kit from Clontech. EP 0 583 265 refers to methods of optimizing PCR based mutagenesis, which can also be combined with the use of mutagenic DNA analogues such as those described in EP 0 866 796. Error prone PCR technologies are suitable for the production of variants of lipid acyl transferases with preferred characteristics. WO0206457 refers to molecular evolution of lipases.

A third method to obtain novel sequences is to fragment non-identical nucleotide sequences, either by using any number of restriction enzymes or an enzyme such as Dnase I, and reassembling full nucleotide sequences coding for functional proteins. Alternatively one can use one or multiple non-identical nucleotide sequences and introduce mutations during the reassembly of the full nucleotide sequence. DNA shuffling and family shuffling technologies are suitable for the production of variants of lipid acyl transferases with preferred characteristics. Suitable methods for performing ‘shuffling’ can be found in EP0 752 008, EP1 138 763, EP1 103 606. Shuffling can also be combined with other forms of DNA mutagenesis as described in U.S. Pat. No. 6,180,406 and WO 01/34835.

Thus, it is possible to produce numerous site directed or random mutations into a nucleotide sequence, either in vivo or in vitro, and to subsequently screen for improved functionality of the encoded polypeptide by various means. Using in silico and exo mediated recombination methods (see WO 00/58517, U.S. Pat. No. 6,344,328, U.S. Pat. No. 6,361,974), for example, molecular evolution can be performed where the variant produced retains very low homology to known enzymes or proteins. Such variants thereby obtained may have significant structural analogy to known transferase enzymes, but have very low amino acid sequence homology.

As a non-limiting example, In addition, mutations or natural variants of a polynucleotide sequence can be recombined with either the wild type or other mutations or natural variants to produce new variants. Such new variants can also be screened for improved functionality of the encoded polypeptide.

The application of the above-mentioned and similar molecular evolution methods allows the identification and selection of variants of the enzymes of the present invention which have preferred characteristics without any prior knowledge of protein structure or function, and allows the production of non-predictable but beneficial mutations or variants. There are numerous examples of the application of molecular evolution in the art for the optimization or alteration of enzyme activity, such examples include, but are not limited to one or more of the following: optimized expression and/or activity in a host cell or in vitro, increased enzymatic activity, altered substrate and/or product specificity, increased or decreased enzymatic or structural stability, altered enzymatic activity/specificity in preferred environmental conditions, e.g. temperature, pH, substrate

As will be apparent to a person skilled in the art, using molecular evolution tools an enzyme may be altered to improve the functionality of the enzyme.

Suitably, the nucleotide sequence encoding a lipid acyltransferase used in the invention may encode a variant lipid acyltransferase, i.e. the lipid acyltransferase may contain at least one amino acid substitution, deletion or addition, when compared to a parental enzyme. Variant enzymes retain at least 1%, 2%, 3%, 5%, 10%, 15%, 20%, 30%, 40%, 50%, 60%, 70%, 80%, 90%, 95%, 97%, 99% homology with the parent enzyme. Suitable parent enzymes may include any enzyme with esterase or lipase activity. Preferably, the parent enzyme aligns to the pfam00657 consensus sequence.

In a preferable embodiment a variant lipid acyltransferase enzyme retains or incorporates at least one or more of the pfam00657 consensus sequence amino acid residues found in the GDSx, GANDY and HPT blocks.

Suitably, the nucleotide sequence encoding a lipid acyltransferase for use in any one of the methods and/or uses of the present invention may encode a lipid acyltransferase that may be a variant with enhanced enzyme activity on polar lipids, preferably phospholipids and/or glycolipids when compared to the parent enzyme. Preferably, such variants also have low or no activity on lyso polar lipids.

Variant lipid acyltransferases may have decreased activity on triglycerides, and/or monoglycerides and/or diglycerides compared with the parent enzyme.

Suitably the variant enzyme may have no activity on triglycerides and/or monoglycerides and/or diglycerides.

Alternatively, the variant enzyme may have increased thermostability.

The variant enzyme may have increased activity on one or more of the following, polar lipids, phospholipids, lecithin, phosphatidylcholine, glycolipids, digalactosyl monoglyceride, monogalactosyl monoglyceride.

Variants of lipid acyltransferases are known, and one or more of such variants may be suitable for use in the methods and uses according to the present invention and/or in the enzyme compositions according to the present invention. By way of example only, variants of lipid acyltransferases are described in the following references may be used in accordance with the present invention: Hilton & Buckley J Biol. Chem. 1991 Jan. 15: 266 (2): 997-1000; Robertson et at J. Biol. Chem. 1994 Jan. 21; 269(3):2146-50; Brumlik et at J. Bacteriol 1996 April; 178 (7): 2060-4; Peelman et at Protein Sci. 1998 March; 7(3):587-99.

### Amino Acid Sequences

The present invention also encompasses the use of amino acid sequences encoded by a nucleotide sequence which encodes a lipid acyltransferase for use in any one of the methods and/or uses of the present invention.

As used herein, the term “amino acid sequence” is synonymous with the term “polypeptide” and/or the term “protein”. In some instances, the term “amino acid sequence” is synonymous with the term “peptide”.

The amino acid sequence may be prepared/isolated from a suitable source, or it may be made synthetically or it may be prepared by use of recombinant DNA techniques.

Suitably, the amino acid sequences may be obtained from the isolated polypeptides taught herein by standard techniques.

One suitable method for determining amino acid sequences from isolated polypeptides is as follows:

Purified polypeptide may be freeze-dried and 100 μg of the freeze-dried material may be dissolved in 50 μl of a mixture of 8 M urea and 0.4 M ammonium hydrogen carbonate, pH 8.4. The dissolved protein may be denatured and reduced for 15 minutes at 50° C. following overlay with nitrogen and addition of 5 μl of 45 mM dithiothreitol. After cooling to room temperature, 5 μl of 100 mM iodoacetamide may be added for the cysteine residues to be derivatized for 15 minutes at room temperature in the dark under nitrogen.

135 μl of water and 5 μg of endoproteinase Lys-C in 5 μl of water may be added to the above reaction mixture and the digestion may be carried out at 37° C. under nitrogen for 24 hours.

The resulting peptides may be separated by reverse phase HPLC on a VYDAC C18 column (0.46×15 cm; 10 μm; The Separation Group, California, USA) using solvent A: 0.1% TFA in water and solvent B: 0.1% TFA in acetonitrile. Selected peptides may be re-chromatographed on a Develosil C18 column using the same solvent system, prior to N-terminal sequencing. Sequencing may be done using an Applied Biosystems 476A sequencer using pulsed liquid fast cycles according to the manufacturer's instructions (Applied Biosystems, California, USA).

### Sequence Identity or Sequence Homology

Here, the term “homologue” means an entity having a certain homology with the subject amino acid sequences and the subject nucleotide sequences. Here, the term “homology” can be equated with “identity”.

The homologous amino acid sequence and/or nucleotide sequence should provide and/or encode a polypeptide which retains the functional activity and/or enhances the activity of the enzyme.

In the present context, a homologous sequence is taken to include an amino acid sequence which may be at least 75, 85 or 90% identical, preferably at least 95 or 98% identical to the subject sequence. Typically, the homologues will comprise the same active sites etc. as the subject amino acid sequence. Although homology can also be considered in terms of similarity (i.e. amino acid residues having similar chemical properties/functions), in the context of the present invention it is preferred to express homology in terms of sequence identity.

In the present context, a homologous sequence is taken to include a nucleotide sequence which may be at least 75, 85 or 90% identical, preferably at least 95 or 98% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e. amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences.

% homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalizing unduly the overall homology score. This is achieved by inserting “gaps” in the sequence alignment to try to maximize local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimized alignments with fewer gaps. Most alignment programs allow the gap penalties to be modified. However, it is preferred to use the default values when using such software for sequence comparisons.

Calculation of maximum % homology therefore firstly requires the production of an optimal alignment, taking into consideration gap penalties. A suitable computer program for carrying out such an alignment is the Vector NTI (Invitrogen Corp.). Examples of other software that can perform sequence comparisons include, but are not limited to, the BLAST package (see Ausubel et at 1999 Short Protocols in Molecular Biology, 4^{th} Ed—Chapter 18), and FASTA (Altschul et at 1990 J. Mol. Biol. 403-410). Both BLAST and FASTA are available for offline and online searching (see Ausubel et at 1999, pages 7-58 to 7-60). However, for some applications, it is preferred to use the Vector NTI program. A new tool, called BLAST 2 Sequences is also available for comparing protein and nucleotide sequence (see FEMS Microbiol Lett 1999 174(2): 247-50; FEMS Microbiol Lett 1999 177(1): 187-8 and tatiana@ncbi.nlm.nih.gov).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI package.

Alternatively, percentage homologies may be calculated using the multiple alignment feature in Vector NTI (Invitrogen Corp.), based on an algorithm, analogous to CLUSTAL (Higgins D G & Sharp P M (1988), Gene 73(1), 237-244).

Once the software has produced an optimal alignment, it is possible to calculate % homology, preferably % sequence identity. The software typically does this as part of the sequence comparison and generates a numerical result.

Should Gap Penalties be used when determining sequence identity, then preferably the following parameters are used for pairwise alignment:

| FOR BLAST | |
|---|---|
| GAP OPEN | 0 |
| GAP EXTENSION | 0 |

| FOR CLUSTAL | DNA | PROTEIN | |
|---|---|---|---|
| WORD SIZE | 2 | 1 | K triple |
| GAP PENALTY | 15 | 10 | |
| GAP EXTENSION | 6.66 | 0.1 | |

In one embodiment, preferably the sequence identity for the nucleotide sequences is determined using CLUSTAL with the gap penalty and gap extension set as defined above.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence may be determined over the whole sequence.

In one embodiment the degree of amino acid sequence identity in accordance with the present invention may be suitably determined by means of computer programs known in the art, such as Vector NTI 10 (Invitrogen Corp.). For pairwise alignment the matrix used is preferably BLOSUM62 with Gap opening penalty of 10.0 and Gap extension penalty of 0.1.

Suitably, the degree of identity with regard to an amino acid sequence is determined over at least 20 contiguous amino acids, preferably over at least 30 contiguous amino acids, preferably over at least 40 contiguous amino acids, preferably over at least 50 contiguous amino acids, preferably over at least 60 contiguous amino acids.

Suitably, the degree of identity with regard to an amino acid sequence may be determined over the whole sequence.

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other:

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyriylalanine, thienylalanine, naphthylalanine and phenylglycine.

Replacements may also be made by unnatural amino acids.

Variant amino acid sequences may include suitable spacer groups that may be inserted between any two amino acid residues of the sequence including alkyl groups such as methyl, ethyl or propyl groups in addition to amino acid spacers such as glycine or α-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89(20), 9367-9371 and Horwell D C, Trends Biotechnol. (1995) 13(4), 132-134.

Nucleotide sequences for use in the present invention or encoding a polypeptide having the specific properties defined herein may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences.

The present invention also encompasses the use of nucleotide sequences that are complementary to the sequences discussed herein, or any derivative, fragment or derivative thereof. If the sequence is complementary to a fragment thereof then that sequence can be used as a probe to identify similar coding sequences in other organisms etc.

Polynucleotides which are not 100% homologous to the sequences of the present invention but fall within the scope of the invention can be obtained in a number of ways. Other variants of the sequences described herein may be obtained for example by probing DNA libraries made from a range of individuals, for example individuals from different populations. In addition, other viral/bacterial, or cellular homologues particularly cellular homologues found in mammalian cells (e.g. rat, mouse, bovine and primate cells), may be obtained and such homologues and fragments thereof in general will be capable of selectively hybridizing to the sequences shown in the sequence listing herein. Such sequences may be obtained by probing cDNA libraries made from or genomic DNA libraries from other animal species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterized sequences. This may be useful where for example silent codon sequence changes are required to optimize codon preferences for a particular host cell in which the polynucleotide sequences are being expressed. Other sequence changes may be desired in order to introduce restriction polypeptide recognition sites, or to alter the property or function of the polypeptides encoded by the polynucleotides.

Polynucleotides (nucleotide sequences) of the invention may be used to produce a primer, e.g. a PCR primer, a primer for an alternative amplification reaction, a probe e.g. labelled with a revealing label by conventional means using radioactive or non-radioactive labels, or the polynucleotides may be cloned into vectors. Such primers, probes and other fragments will be at least 15, preferably at least 20, for example at least 25, 30 or 40 nucleotides in length, and are also encompassed by the term polynucleotides of the invention as used herein.

Polynucleotides such as DNA polynucleotides and probes according to the invention may be produced recombinantly, synthetically, or by any means available to those of skill in the art. They may also be cloned by standard techniques.

In general, primers will be produced by synthetic means, involving a stepwise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques. This will involve making a pair of primers (e.g. of about 15 to 30 nucleotides) flanking a region of the lipid targeting sequence which it is desired to clone, bringing the primers into contact with mRNA or cDNA obtained from an animal or human cell, performing a polymerase chain reaction under conditions which bring about amplification of the desired region, isolating the amplified fragment (e.g. by purifying the reaction mixture on an agarose gel) and recovering the amplified DNA. The primers may be designed to contain suitable restriction enzyme recognition sites so that the amplified DNA can be cloned into a suitable cloning vector.

### Hybridization

The present invention also encompasses the use of sequences that are complementary to the sequences of the present invention or sequences that are capable of hybridizing either to the sequences of the present invention or to sequences that are complementary thereto.

The term “hybridization” as used herein shall include “the process by which a strand of nucleic acid joins with a complementary strand through base pairing” as well as the process of amplification as carried out in polymerase chain reaction (PCR) technologies.

The present invention also encompasses the use of nucleotide sequences that are capable of hybridizing to the sequences that are complementary to the subject sequences discussed herein, or any derivative, fragment or derivative thereof.

The present invention also encompasses sequences that are complementary to sequences that are capable of hybridizing to the nucleotide sequences discussed herein.

Hybridization conditions are based on the melting temperature (Tm) of the nucleotide binding complex, as taught in Berger and Kimmel (1987, Guide to Molecular Cloning Techniques, Methods in Enzymology, Vol. 152, Academic Press, San Diego Calif.), and confer a defined “stringency” as explained below.

Maximum stringency typically occurs at about Tm-5° C. (5° C. below the Tm of the probe); high stringency at about 5° C. to 10° C. below Tm; intermediate stringency at about 10° C. to 20° C. below Tm; and low stringency at about 20° C. to 25° C. below Tm. As will be understood by those of skill in the art, a maximum stringency hybridization can be used to identify or detect identical nucleotide sequences while an intermediate (or low) stringency hybridization can be used to identify or detect similar or related polynucleotide sequences.

Preferably, the present invention encompasses the use of sequences that are complementary to sequences that are capable of hybridizing under high stringency conditions or intermediate stringency conditions to nucleotide sequences encoding polypeptides having the specific properties as defined herein.

More preferably, the present invention encompasses the use of sequences that are complementary to sequences that are capable of hybridizing under high stringency conditions (e.g. 65° C. and 0.1×SSC {1×SSC=0.15 M NaC, 0.015 M Na-citrate pH 7.0}) to nucleotide sequences encoding polypeptides having the specific properties as defined herein.

The present invention also relates to the use of nucleotide sequences that can hybridize to the nucleotide sequences discussed herein (including complementary sequences of those discussed herein).

The present invention also relates to the use of nucleotide sequences that are complementary to sequences that can hybridize to the nucleotide sequences discussed herein (including complementary sequences of those discussed herein).

Also included within the scope of the present invention are the use of polynucleotide sequences that are capable of hybridizing to the nucleotide sequences discussed herein under conditions of intermediate to maximal stringency.

In a preferred aspect, the present invention covers the use of nucleotide sequences that can hybridize to the nucleotide sequences discussed herein, or the complement thereof, under stringent conditions (e.g. 50° C. and 0.2×SSC).

In a more preferred aspect, the present invention covers the use of nucleotide sequences that can hybridize to the nucleotide sequences discussed herein, or the complement thereof, under high stringency conditions (e.g. 65° C. and 0.1×SSC).

### Expression of Polypeptides

A nucleotide sequence for use in the present invention or for encoding a polypeptide having the specific properties as defined herein can be incorporated into a recombinant replicable vector. The vector may be used to replicate and express the nucleotide sequence, in polypeptide form, in and/or from a compatible host cell. Expression may be controlled using control sequences which include promoters/enhancers and other expression regulation signals. Prokaryotic promoters and promoters functional in eukaryotic cells may be used. Tissue specific or stimuli specific promoters may be used. Chimeric promoters may also be used comprising sequence elements from two or more different promoters described above.

The polypeptide produced by a host recombinant cell by expression of the nucleotide sequence may be secreted or may be contained intracellularly depending on the sequence and/or the vector used. The coding sequences can be designed with signal sequences which direct secretion of the substance coding sequences through a particular prokaryotic or eukaryotic cell membrane.

### Constructs

The term “construct”—which is synonymous with terms such as “conjugate”, “cassette” and “hybrid”—includes a nucleotide sequence encoding a polypeptide having the specific properties as defined herein for use according to the present invention directly or indirectly attached to a promoter. An example of an indirect attachment is the provision of a suitable spacer group such as an intron sequence, such as the Sh1-intron or the ADH intron, intermediate the promoter and the nucleotide sequence of the present invention. The same is true for the term “fused” in relation to the present invention which includes direct or indirect attachment. In some cases, the terms do not cover the natural combination of the nucleotide sequence coding for the protein ordinarily associated with the wild type gene promoter and when they are both in their natural environment.

The construct may even contain or express a marker which allows for the selection of the genetic construct.

For some applications, preferably the construct comprises at least a nucleotide sequence of the present invention or a nucleotide sequence encoding a polypeptide having the specific properties as defined herein operably linked to a promoter.

### Organism

The term “organism” in relation to the present invention includes any organism that could comprise a nucleotide sequence according to the present invention or a nucleotide sequence encoding for a polypeptide having the specific properties as defined herein and/or products obtained therefrom.

The term “transgenic organism” in relation to the present invention includes any organism that comprises a nucleotide sequence coding for a polypeptide having the specific properties as defined herein and/or the products obtained therefrom, and/or wherein a promoter can allow expression of the nucleotide sequence coding for a polypeptide having the specific properties as defined herein within the organism. Preferably the nucleotide sequence is incorporated in the genome of the organism.

The term “transgenic organism” does not cover native nucleotide coding sequences in their natural environment when they are under the control of their native promoter which is also in its natural environment.

Therefore, the transgenic organism of the present invention includes an organism comprising any one of, or combinations of, a nucleotide sequence coding for a polypeptide having the specific properties as defined herein, constructs as defined herein, vectors as defined herein, plasmids as defined herein, cells as defined herein, or the products thereof. For example the transgenic organism can also comprise a nucleotide sequence coding for a polypeptide having the specific properties as defined herein under the control of a promoter not associated with a sequence encoding a lipid acyltransferase in nature.

### Transformation of Host Cells/Organism

The host organism can be a prokaryotic or a eukaryotic organism.

Examples of suitable prokaryotic hosts include bacteria such as E. coli and Bacillus licheniformis, preferably B. licheniformis.

Teachings on the transformation of prokaryotic hosts is well documented in the art, for example see Sambrook et al (Molecular Cloning: A Laboratory Manual, 2nd edition, 1989, Cold Spring Harbor Laboratory Press). If a prokaryotic host is used then the nucleotide sequence may need to be suitably modified before transformation—such as by removal of introns.

In another embodiment the transgenic organism can be a yeast.

Filamentous fungi cells may be transformed using various methods known in the art—such as a process involving protoplast formation and transformation of the protoplasts followed by regeneration of the cell wall in a manner known. The use of Aspergillus as a host microorganism is described in EP 0 238 023.

Another host organism can be a plant. A review of the general techniques used for transforming plants may be found in articles by Potrykus (Annu Rev Plant Physiol Plant Mol Biol [1991] 42:205-225) and Christou (Agro-Food-Industry Hi-Tech March/April 1994 17-27). Further teachings on plant transformation may be found in EP-A-0449375.

General teachings on the transformation of fungi, yeasts and plants are presented in following sections.

### Transformed Fungus

A host organism may be a fungus—such as a filamentous fungus. Examples of suitable such hosts include but are not limited to any member belonging to the genera Thermomyces, Acremonium, Aspergillus, Penicillium, Mucor, Neurospora, Trichoderma and the like.

Teachings on transforming filamentous fungi are reviewed in U.S. Pat. No. 5,741,665 which states that standard techniques for transformation of filamentous fungi and culturing the fungi are well known in the art. An extensive review of techniques as applied to N. crassa is found, for example in Davis and de Serres, Methods Enzymol (1971) 17A: 79-143.

Further teachings on transforming filamentous fungi are reviewed in U.S. Pat. No. 5,674,707.

In one aspect, the host organism can be of the genus Aspergillus, such as Aspergillus niger.

A transgenic Aspergillus according to the present invention can also be prepared by following, for example, the teachings of Turner G. 1994 (Vectors for genetic manipulation. In: Martinelli S. D., Kinghorn J. R. (Editors) Aspergillus: 50 years on. Progress in industrial microbiology vol 29. Elsevier Amsterdam 1994. pp. 641-666).

Gene expression in filamentous fungi has been reviewed in Punt et al. (2002) Trends Biotechnol 2002 May; 20(5):200-6, Archer & Peberdy Crit Rev Biotechnol (1997) 17(4):273-306.

### Transformed Yeast

In another embodiment, the transgenic organism can be a yeast.

A review of the principles of heterologous gene expression in yeast are provided in, for example, Methods Mol Biol (1995), 49:341-54, and Curr Opin Biotechnol (1997) October; 8(5):554-60

In this regard, yeast—such as the species Saccharomyces cerevisi or Pichia pastoris (see FEMS Microbiol Rev (2000 24(1):45-66), may be used as a vehicle for heterologous gene expression.

A review of the principles of heterologous gene expression in Saccharomyces cerevisiae and secretion of gene products is given by E Hinchcliffe E Kenny (1993, “Yeast as a vehicle for the expression of heterologous genes”, Yeasts, Vol 5, Anthony H Rose and J Stuart Harrison, eds, 2nd edition, Academic Press Ltd.).

For the transformation of yeast, several transformation protocols have been developed. For example, a transgenic Saccharomyces according to the present invention can be prepared by following the teachings of Hinnen et al., (1978, Proceedings of the National Academy of Sciences of the USA 75, 1929); Beggs, J D (1978, Nature, London, 275, 104); and Ito, H et at (1983, J Bacteriology 153, 163-168).

The transformed yeast cells may be selected using various selective markers—such as auxotrophic markers dominant antibiotic resistance markers.

A suitable yeast host organism can be selected from the biotechnologically relevant yeasts species such as, but not limited to, yeast species selected from Pichia spp., Hansenula spp., Kluyveromyces, Yarrowinia spp., Saccharomyces spp., including S. cerevisiae, or Schizosaccharomyce spp. including Schizosaccharomyce pombe.

A strain of the methylotrophic yeast species Pichia pastoris may be used as the host organism.

In one embodiment, the host organism may be a Hansenula species, such as H. polymorphs (as described in WO01/39544).

### Transformed Plants/Plant Cells

A host organism suitable for the present invention may be a plant. A review of the general techniques may be found in articles by Potrykus (Annu Rev Plant Physiol Plant Mol Biol 42:205-225) and Christou (Agro-Food-Industry Hi-Tech March/April 1994 17-27), or in WO01/16308. The transgenic plant may produce enhanced levels of phytosterol esters and phytostanol esters, for example.

Therefore the present invention also relates to a method for the production of a transgenic plant with enhanced levels of phytosterol esters and phytostanol esters, comprising the steps of transforming a plant cell with a lipid acyltransferase as defined herein (in particular with an expression vector or construct comprising a lipid acyltransferase as defined herein), and growing a plant from the transformed plant cell.

### Secretion

Often, it is desirable for the polypeptide to be secreted from the expression host into the culture medium from where the enzyme may be more easily recovered. According to the present invention, the secretion leader sequence may be selected on the basis of the desired expression host. Hybrid signal sequences may also be used with the context of the present invention.

Typical examples of secretion leader sequences not associated with a nucleotide sequence encoding a lipid acyltransferase in nature are those originating from the fungal amyloglucosidase (AG) gene (glaA—both 18 and 24 amino acid versions e.g. from Aspergillus), the a-factor gene (yeasts e.g. Saccharomyces, Kluyveromyces and Hansenula) or the α-amylase gene (Bacillus).

### Detection

A variety of protocols for detecting and measuring the expression of the amino acid sequence are known in the art. Examples include but are not limited to enzyme-linked immunosorbent assay (ELISA), radioimmunoassay (RIA) and fluorescent activated cell sorting (FACS).

A wide variety of labels and conjugation techniques are known by those skilled in the art and can be used in various nucleic and amino acid assays.

A number of companies such as Pharmacia Biotech (Piscataway, N.J.), Promega (Madison, Wis.), and US Biochemical Corp (Cleveland, Ohio) supply commercial kits and protocols for these procedures.

Suitable reporter molecules or labels include, but are not limited to those radionuclides, enzymes, fluorescent, chemiluminescent, or chromogenic agents as well as substrates, cofactors, inhibitors, magnetic particles and the like. Patents teaching the use of such labels include U.S. Pat. No. 3,817,837; U.S. Pat. No. 3,850,752; U.S. Pat. No. 3,939,350; U.S. Pat. No. 3,996,345; U.S. Pat. No. 4,277,437; U.S. Pat. No. 4,275,149 and U.S. Pat. No. 4,366,241.

Also, recombinant immunoglobulins may be produced as shown in U.S. Pat. No. 4,816,567.

### Fusion Proteins

The lipid acyltransferase for use in the present invention may be produced as a fusion protein, for example to aid in extraction and purification thereof. Examples of fusion protein partners include glutathione-S-transferase (GST), 6×His, GAL4 (DNA binding and/or transcriptional activation domains) and β-galactosidase. It may also be convenient to include a proteolytic cleavage site between the fusion protein partner and the protein sequence of interest to allow removal of fusion protein sequences. Preferably the fusion protein will not hinder the activity of the protein sequence.

Gene fusion expression systems in E. coli have been reviewed in Curr. Opin. Biotechnol. (1995) 6(5):501-6.

The amino acid sequence of a polypeptide having the specific properties as defined herein may be ligated to a non-native sequence to encode a fusion protein. For example, for screening of peptide libraries for agents capable of affecting the substance activity, it may be useful to encode a chimeric substance expressing a non-native epitope that is recognized by a commercially available antibody.

The invention will now be further described by way of the following non-limiting examples.

### Example 1

### Expression of a Lipid Acyltransferase (KLM3′) in Bacillus licheniformis

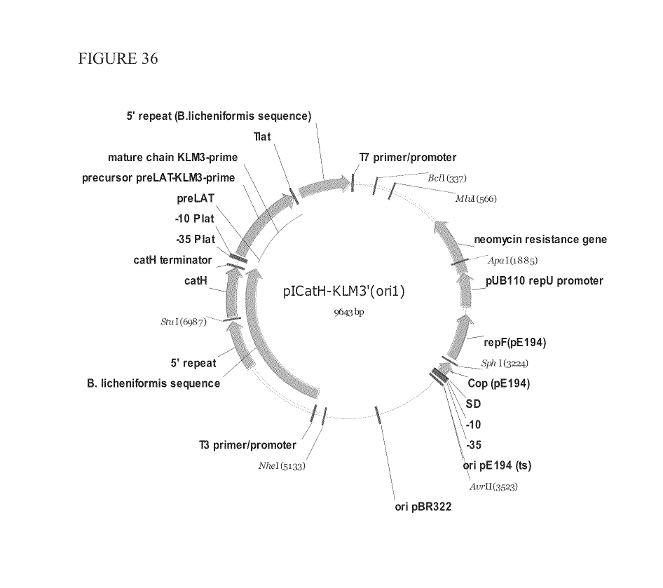

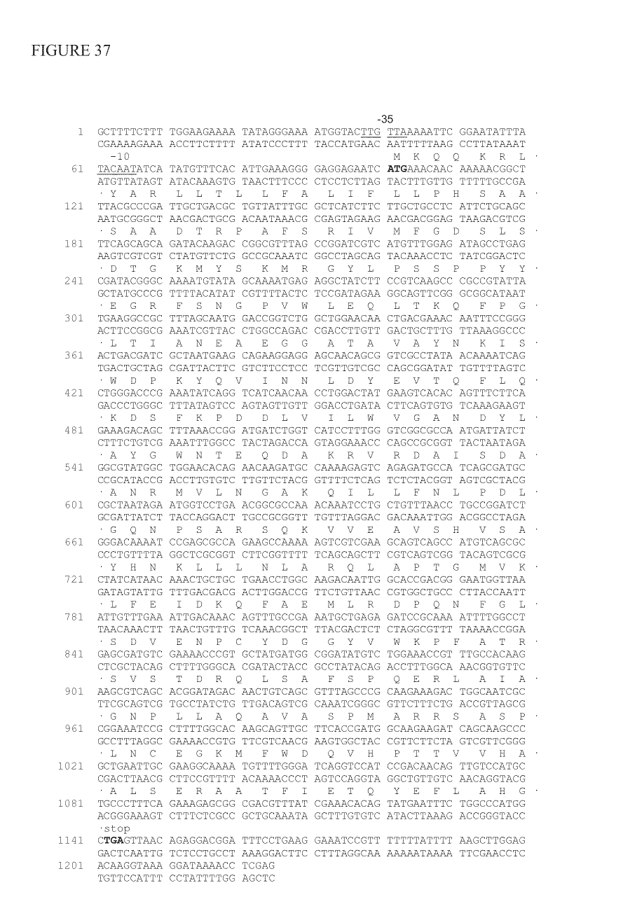

A nucleotide sequence (SEQ ID No. 49) encoding a lipid acyltransferase (SEQ. ID No. 15, hereinafter KLM3′) was expressed in Bacillus licheniformis as a fusion protein with the signal peptide of B. licheniformis [alpha]-amylase (LAT) (see FIGS. 35 and 36). For optimal expression in Bacillus, a codon optimized gene construct (No. 052907) was ordered at Geneart (Geneart AG, Regensburg, Germany).

Construct No. 052907 contains an incomplete LAT promoter (only the -10 sequence) in front of the LAT-KLM3′ precursor gene and the LAT transcription (Tlat) downstream of the LAT-KLM3′ precursor gene (see FIGS. 35 and 36). To create a XhoI fragment that contains the LAT-KLM3′ precursor gene flanked by the complete LAT promoter at the 5′ end and the LAT terminator at the 3′ end, a PCR (polymerase chain reaction) amplification was performed with the primers Plat5XhoI_FW and EBS2XhoI_RV and gene construct 052907 as template.

Plat5XhoI_FW:

ccccgctcgaggcttttcttttggaagaaaatatagggaaaatggtactt
gttaaaaattcggaatatttatacaatatcatatgtttcacattgaaagg
gg

EBS2XhoI_RV:

tggaatctcgaggttttatcctttaccttgtctcc

PCR was performed on a thermocycler with Phusion High Fidelity DNA polymerase (Finnzymes OY, Espoo, Finland) according to the instructions of the manufacturer (annealing temperature of 55° C.).

The resulting PCR fragment was digested with restriction enzyme XhoI and ligated with T4 DNA ligase into XhoI digested pICatH according to the instructions of the supplier (Invitrogen, Carlsbad, Calif. USA).

The ligation mixture was transformed into B. subtilis strain SC6.1 as described in U.S. Patent Application US20020182734 (International Publication WO 02/14490). The sequence of the XhoI insert containing the LAT-KLM3′ precursor gene was confirmed by DNA sequencing (BaseClear, Leiden, The Netherlands) and one of the correct plasmid clones was designated pICatH-KLM3′(ori1) (FIG. 53). plCatH-KLM3′(ori1) was transformed into B. licheniformis strain BML780 (a derivative of BRA7 and BML612, see WO2005111203) at the permissive temperature (37° C.).

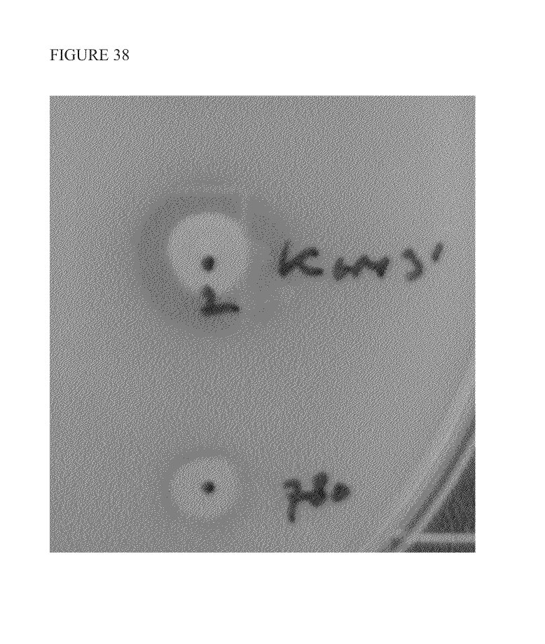

One neomycin resistant (neoR) and chloramphenicol resistant (CmR) transformant was selected and designated BML780(plCatH-KLM3′(ori1)). The plasmid in BML780(plCatH-KLM3′(ori1)) was integrated into the catH region on the B. licheniformis genome by growing the strain at a non-permissive temperature (50[deg.] C.) in medium with 5 [mu]g/ml chloramphenicol. One CmR resistant clone was selected and designated BML780-plCatH-KLM3′(ori1). BML780-plCatH-KLM3′(ori1) was grown again at the permissive temperature for several generations without antibiotics to loop-out vector sequences and then one neomycin sensitive (neoS), CmR clone was selected. In this clone, vector sequences of plCatH on the chromosome are excised (including the neomycin resistance gene) and only the catH-LATKLM3′ cassette is left. Next, the catH-LATKLM3′ cassette on the chromosome was amplified by growing the strain in/on media with increasing concentrations of chloramphenicol. After various rounds of amplification, one clone (resistant against 50 [mu]g/ml chloramphenicol) was selected and designated BML780-KLM3′CAP50. To verify KLM3′expression, BML780-KLM3′CAP50 and BML780 (the empty host strain) were grown for 48 h at 37° C. on a Heart Infusion (Bacto) agar plate with 1% tributyrin. A clearing zone, indicative for lipid acyltransferase activity, was clearly visible around the colony of BML780-KLM3′CAP50 but not around the host strain BML780 (see FIG. 38). This result shows that a substantial amount of KLM3′ is expressed in B. licheniformis strain BML780-KLM3′CAP50 and that these KLM3′ molecules are functional. The expressed KLM3′ protein in a post-translationally clipped sequence—which after post-translational clipping has the amino acid sequence shown in SEQ ID No. 37.

### Example 2

### Use of a Lipid Acyltransferase (KLM3′) to Reduce the Cholesterol Content of (Whilst Maintaining or Improving Weight Loss, Texture and Fat Stability) of Meat Based Food Products (Namely Fine Paste Sausages)

Enzymes tested:
Lipid acyltransferase according to the present invention KLM3′ having SEQ ID No. 37 (3158TrU/g).
Lipomod™ 699L (a pancreatin phospholipase) from BioCatalysts, UK (10,000 Units/ml according to the supplier)—tested for comparative purposes.

### Recipe

TABLE 1
Formulation of fine paste meat batters

| | |
|---|---|
| ingredients | Lot Nr. |

Recipe 1: Control without enzyme

| | | | |
|---|---|---|---|
| | Pork meat S II | 22.50% | 337.5 |
| | beef meat R II | 16.50% | 247.5 |
| | Neck fat Pork | 23.00% | 345.0 |
| | ice/water | 38.00% | 570.0 |
| | | 100.00% | 1500.0 |
| 1 | nitrite curing salt | 1.80% | 27.0 |
| 1 | STPP | 0.10% | 1.5 |
| 2 | ascorbic acid | 0.05% | 0.8 |
| 2 | dextrose | 1.40% | 21.0 |
| 3 | 3% NaCl | | 5 ml |

Recipe 2: KLM3 (0.84 TrU)

| | | | |
|---|---|---|---|
| | pork meat S II | 22.50% | 337.5 |
| | beef meat R II | 16.50% | 247.5 |
| | Neck fat pork | 23.00% | 345.0 |
| | ice/water | 38.00% | 570.0 |
| | | 100.00% | 1500.0 |
| 1 | nitrite curing salt | 1.80% | 27.0 |
| 1 | STPP | 0.10% | 1.5 |
| 2 | ascorbic acid | 0.05% | 0.8 |
| 2 | dextrose | 1.40% | 21.0 |
| 3 | KLM3 | | 0.450 ml |
| 3 | 3% NaCl | | 4.550 ml |

Recipe 3: KLM3 (4.2 TrU)

| | | | |
|---|---|---|---|
| | pork meat S II | 22.50% | 337.5 |
| | beef meat R II | 16.50% | 247.5 |
| | Neck fat pork | 23.00% | 345.0 |
| | ice/water | 38.00% | 570.0 |
| | | 100.00% | 1500.0 |
| 1 | nitrite curing salt | 1.80% | 27.0 |
| 1 | STPP | 0.10% | 1.5 |
| 2 | ascorbic acid | 0.05% | 0.8 |
| 2 | dextrose | 1.40% | 21.0 |
| 3 | KLM3 | | 1.995 ml |
| 3 | 3% NaCl | | 3.005 ml |

Recipe 4: Lipomod (3 LEU/g)

| | | | |
|---|---|---|---|
| | pork meat S II | 22.50% | 337.5 |
| | beef meat R II | 16.50% | 247.5 |
| | Neck fat pork | 23.00% | 345.0 |
| | ice/water | 38.00% | 570.0 |
| | | 100.00% | 1500.0 |
| 1 | nitrite curing salt | 1.80% | 27.0 |
| 1 | STPP | 0.10% | 1.5 |
| 2 | ascorbic acid | 0.05% | 0.8 |
| 2 | dextrose | 1.40% | 21.0 |
| 3 | Lipomod | | 0.450 ml |
| 3 | 3% NaCl | | 4.550 ml |

### Methods

Grind meat separately through 3 mm plate (MADO MEW 512 D)—mixture, cooling at 2° C.

Dissolve the enzyme (either KLM3′ (dosed at either 0.84 TrU/g meat matter or 4.2 TrU/g meat batter) or Lipomod™ (dosed at 3 LEU/g meat matter)) in 100 ml 3% salt water

Place meat with curing salt and phosphate in the Stephan cutter (UMC 5), add ⅓ of ice/water and start cutting for 15 sec at 600 U/min and 15 sec at 1500 U/min

Add ⅓ of ice/water, the 3% NaCl solution with enzyme (or without enzyme in the case of the control) and the dry blend of all other ingredients, continue cutting for 15 sec at 600 U/min—15 sec at 1500 U/min—until 5° C. at 3000 U/min

Add fat/fat emulsion, and the remaining ice/water—15 sec at 600 U/min and 15 sec at 1500 U/min

Scrape the bowl—apply vacuum (80%)—continue chopping for 15 sec at 600 U/min and 15 sec at 1500 U/min—until 12° C. at 3000 U/min

Temperature at the end of the process 12.5° C.

Stuff plastic cups with the meat batter (in total 6 samples×about 220 g) and seal them with plastic foil

The samples were either a) incubated overnight (i.e. 20 h) at 2° C. or b) incubated at 40° C. for 1 h.

After storage, the samples were cooked for 1 h at 75° C. in the steamer—to deactivate the enzyme.

After cooking (99% HR-75° C. to reach 70° C. core temperature), store the meat samples in the fridge ˜5° C.

After overnight cooling, weigh out the cooked meat after drying with absorbent paper.

Texture Measurement

Vacuum pack the samples for 1-week storage test (at ˜2° C.) and weigh out (storage loss).

### Weight Loss

Weight loss on standardized meat samples was recorded as follows:

% weight loss=(g sample before heat treatment−g sample after heat treatment)/g sample before heat treatment

### Texture Measurement

Instrumental texture measurements were performed using a texture analyzer (TAXT). A penetration test was applied using 025 probe positioned 15 mm in the meat sample at a speed of 0.5 mm/s and 5 g as a trigger force. Three replicates of each batch were measured.

### TLC Analysis

Materials:

Standards for TLC analysis.
St16.: 0.5% Soy Lecithin Mix Standard No. SLM45 from SpectraLipids, Germany.
St 17: 0.1% Cholesterol, Sigma C3292; 0.1% Oleic acid, Sigma 01008; 0.1% Cholesterol ester
Cholesterol stearate (Sigma C3549)

Lipid Extraction:
Meat sample was frozen and lyophilized. The dry test sample was ground in a coffee mill.
0.5 g dry meat powder was extracted with chloroform:methanol 2:1 for 30 minutes.
The organic phase was isolated and analyzed by HPTLC.

### HPTLC

HPTLC was used to measure the content of cholesterol (CHL) and phospholipids in the meat samples.
Applicator: CAMAG applicator AST4.
HPTLC plate: 20×10 cm (Merck No. 1.05641)
The plate was activated before use by drying in an oven at 160° C. for 20-30 minutes.
Application: 6.0 μl of extracted lipids dissolved in CHCl₃:methanol (2:1) were applied to the HPTLC plate using AST4 applicator.
0.1, 0.3, 0.5, 0.8, 1.5 μl of a standard solution containing standard components in known concentrations were also applied to the HPTLC plate.
Running buffer 5: Hexane:MTBE (70:30).
Running buffer 6: Chloroform:1-propanol:Methylacetate:Methanol:0.25% KCl in water 25:25:25:10:9.
Elution: The plate was eluted 7 cm using an Automatic Developing Chamber ADC2 from Camag
Elution length: 7 cm
Developing fluid: 6% Cupriacetate in 16% H₃PO₄

After elution, the plate was dried in an oven at 160° C. for 10 minutes, cooled and immersed in the developing fluid (10 sec) and then dried additionally for 6 minutes at 160° C. The plate was evaluated visually and the density was scanned (Camag TLC scanner).

### Results:

### Weight Loss

The table below shows weight loss of fine batter paste incubated at 40° C. for 1 h followed by heat treatment at 75° C. for 1 hr.

| Sample | Weight loss (%) at 40° C. |
|---|---|
| Control | 11% |
| KLM3′ 0.84 TrU/g | 10.3% |
| Lipomod ™ 3LEU/g | 11% |

The table below shows weight loss of fine paste meat batter after 1 week's storage at 2° C. incubated at 40° C. for 1 hr or 2° C. for 20 hrs followed by heat treatment at 75° C. for 1 hr.

| | Weight loss | Weight loss |
|---|---|---|
| Sample | (40° C./1 hour) | (2° C./20 hours) |
| Control | 14.4% | 12.9% |
| KLM3′ 0.84 TrU/g | 13.4% | 12.7% |

The weight losses of the heat-treated fine paste meat batters showed that samples treated with KLM3′ had the lowest weight loss as compared to the control (no enzyme) and the Lipomod™ (phospholipase) sample.

From the results of the 1-week storage test, it was observed that the samples treated with KLM3′ followed by incubation at 2° C. resulted in the lowest weight loss after storage.

### Texture

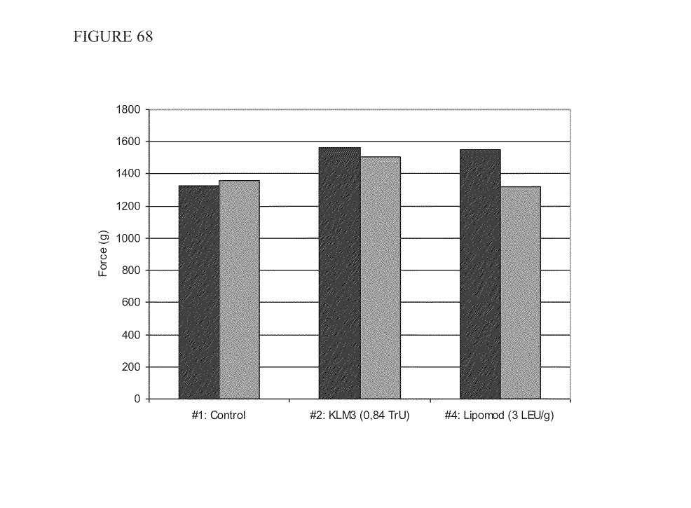

The results from the texture measurements are presented in FIG. 68. The fine paste meat batter treated with KLM3′ had the firmest (most improved) texture compared to the control and Lipomod™-treated samples.

### Appearance and Greasiness (Fat Stability)

The table below shows the results of an assessment of the appearance and greasiness of the meat samples

| | Reaction | |
|---|---|---|
| Sample Enzyme Units/g | Temperature ° C. | Comments |
| Control | 5 | Extremely greasy |
| | 40 | Not greasy |
| 4.2 TrU/g KLM3′ | 5 | Not greasy |
| | 40 | Not greasy |
| 3 Lipomod ™ | 5 | Not greasy |
| | 40 | Very greasy |

### HPTLC Analysis

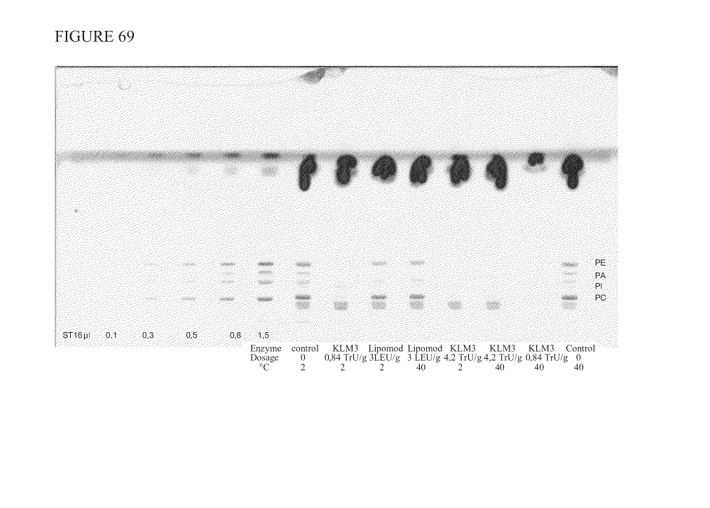

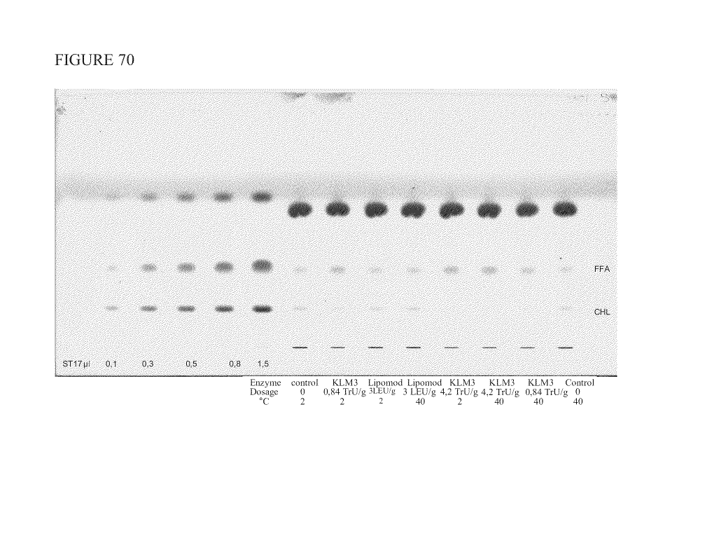

The TLC chromatograms from the analysis are shown in FIGS. 69 and 70.

Based on the standard mixtures, calibration curves for lipid components were constructed and lipid components calculated with results shown in the table below.

TABLE
TLC analysis of lipid components from meat samples. % based on dry weight.

| Sample | | Dosage | Temp. | | | | | | | Sum % |
|---|---|---|---|---|---|---|---|---|---|---|
| no. | Enzyme | Units/g | ° C. | % CHL | % FFA | % PC | % PA | % PE | % PI | Phospholipid |
| 1 | control | 0 | 5 | 0.0065 | 0.015 | 0.380 | 0.054 | 0.240 | 0.155 | 0.830 |
| 2 | KLM3′ | 0.84* | 5 | 0.0042 | 0.028 | 0.033 | 0.019 | 0.017 | 0.019 | 0.087 |
| 3 | Lipomod ™ | 3^{#} | 5 | 0.0057 | 0.016 | 0.291 | 0.024 | 0.131 | 0.084 | 0.528 |
| 4 | Lipomod ™ | 3^{#} | 40 | 0.0062 | 0.018 | 0.344 | 0.022 | 0.156 | 0.094 | 0.615 |
| 5 | KLM3′ | 4.2* | 5 | 0.0031 | 0.029 | 0.015 | 0.021 | 0.007 | 0.011 | 0.054 |
| 6 | KLM3′ | 4.2* | 40 | 0.0031 | 0.031 | 0.016 | 0.019 | 0.003 | 0.008 | 0.046 |
| 7 | KLM3′ | 0.84* | 40 | 0.0032 | 0.020 | 0.000 | 0.000 | 0.005 | 0.000 | 0.005 |
| 8 | Control | 0 | 40 | 0.0056 | 0.015 | 0.401 | 0.054 | 0.214 | 0.095 | 0.764 |

*TrU/g
^{#}LEU/g

The results from FIGS. 69 and 70 and table above confirm activity of KLM3′ and Lipomod™ in the meat sample. The activity of KLM3′ on phospholipids causes degradation of phospholipids to lysophospholipid. The results also confirm a reduction in free cholesterol caused by the transferase reaction catalyzed by KLM3′. Lipomod™, however, did not reduce the cholesterol level significantly. KLM3′ did not only catalyze a transferase reaction, because the amount of free fatty acids also increased in the meat samples which indicate a hydrolytic reaction.

The enzyme reactions were conducted at both 5 and 40° C. and the results confirmed the activity of KLM3′ at 5° C., which for some applications is of interest because it is easier to control microbial growth in meat products at low temperature.

### SUMMARY

From the results obtained in this experiment, positive effects on weight loss and texture were observed in the fine paste meat samples treated with KLM3′ compared to the control.

Analysis of phospholipid degradation by enzyme treatment revealed an extremely high activity of KLM3′, which was not observed with Lipomod™ to the same extent.

The lipid acyltransferase significantly reduced cholesterol in the meat product compared with the control and the Lipomod™ treated sample.

### Example 3

### Use of a Lipid Acyltransferase (KLM3′) to Improve the Taste and/or Texture (Including Mouthfeel and/or Spreadability) of Liver Sausage

Liver sausages are generally produced using an emulsifier in order to reduce the risk of fat separation during thermal processing.

KLM3′ emulsifying effect will be tested in this meat application and compared to an emulsifier, Citrem™ N 12 which is conventionally used in liver sausages.

The liver sausage is based on a recipe containing a low amount of liver and high content of fat/water, which stresses the liver protein matrix emulsifying capacity.

### Material

Citrem™ N 12 veg (Danisco A/S, Denmark)

A lipid acyltransferase (KLM3′) according to the present invention having SEQ ID No. 37

### Meat Mixture

Content meat
mixture

| | (%) | kg |
|---|---|---|
| Pork liver | 15 | 1.2 |
| Pork skin | 15 | 1.2 |
| Back fat | 20 | 1.6 |
| Water hot/Soup | 50 | 4 |
| Total volume | 100 | 8 |

### Recipe:

Recipe 1 ingredients

| | | | |
|---|---|---|---|
| nitrite curing salt | 1.80% | 144.0 | g |
| spices liver sausage | 0.60% | 48.0 | g |
| Carmin | 0.05% | 4.0 | g |
| Dextrose | 1.00% | 80.0 | g |
| ascorbic acid | 0.05% | 4.0 | g |
| Control | 0.00% | 0.0 | g |

Recipe 2 ingredients

| | | | |
|---|---|---|---|
| nitrite curing salt | 1.80% | 144.0 | g |
| spices liver sausage | 0.60% | 48.0 | g |
| Carmin | 0.05% | 4.0 | g |
| Dextrose | 0.50% | 40.0 | g |
| ascorbic acid | 0.05% | 4.0 | g |
| Citrem N 12 veg | 0.50% | 40.0 | g |

Recipe 3 ingredients

| | | | |
|---|---|---|---|
| nitrite curing salt | 1.80% | 144.0 | g |
| spices liver sausage | 0.60% | 48.0 | g |
| Carmin | 0.05% | 4.0 | g |
| Dextrose | 1.00% | 80.0 | g |
| ascorbic acid | 0.05% | 4.0 | g |
| KLM3 diluted in 3% NaCl | 0.84 TrU/g | 2.7 | ml |

### Method

Precook the meat and fat in hot water 75° C. for 45 min.

Place ½ of hot water (65° C.) in the bowl chopper with the meat and fat.

Spray the emulsifier or enzyme on and start chopping highest speed and turn on the steam to obtain a slurry (Smooth and homogeneous) approximately 30 rounds (approx. 10 mins)

Chop until 65° C. and a smooth paste is reached.

Turn of the steam and the chopper and scrape the lid and continue chopping.

Add the rest of the dry ingredients

When the temperature is below 50° C., add the liver and the rest of the ingredients.

Stop chopping when 40° C. is reached

Stuff the meat mix in casing F-plus Kal. 60

Cook the casings, tins and cups for 1 h with a temp. of 76° C.

### Results

### Viscosity in Bowl Chopper

The viscosity of the meat batter added KLM3′ was higher compared with either the control (without enzyme) or the positive control (with the conventional emulsifier Citrem).

### Final Products

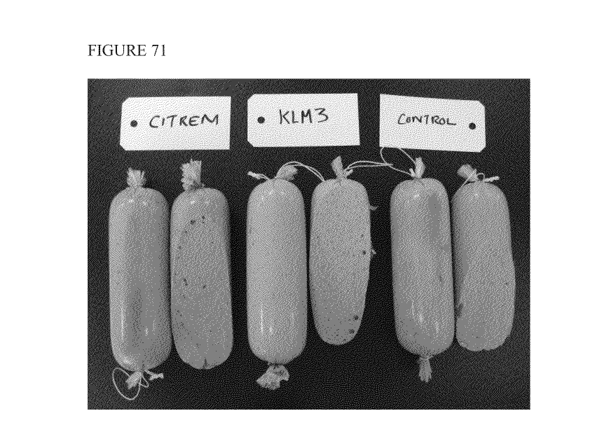

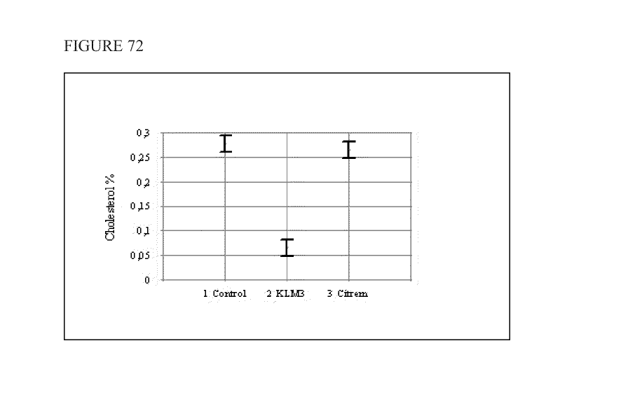

From the visual inspection of the liver sausages presented in FIG. 71 the liver sausage treated with KLM3′ had much less fat extraction compared to the control and liver sausage treated with Citrem™.

Also the colour of the liver sausages treated with KLM3′ was much lighter (better) compared to the control and the liver sausage with Citrem™.

The mouthfeel of the liver sausage treated with KLM3′ was better than the control.

Also the spreadability of liver sausage treated with KLM3′ was much better compared with the control.

### Cholesterol Levels

Cholesterol analysis in liver sausage Example 3 gave the following results, HPTLC analysis of cholesterol in lever sausage samples. % based on dry weight:

| | | | % Cholesterol |
|---|---|---|---|
| | | % Cholesterol | reduction |
| 1 | Control | 0.277 | 0 |
| 2 | KLM3′ | 0.067 | 76 |
| 3 | Citrem | 0.264 | 5 |

Statistical analysis of the results shows no significant differences between control and Citrem.

### SUMMARY

The use of the lipid acyltransferase resulted in improved characteristics, such as reduced fat extraction and increased spreadability in the liver sausage.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in biochemistry and biotechnology or related fields are intended to be within the scope of the following claims.

The invention will now be further described by way of the following numbered paragraphs:

1. A method for reducing the amount of cholesterol and/or improving the texture and/or reducing weight loss and/or increasing the fat stability of a meat based food product comprising:
(a) contacting meat with a lipid acyltransferase;
(b) incubating the meat contacted with the lipid acyltransferase at a temperature between about 1° C. to about 70° C.;
(c) producing a food product from the meat;
wherein step b) is conducted before, during or after step c).

2. A method according to paragraph 1 wherein meat contacted with the lipid acyltransferase is incubated for between about 1 hour to 24 hours.

3. A method according to paragraph 1 or paragraph 2 wherein the meat contacted with the lipid acyltransferase is incubated at a temperature between about 1° C. to about 9° C.

4. A method according to any one of the preceding paragraphs wherein the meat contacted with the lipid acyltransferase is incubated at a temperature between about 1° C. to about 6° C.

5. A method according to paragraph 3 or paragraph 4 wherein the meat contacted with the lipid acyltransferase is incubated for between about 10 to about 24 hours.

6. A method according to paragraph 1 or paragraph 2 wherein the meat contacted with the lipid acyltransferase is incubated at a temperature between about 60° C. to about 70° C.

7. A method according to paragraph 1, paragraph 2 or paragraph 6 wherein the meat contacted with the lipid acyltransferase is incubated at a temperature between about 60° C. to about 68° C.

8. A method according to paragraph 6 or paragraph 7 wherein the meat contacted with the lipid acyltransferase is incubated for between about 30 minutes to about 2 hours.

9. A method according to paragraph 6 or paragraph 7 or paragraph 8 wherein the meat contacted with the lipid acyltransferase is incubated for between about 1 hours to about 1.5 hours.

10. A method according to any one of the preceding paragraphs wherein the meat contacted with the lipid acyltransferase and/or the food product derived therefrom is further heated to a temperature and for a sufficient time to inactivate the enzyme.

11. A method according to paragraph 10 wherein the meat contacted with the lipid acyltransferase and/or the food product derived therefrom is heated to a temperature in the range of about 80° C. to about 140° C.

12. A method according to any one of the preceding paragraphs wherein the meat to be contacted with the lipid acyltransferase is minced meat.

13. A method according to any one of the preceding paragraphs wherein the food product is an emulsified meat product.

14. A method according to any one of the preceding paragraphs wherein the food product comprises at least 15% meat.

15. Use of a lipid acyltransferase for producing a meat based food product. 16. Use according to paragraph 15 wherein the technical effect is a reduction in the amount of cholesterol in the meat based food product compared with a comparative meat based food product where the meat had not been treated with the lipid acyltransferase.

17. Use according to paragraph 15 or paragraph 16 wherein the technical effect is one or more of the following: improving the texture and/or reducing weight loss and/or increasing fat stability in the meat based food product compared with a comparative meat based food product where the meat had not been treated with the lipid acyltransferase.

18. A method according to any one of paragraphs 1-14 or a use according to paragraph 15 or paragraph 17 wherein the lipid acyltransferase is characterized as an enzyme which possesses acyl transferase activity and which comprises the amino acid sequence motif GDSX, wherein X is one or more of the following amino acid residues L, A, V, I, F, Y, H, Q, T, N, M or S.

19. A method according to any one of paragraphs 1-14 or a use according to paragraph 15 or paragraph 17 wherein said lipid acyltransferase when tested using the “Protocol for the determination of % transferase activity” has a transferase activity in the meat based food product of at least 15%, preferably at least 20%, preferably at least 30%, preferably at least 40%.

20. A method to any one of paragraphs 1-14 or a use according to paragraph 15 or paragraph 17 wherein said lipid acyltransferase is a polypeptide having lipid acyltransferase activity which polypeptide is obtained by expression of any one of the nucleotide sequences shown as SEQ ID No. 21, SEQ ID No. 47, SEQ ID No. 25, SEQ ID No. 48, SEQ ID No. 50, SEQ ID No. 51, SEQ ID No. 26, SEQ ID No. 27, SEQ ID No. 28, SEQ ID No. 38, SEQ ID No. 39, SEQ ID No. 40, SEQ ID No. 29, SEQ ID No. 30, SEQ ID No. 31, SEQ ID No. 52, SEQ ID No. 32, SEQ ID No. 33, SEQ ID No. 34, SEQ ID No. 35 or SEQ ID No. 36 or a nucleotide sequence which as has 75% or more identity therewith.

21. A method according to any one of paragraphs 1-14 or a use according to paragraph 15 or paragraph 17 wherein said lipid acyltransferase is a polypeptide having lipid acyltransferase activity which polypeptide is obtained by expression of:
(a) the nucleotide sequence shown as SEQ ID No. 26 or a nucleotide sequence which as has 75% or more identity therewith;
(b) a nucleic acid which encodes said polypeptide wherein said polypeptide is at least 70% identical with the polypeptide sequence shown in SEQ ID No. 15 or with the polypeptide sequence shown in SEQ ID No. 37; or
(c) a nucleic acid which hybridizes under medium stringency conditions to a nucleic probe comprising the nucleotide sequence shown as SEQ ID No. 26.

22. A method according to any one of paragraphs 1-14 or a use according to paragraph 15 or paragraph 17 wherein said lipid acyltransferase is a polypeptide having lipid acyltransferase activity which polypeptide comprises any one of the amino acid sequences shown as SEQ ID No. 1, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 41, SEQ ID No. 11, SEQ ID No. 12, SEQ ID No. 13, SEQ ID No. 14, SEQ ID No. 42, SEQ ID No. 15, SEQ ID No. 19, SEQ ID No. 20, SEQ ID No. 37 or an amino acid sequence which as has 75% or more identity therewith.

23. A method according to any one of paragraphs 1-14 or a use according to paragraph 15 or paragraph 17 wherein the lipid acyltransferase comprises the amino acid sequence shown as SEQ ID No. 37, or an amino acid sequence which has 95% or more identity with SEQ ID No. 37.

24. A method according to any one of paragraphs 1-14 or a use according to paragraph 15 or paragraph 17 wherein the lipid acyltransferase comprises an amino acid sequence which has 98% or more identity with SEQ ID No. 37.

25. A method according to any one of paragraphs 1-14 or a use according to paragraph 15 or paragraph 17 wherein the lipid acyltransferase comprises the amino acid sequence shown as SEQ ID No. 37.

26. A method according to any one of paragraphs 1-14 or a use according to paragraph 15 or paragraph 17 wherein the lipid acyltransferase has the amino acid sequence shown as SEQ ID No. 37.

27. A cholesterol reduced or a cholesterol free meat based food product comprising at least 30% meat and an inactivated lipid acyltransferase.

28. A meat based food product obtainable (e.g. obtained) by the method according to any one of paragraphs 1-14 or paragraphs 18-27.

29. A method, use or meat based food product as generally defined herein with reference to the examples and figures.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for reducing the amount of cholesterol and/or improving the texture and/or reducing weight loss and/or increasing the fat stability of a meat based food product comprising:
(a) contacting meat with a lipid acyltransferase;
(b) incubating the meat contacted with the lipid acyltransferase at a temperature between about 1° C. to about 70° C.;
(c) producing a food product from the meat;
wherein step b) is conducted before, during or after step c).

2. A method according to claim 1 wherein meat contacted with the lipid acyltransferase is incubated for between about 1 hour to 24 hours.

3. A method according to claim 1 wherein the meat contacted with the lipid acyltransferase is incubated at a temperature between about 1° C. to about 9° C.

4. A method according to claim 1 wherein the meat contacted with the lipid acyltransferase is incubated at a temperature between about 1° C. to about 6° C.

5. A method according to claim 3 wherein the meat contacted with the lipid acyltransferase is incubated for between about 10 to about 24 hours.

6. A method according to claim 1 wherein the meat contacted with the lipid acyltransferase is incubated at a temperature between about 60° C. to about 70° C.

7. A method according to claim 1 wherein the meat contacted with the lipid acyltransferase is incubated at a temperature between about 60° C. to about 68° C.

8. A method according to claim 6 wherein the meat contacted with the lipid acyltransferase is incubated for between about 30 minutes to about 2 hours.

9. A method according to claim 6 wherein the meat contacted with the lipid acyltransferase is incubated for between about 1 hours to about 1.5 hours.

10. A method according to claim 1 wherein the meat contacted with the lipid acyltransferase and/or the food product derived therefrom is further heated to a temperature and for a sufficient time to inactivate the enzyme.

11. A method according to claim 10 wherein the meat contacted with the lipid acyltransferase and/or the food product derived therefrom is heated to a temperature in the range of about 80° C. to about 140° C.

12. A method according to claim 1 wherein the meat to be contacted with the lipid acyltransferase is minced meat.

13. A method according to claim 1 wherein the food product is an emulsified meat product.

14. A method according to claim 1 wherein the food product comprises at least 15% meat.

15. Use of a lipid acyltransferase for producing a meat based food product.

16. Use according to claim 15 wherein the technical effect is a reduction in the amount of cholesterol in the meat based food product compared with a comparative meat based food product where the meat had not been treated with the lipid acyltransferase.

17. Use according to claim 15 wherein the technical effect is one or more of the following: improving the texture and/or reducing weight loss and/or increasing fat stability in the meat based food product compared with a comparative meat based food product where the meat had not been treated with the lipid acyltransferase.

18. A method according to claim 1 wherein the lipid acyltransferase is characterized as an enzyme which possesses acyl transferase activity and which comprises the amino acid sequence motif GDSX, wherein X is one or more of the following amino acid residues L, A, V, I, F, Y, H, Q, T, N, M or S.

19. A method according to claim 1 wherein said lipid acyltransferase when tested using the “Protocol for the determination of % transferase activity” has a transferase activity in the meat based food product of at least 15%, preferably at least 20%, preferably at least 30%, preferably at least 40%.

20. A method to claim 1 wherein said lipid acyltransferase is a polypeptide having lipid acyltransferase activity which polypeptide is obtained by expression of any one of the nucleotide sequences shown as SEQ ID No. 21, SEQ ID No. 47, SEQ ID No. 25, SEQ ID No. 48, SEQ ID No. 50, SEQ ID No. 51, SEQ ID No. 26, SEQ ID No. 27, SEQ ID No. 28, SEQ ID No. 38, SEQ ID No. 39, SEQ ID No. 40, SEQ ID No. 29, SEQ ID No. 30, SEQ ID No. 31, SEQ ID No. 52, SEQ ID No. 32, SEQ ID No. 33, SEQ ID No. 34, SEQ ID No. 35 or SEQ ID No. 36 or a nucleotide sequence which as has 75% or more identity therewith.

21. A method according to claim 1 wherein said lipid acyltransferase is a polypeptide having lipid acyltransferase activity which polypeptide is obtained by expression of:
(a) the nucleotide sequence shown as SEQ ID No. 26 or a nucleotide sequence which as has 75% or more identity therewith;
(b) a nucleic acid which encodes said polypeptide wherein said polypeptide is at least 70% identical with the polypeptide sequence shown in SEQ ID No. 15 or with the polypeptide sequence shown in SEQ ID No. 37; or
(c) a nucleic acid which hybridizes under medium stringency conditions to a nucleic probe comprising the nucleotide sequence shown as SEQ ID No. 26.

22. A method according to claim 1 wherein said lipid acyltransferase is a polypeptide having lipid acyltransferase activity which polypeptide comprises any one of the amino acid sequences shown as SEQ ID No. 1, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 41, SEQ ID No. 11, SEQ ID No. 12, SEQ ID No. 13, SEQ ID No. 14, SEQ ID No. 42, SEQ ID No. 15, SEQ ID No. 19, SEQ ID No. 20, SEQ ID No. 37 or an amino acid sequence which as has 75% or more identity therewith.

23. A method according to claim 1 wherein the lipid acyltransferase comprises the amino acid sequence shown as SEQ ID No. 37, or an amino acid sequence which has 95% or more identity with SEQ ID No. 37.

24. A method according to claim 1 wherein the lipid acyltransferase comprises an amino acid sequence which has 98% or more identity with SEQ ID No. 37.

25. A method according to claim 1 wherein the lipid acyltransferase comprises the amino acid sequence shown as SEQ ID No. 37.

26. A method according to claim 1 wherein the lipid acyltransferase has the amino acid sequence shown as SEQ ID No. 37.

27. A cholesterol reduced or a cholesterol free meat based food product comprising at least 30% meat and an inactivated lipid acyltransferase.

28. A meat based food product obtainable (e.g. obtained) by the method according to claim 1.


SEQUENCE LISTING (111 sequences)

SEQ ID NO: 1 - protein, 335 aa, Aeromonas hydrophila
MKKWFVCLLGLVALTVQAADSRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNQLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIANQYEFLAH

SEQ ID NO: 2 - protein, 361 aa, Artificial Sequence
  Consensus sequence
IVAFGDSLTDGEAYYGDSDGGGWGAGLADRLTALLRLRARPRGVDVFNRGISGRTSDGRLIVDALVALLFLAQSLGLPNLPPYLSGDFLRGANFASAGATILPTSGPFLIQVQFKDFKSQVLELRQALGLLQELLRLLPVLDAKSPDLVTIMIGTNDLITSAFFGPKSTESDRNVSVPEFKDNLRQLIKRLRSNNGARIIVLITLVILNLGPLGCLPLKLALALASSKNVDASGCLERLNEAVADFNEALRELAISKLEDQLRKDGLPDVKGADVPYVDLYSIFQDLDGIQNPSAYVYGFETTKACCGYGGRYNYNRVCGNAGLCNVTAKACNPSSYLLSFLFWDGFHPSEKGYKAVAEAL

SEQ ID NO: 3 - protein, 335 aa, Aeromonas hydrophila
MKKWFVCLLGLVALTVQAADSRPAFSRIVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPAATFIESQYEFLAH

SEQ ID NO: 4 - protein, 336 aa, Aeromonas salmonicida
MKKWFVCLLGLIALTVQAADTRPAFSRIVMFGDSLSDTGKMYSKMRGYLPSSPPYYEGRFSNGPVWLEQLTKQFPGLTIANEAEGGATAVAYNKISWNPKYQVYNNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 5 - protein, 295 aa, Streptomyces coelicolor
MPKPALRRVMTATVAAVGTLALGLTDATAHAAPAQATPTLDYVALGDSYSAGSGVLPVDPANLLCLRSTANYPHVIADTTGARLTDVTCGAAQTADFTRAQYPGVAPQLDALGTGTDLVTLTIGGNDNSTFINAITACGTAGVLSGGKGSPCKDRHGTSFDDEIEANTYPALKEALLGVRARAPHARVAALGYPWITPATADPSCFLKLPLAAGDVPYLRAIQAHLNDAVRRAAEETGATYVDFSGVSDGHDACEAPGTRWIEPLLFGHSLVPVHPNALGERRMAEHTMDVLGLD

SEQ ID NO: 6 - protein, 295 aa, Streptomyces coelicolor; identical to SEQ ID NO: 5

SEQ ID NO: 7 - protein, 238 aa, Saccharomyces cerevisiae
MDYEKFLLFGDSITEFAFNTRPIEDGKDQYALGAALVNEYTRKMDILQRGFKGYTSRWALKILPEILKHESNIVMATIFLGANDACSAGPQSVPLPEFIDNIRQMVSLMKSYHIRPIIIGPGLVDREKWEKEKSEEIALGYFRTNENFAIYSDALAKLANEEKVPFVALNKAFQQEGGDAWQQLLTDGLHFSGKGYKIFHDELLKVIETFYPQYHPKNMQYKLKDWRDVLDDGSNIMS

SEQ ID NO: 8 - protein, 347 aa, Ralstonia solanacearum
MNLRQWMGAATAALALGLAACGGGGTDQSGNPNVAKVQRMVVFGDSLSDIGTYTPVAQAVGGGKFTTNPGPIWAETVAAQLGVTLTPAVMGYATSVQNCPKAGCFDYAQGGSRVTDPNGIGHNGGAGALTYPVQQQLANFYAASNNTFNGNNDVVFVLAGSNDIFFWTTAAATSGSGVTPAIATAQVQQAATDLVGYVKDMIAKGATQVYVFNLPDSSLTPDGVASGTTGQALLHALVGTFNTTLQSGLAGTSARIIDFNAQLTAAIQNGASFGFANTSARACDATKINALVPSAGGSSLFCSANTLVASGADQSYLFADGVHPTTAGHRLIASNVLARLLADNVAH

SEQ ID NO: 9 - protein, 261 aa, Streptomyces coelicolor
MIGSYVAVGDSFTEGVGDPGPDGAFVGWADRLAVLLADRRPEGDFTYTNLAVRGRLLDQIVAEQVPRVVGLAPDLVSFAAGGNDIIRPGTDPDEVAERFELAVAALTAAAGTVLVTTGFDTRGVPVLKHLRGKIATYNGHVRAIADRYGCPVLDLWSLRSVQDRRAWDADRLHLSPEGHTRVALRAGQALGLRVPADPDQPWPPLPPRGTLDVRRDDVHWAREYLVPWIGRRLRGESSGDHVTAKGTLSPDAIKTRIAAVA

SEQ ID NO: 10 - protein, 260 aa, Streptomyces coelicolor
MQTNPAYTSLVAVGDSFTEGMSDLLPDGSYRGWADLLATRMAARSPGFRYANLAVRGKLIGQIVDEQVDVAAAMGADVITLVGGLNDTLRPKCDMARVRDLLTQAVERLAPHCEQLVLMRSPGRQGPVLERFRPRMEALFAVIDDLAGRHGAVVVDLYGAQSLADPRMWDVDRLHLTAEGHRRVAEAVWQSLGHEPEDPEWHAPIPATPPPGWVTRRTADVRFARQHLLPWIGRRLTGRSSGDGLPAKRPDLLPYEDPAR

SEQ ID NO: 11 - protein, 340 aa, Streptomyces coelicolor
MTSMSRARVARRIAAGAAYGGGGIGLAGAAAVGLVVAEVQLARRRVGVGTPTRVPNAQGLYGGTLPTAGDPPLRLMMLGDSTAAGQGVHRAGQTPGALLASGLAAVAERPVRLGSVAQPGACSDDLDRQVALVLAEPDRVPDICVIMVGANDVTHRMPATRSVRHLSSAVRRLRTAGAEVVVGTCPDLGTIERVRQPLRWLARRASRQLAAAQTIGAVEQGGRTVSLGDLLGPEFAQNPRELFGPDNYHPSAEGYATAAMAVLPSVCAALGLWPADEEHPDALRREGFLPVARAAAEAASEAGTEVAAAMPTGPRGPWALLKRRRRRRVSEAEPSSPSGV

SEQ ID NO: 12 - protein, 305 aa, Streptomyces coelicolor
MGRGTDQRTRYGRRRARVALAALTAAVLGVGVAGCDSVGGDSPAPSGSPSKRTRTAPAWDTSPASVAAVGDSITRGFDACAVLSDCPEVSWATGSSAKVDSLAVRLLGKADAAEHSWNYAVTGARMADLTAQVTRAAQREPELVAVMAGANDACRSTTSAMTPVADFRAQFEEAMATLRKKLPKAQVYVSSIPDLKRLWSQGRTNPLGKQVWKLGLCPSMLGDADSLDSAATLRRNTVRDRVADYNEVLREVCAKDRRCRSDDGAVHEFRFGTDQLSHWDWFHPSVDGQARLAEIAYRAVTAKNP

SEQ ID NO: 13 - protein, 268 aa, Streptomyces rimosus
MRLSRRAATASALLLTPALALFGASAAVSAPRIQATDYVALGDSYSSGVGAGSYDSSSGSCKRSTKSYPALWAASHTGTRFNFTACSGARTGDVLAKQLTPVNSGTDLVSITIGGNDAGFADTMTTCNLQGESACLARIAKARAYIQQTLPAQLDQVYDAIDSRAPAAQVVVLGYPRFYKLGGSCAVGLSEKSRAAINAAADDINAVTAKRAADHGFAFGDVNTTFAGHELCSGAPWLHSVTLPVENSYHPTANGQSKGYLPVLNSAT

SEQ ID NO: 14 - protein, 336 aa, Aeromonas salmonicida
MKKWFVCLLGLIALTVQAADTRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 15 - protein, 318 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 16 - DNA, 1047 bp, Aeromonas hydrophila
atgtttaagtttaaaaagaatttcttagttggattatcggcagctttaatgagtattagcttgttttcggcaaccgcctctgcagctagcgccgacagccgtcccgccttttcccggatcgtgatgttcggcgacagcctctccgataccggcaaaatgtacagcaagatgcgcggttacctcccctccagcccgccctactatgagggccgtttctccaacggacccgtctggctggagcagctgaccaaacagttcccgggtctgaccatcgccaacgaagcggaaggcggtgccactgccgtggcttacaacaagatctcctggaatcccaagtatcaggtcatcaacaacctggactacgaggtcacccagttcttgcagaaagacagcttcaagccggacgatctggtgatcctctgggtcggtgccaatgactatctggcctatggctggaacacggagcaggatgccaagcgggttcgcgatgccatcagcgatgcggccaaccgcatggtactgaacggtgccaagcagatactgctgttcaacctgccggatctgggccagaacccgtcagctcgcagtcagaaggtggtcgaggcggtcagccatgtctccgcctatcacaaccagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgcgaaccagtacgagttcctcgcccactgatga

SEQ ID NO: 17 - protein, 347 aa, Artificial Sequence
  Fusion construct
MFKFKKNFLVGLSAALMSISLFSATASAASADSRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNQLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIANQYEFLAH

SEQ ID NO: 18 - protein, 300 aa, Corynebacterium efficiens
MRTTVIAASALLLLAGCADGAREETAGAPPGESSGGIREEGAEASTSITDVYIALGDSYAAMGGRDQPLRGEPFCLRSSGNYPELLHAEVTDLTCQGAVTGDLLEPRTLGERTLPAQVDALTEDTTLVTLSIGGNDLGFGEVAGCIRERIAGENADDCVDLLGETIGEQLDQLPPQLDRVHEAIRDRAGDAQVVVTGYLPLVSAGDCPELGDVSEADRRWAVELTGQINETVREAAERHDALFVLPDDADEHTSCAPPQQRWADIQGQQTDAYPLHPTSAGHEAMAAAVRDALGLEPVQP

SEQ ID NO: 19 - protein, 317 aa, Aeromonas hydrophila
ADSRPAFSRIVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPAATFIESQYEFLAH

SEQ ID NO: 20 - protein, 318 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 21 - protein, 1371 aa, Streptomyces thermosacchari
ACAGGCCGATGCACGGAACCGTACCTTTCCGCAGTGAAGCGCTCTCCCCCCATCGTTCGCCGGGACTTCATCCGCGATTTTGGCATGAACACTTCCTTCAACGCGCGTAGCTTGCTACAAGTGCGGCAGCAGACCCGCTCGTTGGAGGCTCAGTGAGATTGACCCGATCCCTGTCGGCCGCATCCGTCATCGTCTTCGCCCTGCTGCTCGCGCTGCTGGGCATCAGCCCGGCCCAGGCAGCCGGCCCGGCCTATGTGGCCCTGGGGGATTCCTATTCCTCGGGCAACGGCGCCGGAAGTTACATCGATTCGAGCGGTGACTGTCACCGCAGCAACAACGCGTACCCCGCCCGCTGGGCGGCGGCCAACGCACCGTCCTCCTTCACCTTCGCGGCCTGCTCGGGAGCGGTGACCACGGATGTGATCAACAATCAGCTGGGCGCCCTCAACGCGTCCACCGGCCTGGTGAGCATCACCATCGGCGGCAATGACGCGGGCTTCGCGGACGCGATGACCACCTGCGTCACCAGCTCGGACAGCACCTGCCTCAACCGGCTGGCCACCGCCACCAACTACATCAACACCACCCTGCTCGCCCGGCTCGACGCGGTCTACAGCCAGATCAAGGCCCGTGCCCCCAACGCCCGCGTGGTCGTCCTCGGCTACCCGCGCATGTACCTGGCCTCGAACCCCTGGTACTGCCTGGGCCTGAGCAACACCAAGCGCGCGGCCATCAACACCACCGCCGACACCCTCAACTCGGTGATCTCCTCCCGGGCCACCGCCCACGGATTCCGATTCGGCGATGTCCGCCCGACCTTCAACAACCACGAACTGTTCTTCGGCAACGACTGGCTGCACTCACTCACCCTGCCGGTGTGGGAGTCGTACCACCCCACCAGCACGGGCCATCAGAGCGGCTATCTGCCGGTCCTCAACGCCAACAGCTCGACCTGATCAACGCACGGCCGTGCCCGCCCCGCGCGTCACGCTCGGCGCGGGCGCCGCAGCGCGTTGATCAGCCCACAGTGCCGGTGACGGTCCCACCGTCACGGTCGAGGGTGTACGTCACGGTGGCGCCGCTCCAGAAGTGGAACGTCAGCAGGACCGTGGAGCCGTCCCTGACCTCGTCGAAGAACTCCGGGGTCAGCGTGATCACCCCTCCCCCGTAGCCGGGGGCGAAGGCGGCGCCGAACTCCTTGTAGGACGTCCAGTCGTGCGGCCCGGCGTTGCCACCGTCCGCGTAGACCGCTTCCATGGTCGCCAGCCGGTCCCCGCGGAACTCGGTGGGGATGTCCGTGCCCAAGGTGGTCCCGGTGGTGTCCGAGAGCACCGGGGGCTCGTACCGGATGATGTGCAGATCCAAAGAATT

SEQ ID NO: 22 - protein, 267 aa, Streptomyces thermosacchari
MRLTRSLSAASVIVFALLLALLGISPAQAAGPAYVALGDSYSSGNGAGSYIDSSGDCHRSNNAYPARWAAANAPSSFTFAACSGAVTTDVINNQLGALNASTGLVSITIGGNDAGFADAMTTCVTSSDSTCLNRLATATNYINTTLLARLDAVYSQIKARAPNARVVVLGYPRMYLASNPWYCLGLSNTKRAAINTTADTLNSVISSRATAHGFRFGDVRPTFNNHELFFGNDWLHSLTLPVWESYHPTSTGHQSGYLPVLNANSST

SEQ ID NO: 23 - protein, 548 aa, Thermobifida fusca
MLPHPAGERGEVGAFFALLVGTPQDRRLRLECHETRPLRGRCGCGERRVPPLTLPGDGVLCTTSSTRDAETVWRKHLQPRPDGGFRPHLGVGCLLAGQGSPGVLWCGREGCRFEVCRRDTPGLSRTRNGDSSPPFRAGWSLPPKCGEISQSARKTPAVPRYSLLRTDRPDGPRGRFVGSGPRAATRRRLFLGIPALVLVTALTLVLAVPTGRETLWRMWCEATQDWCLGVPVDSRGQPAEDGEFLLLSPVQAATWGNYYALGDSYSSGDGARDYYPGTAVKGGCWRSANAYPELVAEAYDFAGHLSFLACSGQRGYAMLDAIDEVGSQLDWNSPHTSLVTIGIGGNDLGFSTVLKTCMVRVPLLDSKACTDQEDAIRKRMAKFETTFEELISEVRTRAPDARILVVGYPRIFPEEPTGAYYTLTASNQRWLNETIQEFNQQLAEAVAVHDEEIAASGGVGSVEFVDVYHALDGHEIGSDEPWVNGVQLRDLATGVTVDRSTFHPNAAGHRAVGERVIEQIETGPGRPLYATFAVVAGATVDTLAGEVG

SEQ ID NO: 24 - protein, 300 aa, Corynebacterium efficiens; identical to SEQ ID NO: 18

SEQ ID NO: 25 - DNA, 3000 bp, Corynebacterium efficiens
ttctggggtgttatggggttgttatcggctcgtcctgggtggatcccgccaggtggggtattcacgggggacttttgtgtccaacagccgagaatgagtgccctgagcggtgggaatgaggtgggcggggctgtgtcgccatgagggggcggcgggctctgtggtgccccgcgacccccggccccggtgagcggtgaatgaaatccggctgtaatcagcatcccgtgcccaccccgtcggggaggtcagcgcccggagtgtctacgcagtcggatcctctcggactcggccatgctgtcggcagcatcgcgctcccgggtcttggcgtccctcggctgttctgcctgctgtccctggaaggcgaaatgatcaccggggagtgatacaccggtggtctcatcccggatgcccacttcggcgccatccggcaattcgggcagctccgggtggaagtaggtggcatccgatgcgtcggtgacgccatagtgggcgaagatctcatcctgctcgagggtgctcaggccactctccggatcgatatcgggggcgtccttgatggcgtccttgctgaaaccgaggtgcagcttgtgggcttccaatttcgcaccacggagcgggacgaggctggaatgacggccgaagagcccgtggtggacctcaacgaaggtgggtagtcccgtgtcatcattgaggaacacgccctccaccgcacccagcttgtggccggagttgtcgtaggcgctggcatccagaagggaaacgatctcatatttgtcggtgtgctcagacatgatcttcctttgctgtcggtgtctggtactaccacggtagggctgaatgcaactgttatttttctgttattttaggaattggtccatatcccacaggctggctgtggtcaaatcgtcatcaagtaatccctgtcacacaaaatgggtggtgggagccctggtcgcggttccgtgggaggcgccgtgccccgcaggatcgtcggcatcggcggatctggccggtaccccgcggtgaataaaatcattctgtaaccttcatcacggttggttttaggtatccgcccctttcgtcctgaccccgtccccggcgcgcgggagcccgcgggttgcggtagacaggggagacgtggacaccatgaggacaacggtcatcgcagcaagcgcattactccttctcgccggatgcgcggatggggcccgggaggagaccgccggtgcaccgccgggtgagtcctccgggggcatccgggaggagggggcggaggcgtcgacaagcatcaccgacgtctacatcgccctcggggattcctatgcggcgatgggcgggcgggatcagccgttacggggtgagccgttctgcctgcgctcgtccggtaattacccggaactcctccacgcagaggtcaccgatctcacctgccagggggcggtgaccggggatctgctcgaacccaggacgctgggggagcgcacgctgccggcgcaggtggatgcgctgacggaggacaccaccctggtcaccctctccatcgggggcaatgacctcggattcggggaggtggcgggatgcatccgggaacggatcgccggggagaacgctgatgattgcgtggacctgctgggggaaaccatcggggagcagctcgatcagcttcccccgcagctggaccgcgtgcacgaggctatccgggaccgcgccggggacgcgcaggttgtggtcaccggttacctgccgctcgtgtctgccggggactgccccgaactgggggatgtctccgaggcggatcgtcgttgggcggttgagctgaccgggcagatcaacgagaccgtgcgcgaggcggccgaacgacacgatgccctctttgtcctgcccgacgatgccgatgagcacaccagttgtgcacccccacagcagcgctgggcggatatccagggccaacagaccgatgcctatccgctgcacccgacctccgccggccatgaggcgatggccgccgccgtccgggacgcgctgggcctggaaccggtccagccgtagcgccgggcgcgcgcttgtcgacgaccaacccatgccaggctgcagtcacatccgcacatagcgcgcgcgggcgatggagtacgcaccatagaggatgagcccgatgccgacgatgatgagcagcacactgccgaagggttgttccccgagggtgcgcagagccgagtccagacctgcggcctgctccggatcatgggcccaaccggcgatgacgatcaacacccccaggatcccgaaggcgataccacgggcgacataaccggctgttccggtgatgatgatcgcggtcccgacctgccctgaccccgcacccgcctccagatcctcccggaaatcccgggtggcccccttccagaggttgtagacacccgcccccagtaccaccagcccggcgaccacaaccagcaccacaccccagggttgggataggacggtggcggtgacatcggtggcggtctccccatcggaggtgctgccgccccgggcgaaggtggaggtggtcaccgccagggagaagtagaccatggccatgaccgcccccttggccctttccttgaggtcctcgcccgccagcagctggctcaattgccagagtcccagggccgccagggcgatgacggcaacccacaggaggaactgcccacccggagcctccgcgatggtggccagggcacctgaattcgaggcctcatcacccgaaccgccggatccagtggcgatgcgcaccgcgatccacccgatgaggatgtgcagtatgcccaggacaatgaaaccacctctggccagggtggtcagcgcggggtggtcctcggcctggtcggcagcccgttcgatcgtccgtttcgcggatctggtgtcgcccttatccatagctcccattgaaccgccttgaggggtgggcggccactgtcagggcggattgtgatctgaactgtgatgttccatcaaccc

SEQ ID NO: 26 - DNA, 1044 bp, Aeromonas salmonicida
atgaaacaacaaaaacggctttacgcccgattgctgacgctgttatttgcgctcatcttcttgctgcctcattctgcagcttcagcagcagatacaagaccggcgtttagccggatcgtcatgtttggagatagcctgagcgatacgggcaaaatgtatagcaaaatgagaggctatcttccgtcaagcccgccgtattatgaaggccgctttagcaatggaccggtctggctggaacaactgacgaaacaatttccgggactgacgatcgctaatgaagcagaaggaggagcaacagcggtcgcctataacaaaatcagctgggacccgaaatatcaggtcatcaacaacctggactatgaagtcacacagtttcttcagaaagacagctttaaaccggatgatctggtcatcctttgggtcggcgccaatgattatctggcgtatggctggaacacagaacaagatgccaaaagagtcagagatgccatcagcgatgccgctaatagaatggtcctgaacggcgccaaacaaatcctgctgtttaacctgccggatctgggacaaaatccgagcgccagaagccaaaaagtcgtcgaagcagtcagccatgtcagcgcctatcataacaaactgctgctgaacctggcaagacaattggcaccgacgggaatggttaaattgtttgaaattgacaaacagtttgccgaaatgctgagagatccgcaaaattttggcctgagcgatgtcgaaaacccgtgctatgatggcggatatgtctggaaaccgtttgccacaagaagcgtcagcacggatagacaactgtcagcgtttagcccgcaagaaagactggcaatcgccggaaatccgcttttggcacaagcagttgcttcaccgatggcaagaagatcagcaagcccgctgaattgcgaaggcaaaatgttttgggatcaggtccatccgacaacagttgtccatgctgccctttcagaaagagcggcgacgtttatcgaaacacagtatgaatttctggcccatggctga

SEQ ID NO: 27 - DNA, 1005 bp, Aeromonas hydrophila
atgaaaaaatggtttgtgtgtttattgggattggtcgcgctgacagttcaggcagccgacagccgtcccgccttctcccggatcgtgatgtttggcgacagcctctccgataccggcaagatgtacagcaagatgcgcggttacctcccctccagccccccctactatgagggccgcttctccaacgggcccgtctggctggagcagctgaccaacgagttcccgggcctgaccatagccaacgaggcggaaggcggaccgaccgccgtggcttacaacaagatctcctggaatcccaagtatcaggtcatcaacaacctggactacgaggtcacccagttcctgcaaaaagacagcttcaagccggacgatctggtgatcctctgggtcggcgccaacgactatctggcctatggctggaacacagagcaggatgccaagcgggtgcgcgacgccatcagcgatgcggccaaccgcatggtgctgaacggcgccaaggagatactgctgttcaacctgccggatctgggccagaacccctcggcccgcagccagaaggtggtcgaggcggccagccatgtctccgcctaccacaaccagctgctgctgaacctggcacgccagctggctcccaccggcatggtgaagctgttcgagatcgacaagcagtttgccgagatgctgcgtgatccgcagaacttcggcctgagcgaccagaggaacgcctgctacggtggcagctatgtatggaagccgtttgcctcccgcagcgccagcaccgacagccagctctccgccttcaacccgcaggagcgcctcgccatcgccggcaacccgctgctggcccaggccgtcgccagccccatggctgcccgcagcgccagcaccctcaactgtgagggcaagatgttctgggatcaggtccaccccaccactgtcgtgcacgccgccctgagcgagcccgccgccaccttcatcgagagccagtacgagttcctcgcccac

SEQ ID NO: 28 - DNA, 1011 bp, Aeromonas salmonicida
atgaaaaaatggtttgtttgtttattggggttgatcgcgctgacagttcaggcagccgacactcgccccgccttctcccggatcgtgatgttcggcgacagcctctccgataccggcaaaatgtacagcaagatgcgcggttacctcccctccagcccgccctactatgagggccgtttctccaacggacccgtctggctggagcagctgaccaagcagttcccgggtctgaccatcgccaacgaagcggaaggcggtgccactgccgtggcttacaacaagatctcctggaatcccaagtatcaggtctacaacaacctggactacgaggtcacccagttcttgcagaaagacagcttcaagccggacgatctggtgatcctctgggtcggtgccaatgactatctggcatatggctggaatacggagcaggatgccaagcgagttcgcgatgccatcagcgatgcggccaaccgcatggtactgaacggtgccaagcagatactgctgttcaacctgccggatctgggccagaacccgtcagcccgcagtcagaaggtggtcgaggcggtcagccatgtctccgcctatcacaacaagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgagacccagtacgagttcctcgcccacggatga

SEQ ID NO: 29 - DNA, 1044 bp, Ralstonia sp.
atgaacctgcgtcaatggatgggcgccgccacggctgcccttgccttgggcttggccgcgtgcgggggcggtgggaccgaccagagcggcaatcccaatgtcgccaaggtgcagcgcatggtggtgttcggcgacagcctgagcgatatcggcacctacacccccgtcgcgcaggcggtgggcggcggcaagttcaccaccaacccgggcccgatctgggccgagaccgtggccgcgcaactgggcgtgacgctcacgccggcggtgatgggctacgccacctccgtgcagaattgccccaaggccggctgcttcgactatgcgcagggcggctcgcgcgtgaccgatccgaacggcatcggccacaacggcggcgcgggggcgctgacctacccggttcagcagcagctcgccaacttctacgcggccagcaacaacacattcaacggcaataacgatgtcgtcttcgtgctggccggcagcaacgacattttcttctggaccactgcggcggccaccagcggctccggcgtgacgcccgccattgccacggcccaggtgcagcaggccgcgacggacctggtcggctatgtcaaggacatgatcgccaagggtgcgacgcaggtctacgtgttcaacctgcccgacagcagcctgacgccggacggcgtggcaagcggcacgaccggccaggcgctgctgcacgcgctggtgggcacgttcaacacgacgctgcaaagcgggctggccggcacctcggcgcgcatcatcgacttcaacgcacaactgaccgcggcgatccagaatggcgcctcgttcggcttcgccaacaccagcgcccgggcctgcgacgccaccaagatcaatgccctggtgccgagcgccggcggcagctcgctgttctgctcggccaacacgctggtggcttccggtgcggaccagagctacctgttcgccgacggcgtgcacccgaccacggccggccatcgcctgatcgccagcaacgtgctggcgcgcctgctggcggataacgtcgcgcactga

SEQ ID NO: 30 - DNA, 786 bp, Streptomyces coelicolor
gtgatcgggtcgtacgtggcggtgggggacagcttcaccgagggcgtcggcgaccccggccccgacggggcgttcgtcggctgggccgaccggctcgccgtactgctcgcggaccggcgccccgagggcgacttcacgtacacgaacctcgccgtgcgcggcaggctcctcgaccagatcgtggcggaacaggtcccgcgggtcgtcggactcgcgcccgacctcgtctcgttcgcggcgggcggcaacgacatcatccggcccggcaccgatcccgacgaggtcgccgagcggttcgagctggcggtggccgcgctgaccgccgcggccggaaccgtcctggtgaccaccgggttcgacacccggggggtgcccgtcctcaagcacctgcgcggcaagatcgccacgtacaacgggcacgtccgcgccatcgccgaccgctacggctgcccggtgctcgacctgtggtcgctgcggagcgtccaggaccgcagggcgtgggacgccgaccggctgcacctgtcgccggaggggcacacccgggtggcgctgcgcgcggggcaggccctgggcctgcgcgtcccggccgaccctgaccagccctggccgcccctgccgccgcgcggcacgctcgacgtccggcgcgacgacgtgcactgggcgcgcgagtacctggtgccgtggatcgggcgccggctgcggggcgagtcgtcgggcgaccacgtgacggccaaggggacgctgtcgccggacgccatcaagacgcggatcgccgcggtggcctga

SEQ ID NO: 31 - DNA, 783 bp, Streptomyces coelicolor
atgcagacgaaccccgcgtacaccagtctcgtcgccgtcggcgactccttcaccgagggcatgtcggacctgctgcccgacggctcctaccgtggctgggccgacctcctcgccacccggatggcggcccgctcccccggcttccggtacgccaacctggcggtgcgcgggaagctgatcggacagatcgtcgacgagcaggtggacgtggccgccgccatgggagccgacgtgatcacgctggtcggcgggctcaacgacacgctgcggcccaagtgcgacatggcccgggtgcgggacctgctgacccaggccgtggaacggctcgccccgcactgcgagcagctggtgctgatgcgcagtcccggtcgccagggtccggtgctggagcgcttccggccccgcatggaggccctgttcgccgtgatcgacgacctggccgggcggcacggcgccgtggtcgtcgacctgtacggggcccagtcgctggccgaccctcggatgtgggacgtggaccggctgcacctgaccgccgagggccaccgccgggtcgcggaggcggtgtggcagtcgctcggccacgagcccgaggaccccgagtggcacgcgccgatcccggcgacgccgccgccggggtgggtgacgcgcaggaccgcggacgtccggttcgcccggcagcacctgctgccctggataggccgcaggctgaccgggcgctcgtccggggacggcctgccggccaagcgcccggacctgctgccctacgaggaccccgcacggtga

SEQ ID NO: 32 - DNA, 1023 bp, Streptomyces coelicolor
atgacgagcatgtcgagggcgagggtggcgcggcggatcgcggccggcgcggcgtacggcggcggcggcatcggcctggcgggagcggcggcggtcggtctggtggtggccgaggtgcagctggccagacgcagggtgggggtgggcacgccgacccgggtgccgaacgcgcagggactgtacggcggcaccctgcccacggccggcgacccgccgctgcggctgatgatgctgggcgactccacggccgccgggcagggcgtgcaccgggccgggcagacgccgggcgcgctgctggcgtccgggctcgcggcggtggcggagcggccggtgcggctggggtcggtcgcccagccgggggcgtgctcggacgacctggaccggcaggtggcgctggtgctcgccgagccggaccgggtgcccgacatctgcgtgatcatggtcggcgccaacgacgtcacccaccggatgccggcgacccgctcggtgcggcacctgtcctcggcggtacggcggctgcgcacggccggtgcggaggtggtggtcggcacctgtccggacctgggcacgatcgagcgggtgcggcagccgctgcgctggctggcccggcgggcctcacggcagctcgcggcggcacagaccatcggcgccgtcgagcagggcgggcgcacggtgtcgctgggcgacctgctgggtccggagttcgcgcagaacccgcgggagctcttcggccccgacaactaccacccctccgccgaggggtacgccacggccgcgatggcggtactgccctcggtgtgcgccgcgctcggcctgtggccggccgacgaggagcacccggacgcgctgcgccgcgagggcttcctgccggtggcgcgcgcggcggcggaggcggcgtccgaggcgggtacggaggtcgccgccgccatgcctacggggcctcgggggccctgggcgctgctgaagcgccggagacggcgtcgggtgtcggaggcggaaccgtccagcccgtccggcgtttga

SEQ ID NO: 33 - DNA, 918 bp, Streptomyces coelicolor
atgggtcgagggacggaccagcggacgcggtacggccgtcgccgggcgcgtgtcgcgctcgccgccctgaccgccgccgtcctgggcgtgggcgtggcgggctgcgactccgtgggcggcgactcacccgctccttccggcagcccgtcgaagcggacgaggacggcgcccgcctgggacaccagcccggcgtccgtcgccgccgtgggcgactccatcacgcgcggcttcgacgcctgtgcggtgctgtcggactgcccggaggtgtcgtgggcgaccggcagcagcgcgaaggtcgactcgctggccgtacggctgctggggaaggcggacgcggccgagcacagctggaactacgcggtcaccggggcccggatggcggacctgaccgctcaggtgacgcgggcggcgcagcgcgagccggagctggtggcggtgatggccggggcgaacgacgcgtgccggtccacgacctcggcgatgacgccggtggcggacttccgggcgcagttcgaggaggcgatggccaccctgcgcaagaagctccccaaggcgcaggtgtacgtgtcgagcatcccggacctcaagcggctctggtcccagggccgcaccaacccgctgggcaagcaggtgtggaagctcggcctgtgcccgtcgatgctgggcgacgcggactccctggactcggcggcgaccctgcggcgcaacacggtgcgcgaccgggtggcggactacaacgaggtgctgcgggaggtctgcgcgaaggaccggcggtgccgcagcgacgacggcgcggtgcacgagttccggttcggcacggaccagttgagccactgggactggttccacccgagtgtggacggccaggcccggctggcggagatcgcctaccgcgcggtcaccgcgaagaatccctga

SEQ ID NO: 34 - DNA, 1068 bp, Streptomyces rimosus
ttcatcacaacgatgtcacaacaccggccatccgggtcatccctgatcgtgggaatgggtgacaagccttcccgtgacgaaagggtcctgctacatcagaaatgacagaaatcctgctcagggaggttccatgagactgtcccgacgcgcggccacggcgtccgcgctcctcctcaccccggcgctcgcgctcttcggcgcgagcgccgccgtgtccgcgccgcgaatccaggccaccgactacgtggccctcggcgactcctactcctcgggggtcggcgcgggcagctacgacagcagcagtggctcctgtaagcgcagcaccaagtcctacccggccctgtgggccgcctcgcacaccggtacgcggttcaacttcaccgcctgttcgggcgcccgcacaggagacgtgctggccaagcagctgaccccggtcaactccggcaccgacctggtcagcattaccatcggcggcaacgacgcgggcttcgccgacaccatgaccacctgcaacctccagggcgagagcgcgtgcctggcgcggatcgccaaggcgcgcgcctacatccagcagacgctgcccgcccagctggaccaggtctacgacgccatcgacagccgggcccccgcagcccaggtcgtcgtcctgggctacccgcgcttctacaagctgggcggcagctgcgccgtcggtctctcggagaagtcccgcgcggccatcaacgccgccgccgacgacatcaacgccgtcaccgccaagcgcgccgccgaccacggcttcgccttcggggacgtcaacacgaccttcgccgggcacgagctgtgctccggcgccccctggctgcacagcgtcacccttcccgtggagaactcctaccaccccacggccaacggacagtccaagggctacctgcccgtcctgaactccgccacctgatctcgcggctactccgcccctgacgaagtcccgcccccgggcggggcttcgccgtaggtgcgcgtaccgccgtcgcccgtcgcgccggtggccccgccgtacgtgccgccgcccccggacgcggtcggttc

SEQ ID NO: 35 - DNA, 1008 bp, Aeromonas hydrophila
atgaaaaaatggtttgtgtgtttattgggattggtcgcgctgacagttcaggcagccgacagtcgccccgccttttcccggatcgtgatgttcggcgacagcctctccgataccggcaaaatgtacagcaagatgcgcggttacctcccctccagcccgccctactatgagggccgtttctccaacggacccgtctggctggagcagctgaccaaacagttcccgggtctgaccatcgccaacgaagcggaaggcggtgccactgccgtggcttacaacaagatctcctggaatcccaagtatcaggtcatcaacaacctggactacgaggtcacccagttcttgcagaaagacagcttcaagccggacgatctggtgatcctctgggtcggtgccaatgactatctggcctatggctggaacacggagcaggatgccaagcgggttcgcgatgccatcagcgatgcggccaaccgcatggtactgaacggtgccaagcagatactgctgttcaacctgccggatctgggccagaacccgtcagctcgcagtcagaaggtggtcgaggcggtcagccatgtctccgcctatcacaaccagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgcgaaccagtacgagttcctcgcccactga

SEQ ID NO: 36 - DNA, 1011 bp, Aeromonas salmonicida
atgaaaaaatggtttgtttgtttattggggttgatcgcgctgacagttcaggcagccgacactcgccccgccttctcccggatcgtgatgttcggcgacagcctctccgataccggcaaaatgtacagcaagatgcgcggttacctcccctccagcccgccctactatgagggccgtttctccaacggacccgtctggctggagcagctgaccaagcagttcccgggtctgaccatcgccaacgaagcggaaggcggtgccactgccgtggcttacaacaagatctcctggaatcccaagtatcaggtcatcaacaacctggactacgaggtcacccagttcttgcagaaagacagcttcaagccggacgatctggtgatcctctgggtcggtgccaatgactatctggcatatggctggaatacggagcaggatgccaagcgagttcgcgatgccatcagcgatgcggccaaccgcatggtactgaacggtgccaagcagatactgctgttcaacctgccggatctgggccagaacccgtcagcccgcagtcagaaggtggtcgaggcggtcagccatgtctccgcctatcacaacaagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgagacccagtacgagttcctcgcccacggatga

SEQ ID NO: 37 - protein, 280 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFRSASPLNCEGKMFWDQVHPTTVVHAALSERAATFIETQYEFLAHG

SEQ ID NO: 38 - DNA, 888 bp, Streptomyces coelicolor
atgccgaagcctgcccttcgccgtgtcatgaccgcgacagtcgccgccgtcggcacgctcgccctcggcctcaccgacgccaccgcccacgccgcgcccgcccaggccactccgaccctggactacgtcgccctcggcgacagctacagcgccggctccggcgtcctgcccgtcgaccccgccaacctgctctgtctgcgctcgacggccaactacccccacgtcatcgcggacacgacgggcgcccgcctcacggacgtcacctgcggcgccgcgcagaccgccgacttcacgcgggcccagtacccgggcgtcgcaccccagttggacgcgctcggcaccggcacggacctggtcacgctcaccatcggcggcaacgacaacagcaccttcatcaacgccatcacggcctgcggcacggcgggtgtcctcagcggcggcaagggcagcccctgcaaggacaggcacggcacctccttcgacgacgagatcgaggccaacacgtaccccgcgctcaaggaggcgctgctcggcgtccgcgccagggctccccacgccagggtggcggctctcggctacccgtggatcaccccggccaccgccgacccgtcctgcttcctgaagctccccctcgccgccggtgacgtgccctacctgcgggccatccaggcacacctcaacgacgcggtccggcgggccgccgaggagaccggagccacctacgtggacttctccggggtgtccgacggccacgacgcctgcgaggcccccggcacccgctggatcgaaccgctgctcttcgggcacagcctcgttcccgtccaccccaacgccctgggcgagcggcgcatggccgagcacacgatggacgtcctcggcctggactga

SEQ ID NO: 39 - DNA, 888 bp, Streptomyces coelicolor
tcagtccaggccgaggacgtccatcgtgtgctcggccatgcgccgctcgcccagggcgttggggtggacgggaacgaggctgtgcccgaagagcagcggttcgatccagcgggtgccgggggcctcgcaggcgtcgtggccgtcggacaccccggagaagtccacgtaggtggctccggtctcctcggcggcccgccggaccgcgtcgttgaggtgtgcctggatggcccgcaggtagggcacgtcaccggcggcgagggggagcttcaggaagcaggacgggtcggcggtggccggggtgatccacgggtagccgagagccgccaccctggcgtggggagccctggcgcggacgccgagcagcgcctccttgagcgcggggtacgtgttggcctcgatctcgtcgtcgaaggaggtgccgtgcctgtccttgcaggggctgcccttgccgccgctgaggacacccgccgtgccgcaggccgtgatggcgttgatgaaggtgctgttgtcgttgccgccgatggtgagcgtgaccaggtccgtgccggtgccgagcgcgtccaactggggtgcgacgcccgggtactgggcccgcgtgaagtcggcggtctgcgcggcgccgcaggtgacgtccgtgaggcgggcgcccgtcgtgtccgcgatgacgtgggggtagttggccgtcgagcgcagacagagcaggttggcggggtcgacgggcaggacgccggagccggcgctgtagctgtcgccgagggcgacgtagtccagggtcggagtggcctgggcgggcgcggcgtgggcggtggcgtcggtgaggccgagggcgagcgtgccgacggcggcgactgtcgcggtcatgacacggcgaagggcaggcttcggcat

SEQ ID NO: 40 - DNA, 717 bp, Saccharomyces cerevisiae
atggattacgagaagtttctgttatttggggattccattactgaatttgcttttaatactaggcccattgaagatggcaaagatcagtatgctcttggagccgcattagtcaacgaatatacgagaaaaatggatattcttcaaagagggttcaaagggtacacttctagatgggcgttgaaaatacttcctgagattttaaagcatgaatccaatattgtcatggccacaatatttttgggtgccaacgatgcatgctcagcaggtccccaaagtgtccccctccccgaatttatcgataatattcgtcaaatggtatctttgatgaagtcttaccatatccgtcctattataataggaccggggctagtagatagagagaagtgggaaaaagaaaaatctgaagaaatagctctcggatacttccgtaccaacgagaactttgccatttattccgatgccttagcaaaactagccaatgaggaaaaagttcccttcgtggctttgaataaggcgtttcaacaggaaggtggtgatgcttggcaacaactgctaacagatggactgcacttttccggaaaagggtacaaaatttttcatgacgaattattgaaggtcattgagacattctacccccaatatcatcccaaaaacatgcagtacaaactgaaagattggagagatgtgctagatgatggatctaacataatgtcttga

SEQ ID NO: 41 - protein, 454 aa, Streptomyces coelicolor
MTRGRDGGAGAPPTKHRALLAAIVTLIVAISAAIYAGASADDGSRDHALQAGGRLPRGDAAPASTGAWVGAWATAPAAAEPGTETTGLAGRSVRNVVHTSVGGTGARITLSNLYGQSPLTVTHASIALAAGPDTAAAIADTMRRLTFGGSARVIIPAGGQVMSDTARLAIPYGANVLVTTYSPIPSGPVTYHPQARQTSYLADGDRTADVTAVAYTTPTPYWRYLTALDVLSHEADGTVVAFGDSITDGARSQSDANHRWTDVLAARLHEAAGDGRDTPRYSVVNEGISGNRLLTSRPGRPADNPSGLSRFQRDVLERTNVKAVVVVLGVNDVLNSPELADRDAILTGLRTLVDRAHARGLRVVGATITPFGGYGGYTEARETMRQEVNEEIRSGRVFDTVVDFDKALRDPYDPRRMRSDYDSGDHLHPGDKGYARMGAVIDLAALKGAAPVKA

SEQ ID NO: 42 - protein, 465 aa, Candida parapsilosis
MRYFAIAFLLINTISAFVLAPKKPSQDDFYTPPQGYEAQPLGSILKTRNVPNPLTNVFTPVKVQNAWQLLVRSEDTFGNPNAIVTTIIQPFNAKKDKLVSYQTFEDSGKLDCAPSYAIQYGSDISTLTTQGEMYYISALLDQGYYVVTPDYEGPKSTFTVGLQSGRATLNSLRATLKSGNLTGVSSDAETLLWGYSGGSLASGWAAAIQKEYAPELSKNLLGAALGGFVTNITATAEAVDSGPFAGIISNALAGIGNEYPDFKNYLLKKVSPLLSITYRLGNTHCLLDGGIAYFGKSFFSRIIRYFPDGWDLVNQEPIKTILQDNGLVYQPKDLTPQIPLFIYHGTLDAIVPIVNSRKTFQQWCDWGLKSGEYNEDLTNGHITESIVGAPAALTWIINRFNGQPPVDGCQHNVRASNLEYPGTPQSIKNYFEAALHAILGFDLGPDVKRDKVTLGGLLKLERFAF

SEQ ID NO: 43 - protein, 372 aa, Thermobifida sp.
MGSGPRAATRRRLFLGIPALVLVTALTLVLAVPTGRETLWRMWCEATQDWCLGVPVDSRGQPAEDGEFLLLSPVQAATWGNYYALGDSYSSGDGARDYYPGTAVKGGCWRSANAYPELVAEAYDFAGHLSFLACSGQRGYAMLDAIDEVGSQLDWNSPHTSLVTIGIGGNDLGFSTVLKTCMVRVPLLDSKACTDQEDAIRKRMAKFETTFEELISEVRTRAPDARILVVGYPRIFPEEPTGAYYTLTASNQRWLNETIQEFNQQLAEAVAVHDEEIAASGGVGSVEFVDVYHALDGHEIGSDEPWVNGVQLRDLATGVTVDRSTFHPNAAGHRAVGERVIEQIETGPGRPLYATFAVVAGATVDTLAGEVG

SEQ ID NO: 44 - protein, 284 aa, Novosphingobium aromaticivorans
MGQVKLFARRCAPVLLALAGLAPAATVAREAPLAEGARYVALGSSFAAGPGVGPNAPGSPERCGRGTLNYPHLLAEALKLDLVDATCSGATTHHVLGPWNEVPPQIDSVNGDTRLVTLTIGGNDVSFVGNIFAAACEKMASPDPRCGKWREITEEEWQADEERMRSIVRQIHARAPLARVVVVDYITVLPPSGTCAAMAISPDRLAQSRSAAKRLARITARVAREEGASLLKFSHISRRHHPCSAKPWSNGLSAPADDGIPVHPNRLGHAEAAAALVKLVKLMK

SEQ ID NO: 45 - protein, 268 aa, Streptomyces coelicolor
MRRFRLVGFLSSLVLAAGAALTGAATAQAAQPAAADGYVALGDSYSSGVGAGSYISSSGDCKRSTKAHPYLWAAAHSPSTFDFTACSGARTGDVLSGQLGPLSSGTGLVSISIGGNDAGFADTMTTCVLQSESSCLSRIATAEAYVDSTLPGKLDGVYSAISDKAPNAHVVVIGYPRFYKLGTTCIGLSETKRTAINKASDHLNTVLAQRAAAHGFTFGDVRTTFTGHELCSGSPWLHSVNWLNIGESYHPTAAGQSGGYLPVLNGAA

SEQ ID NO: 46 - protein, 269 aa, Streptomyces avermitilis
MRRSRITAYVTSLLLAVGCALTGAATAQASPAAAATGYVALGDSYSSGVGAGSYLSSSGDCKRSSKAYPYLWQAAHSPSSFSFMACSGARTGDVLANQLGTLNSSTGLVSLTIGGNDAGFSDVMTTCVLQSDSACLSRINTAKAYVDSTLPGQLDSVYTAISTKAPSAHVAVLGYPRFYKLGGSCLAGLSETKRSAINDAADYLNSAIAKRAADHGFTFGDVKSTFTGHEICSSSTWLHSLDLLNIGQSYHPTAAGQSGGYLPVMNSVA

SEQ ID NO: 47 - DNA, 3000 bp, Thermobifida fusca
ggtggtgaaccagaacacccggtcgtcggcgtgggcgtccaggtgcaggtgcaggttcttcaactgctccagcaggatgccgccgtggccgtgcacgatggccttgggcaggcctgtggtccccgacgagtacagcacccatagcggatggtcgaacggcagcggggtgaactccagttccgcgccttcgcccgcggcttcgaactccgcccaggacagggtgtcggcgacagggccgcagcccaggtacggcaggacgacggtgtgctgcaggctgggcatgccgtcgcgcagggctttgagcacgtcacggcggtcgaagtccttaccgccgtagcggtagccgtccacggccagcagcactttcggttcgatctgcgcgaaccggtcgaggacgctgcgcaccccgaagtcgggggaacaggacgaccaggtcgcaccgatcgcggcgcaggcgaggaatgcggccgtcgcctcggcgatgttcggcaggtaggccacgacccggtcgccggggcccaccccgaggctgcggagggccgcagcgatcgcggcggtgcgggtccgcagttctccccaggtccactcggtcaacggccggagttcggacgcgtgccggatcgccacggctgatgggtcacggtcgcggaagatgtgctcggcgtagttgagggtggcgccggggaaccagacggcgccgggcatggcgtcggaggcgagcactgtggtgtacggggtggcggcgcgcacccggtagtactcccagatcgcggaccagaatccttcgaggtcggttaccgaccagcgccacagtgcctcgtagtccggtgcgtccacaccgcggtgctcccgcacccagcgggtgaacgcggtgaggttggcgcgttctttgcgctcctcgtcgggactccacaggatcggcggctgcggcttgagtgtcatgaaacgcgaccccttcgtggacggtgcggatgcggtgagcgtcgggtgcctcccctaacgctccccggtgacggagtgttgtgcaccacatctagcacgcgggacgcggaaaccgtatggagaaaacacctacaaccccggccggacggtgggtttcggccacacttaggggtcgggtgcctgcttgccgggcagggcagtcccggggtgctgtggtgcgggcgggagggctgtcgcttcgaggtgtgccggcgggacactccgggcctcagccgtacccgcaacggggacagttctcctcccttccgggctggatggtcccttcccccgaaatgcggcgagatctcccagtcagcccggaaaacacccgctgtgcccaggtactctttgcttcgaacagacaggccggacggtccacgggggaggtttgtgggcagcggaccacgtgcggcgaccagacgacggttgttcctcggtatccccgctcttgtacttgtgacagcgctcacgctggtcttggctgtcccgacggggcgcgagacgctgtggcgcatgtggtgtgaggccacccaggactggtgcctgggggtgccggtcgactcccgcggacagcctgcggaggacggcgagtttctgctgctttctccggtccaggcagcgacctgggggaactattacgcgctcggggattcgtactcttcgggggacggggcccgcgactactatcccggcaccgcggtgaagggcggttgctggcggtccgctaacgcctatccggagctggtcgccgaagcctacgacttcgccggacacttgtcgttcctggcctgcagcggccagcgcggctacgccatgcttgacgctatcgacgaggtcggctcgcagctggactggaactcccctcacacgtcgctggtgacgatcgggatcggcggcaacgatctggggttctccacggttttgaagacctgcatggtgcgggtgccgctgctggacagcaaggcgtgcacggaccaggaggacgctatccgcaagcggatggcgaaattcgagacgacgtttgaagagctcatcagcgaagtgcgcacccgcgcgccggacgcccggatccttgtcgtgggctacccccggatttttccggaggaaccgaccggcgcctactacacgctgaccgcgagcaaccagcggtggctcaacgaaaccattcaggagttcaaccagcagctcgccgaggctgtcgcggtccacgacgaggagattgccgcgtcgggcggggtgggcagcgtggagttcgtggacgtctaccacgcgttggacggccacgagatcggctcggacgagccgtgggtgaacggggtgcagttgcgggacctcgccaccggggtgactgtggaccgcagtaccttccaccccaacgccgctgggcaccgggcggtcggtgagcgggtcatcgagcagatcgaaaccggcccgggccgtccgctctatgccactttcgcggtggtggcgggggcgaccgtggacactctcgcgggcgaggtggggtgacccggcttaccgtccggcccgcaggtctgcgagcactgcggcgatctggtccactgcccagtgcagttcgtcttcggtgatgaccagcggcggggagagccggatcgttgagccgtgcgtgtctttgacgagcacaccccgctgcaggagccgttcgcacagttctcttccggtggccagagtcgggtcgacgtcgatcccagcccacaggccgatgctgcgggccgcgaccacgccgttgccgaccagttggtcgaggcgggcgcgcagcacgggggcgagggcgcggacatggtccaggtaagggccgtcgcggacgaggctcaccacggcagtgccgaccgcgcaggcgagggcgttgccgccgaaggtgctgccgtgctggccggggcggatcacgtcgaagacttccgcgtcgcctaccgccgccgccacgggcaggatgccgccgcccagcgctttgccgaacaggtagatatcggcgtcgactccgctgtggtcgcaggcccg

SEQ ID NO: 48 - DNA, 2000 bp, Streptomyces coelicolor
cccggcggcccgtgcaggagcagcagccggcccgcgatgtcctcgggcgtcgtcttcatcaggccgtccatcgcgtcggcgaccggcgccgtgtagttggcccggacctcgtcccaggtgcccgcggcgatctggcgggtggtgcggtgcgggccgcgccgaggggagacgtaccagaagcccatcgtcacgttctccggctgcggttcgggctcgtccgccgctccgtccgtcgcctcgccgagcaccttctcggcgaggtcggcgctggtcgccgtcaccgtgacgtcggcgccccggctccagcgcgagatcagcagcgtccagccgtcgccctccgccagcgtcgcgctgcggtcgtcgtcgcgggcgatccgcagcacgcgcgcgccgggcggcagcagcgtggcgccggaccgtacgcggtcgatgttcgccgcgtgcgagtacggctgctcacccgtggcgaaacggccgaggaacagcgcgtcgacgacgtcggacggggagtcgctgtcgtccacgttgagccggatcggcagggcttcgtgcgggttcacggacatgtcgccatgatcgggcacccggccgccgcgtgcacccgctttcccgggcacgcacgacaggggctttctcgccgtcttccgtccgaacttgaacgagtgtcagccatttcttggcatggacacttccagtcaacgcgcgtagctgctaccacggttgtggcagcaatcctgctaagggaggttccatgagacgtttccgacttgtcggcttcctgagttcgctcgtcctcgccgccggcgccgccctcaccggggcagcgaccgcccaggcggcccaacccgccgccgccgacggctatgtggccctcggcgactcctactcctccggggtcggagcgggcagctacatcagctcgagcggcgactgcaagcgcagcacgaaggcccatccctacctgtgggcggccgcccactcgccctccacgttcgacttcaccgcctgttccggcgcccgtacgggtgatgttctctccggacagctcggcccgctcagctccggcaccggcctcgtctcgatcagcatcggcggcaacgacgccggtttcgccgacaccatgacgacctgtgtgctccagtccgagagctcctgcctgtcgcggatcgccaccgccgaggcgtacgtcgactcgacgctgcccggcaagctcgacggcgtctactcggcaatcagcgacaaggcgccgaacgcccacgtcgtcgtcatcggctacccgcgcttctacaagctcggcaccacctgcatcggcctgtccgagaccaagcggacggcgatcaacaaggcctccgaccacctcaacaccgtcctcgcccagcgcgccgccgcccacggcttcaccttcggcgacgtacgcaccaccttcaccggccacgagctgtgctccggcagcccctggctgcacagcgtcaactggctgaacatcggcgagtcgtaccaccccaccgcggccggccagtccggtggctacctgccggtcctcaacggcgccgcctgacctcaggcggaaggagaagaagaaggagcggagggagacgaggagtgggaggccccgcccgacggggtccccgtccccgtctccgtctccgtcccggtcccgcaagtcaccgagaacgccaccgcgtcggacgtggcccgcaccggactccgcacctccacgcgcacggcactctcgaacgcgccggtgtcgtcgtgcgtcgtcaccaccacgccgtcctggcgcgagcgctcgccgcccgacgggaaggacagcgtccgccaccccggatcggagaccgacccgtccgcggtcacccaccggtagccgacctccgcgggcagccgcccgaccgtgaacgtcgccgtgaacgcgggtgcccggtcgtgcggcggcggacaggcccccgagtagtgggtgcgcgagcccaccacggtcacctccaccgactgcgctgcggggc

SEQ ID NO: 49 - protein, 269 aa, Streptomyces avermitilis; identical to SEQ ID NO: 46

SEQ ID NO: 50 - DNA, 1980 bp, Streptomyces avermitilis
ccaccgccgggtcggcggcgagtctcctggcctcggtcgcggagaggttggccgtgtagccgttcagcgcggcgccgaacgtcttcttcaccgtgccgccgtactcgttgatcaggcccttgcccttgctcgacgcggccttgaagccggtgcccttcttgagcgtgacgatgtagctgcccttgatcgcggtgggggagccggcggcgagcaccgtgccctcggccggggtggcctgggcgggcagtgcggtgaatccgcccacgagggcgccggtcgccacggcggttatcgcggcgatccggatcttcttgctacgcagctgtgccatacgagggagtcctcctctgggcagcggcgcgcctgggtggggcgcacggctgtggggggtgcgcgcgtcatcacgcacacggccctggagcgtcgtgttccgccctgggttgagtaaagcctcggccatctacgggggtggctcaagggagttgagaccctgtcatgagtctgacatgagcacgcaatcaacggggccgtgagcaccccggggcgaccccggaaagtgccgagaagtcttggcatggacacttcctgtcaacacgcgtagctggtacgacggttacggcagagatcctgctaaagggaggttccatgagacgttcccgaattacggcatacgtgacctcactcctcctcgccgtcggctgcgccctcaccggggcagcgacggcgcaggcgtccccagccgccgcggccacgggctatgtggccctcggcgactcgtactcgtccggtgtcggcgccggcagctacctcagctccagcggcgactgcaagcgcagttcgaaggcctatccgtacctctggcaggccgcgcattcaccctcgtcgttcagtttcatggcttgctcgggcgctcgtacgggtgatgtcctggccaatcagctcggcaccctgaactcgtccaccggcctggtctccctcaccatcggaggcaacgacgcgggcttctccgacgtcatgacgacctgtgtgctccagtccgacagcgcctgcctctcccgcatcaacacggcgaaggcgtacgtcgactccaccctgcccggccaactcgacagcgtgtacacggcgatcagcacgaaggccccgtcggcccatgtggccgtgctgggctacccccgcttctacaaactgggcggctcctgcctcgcgggcctctcggagaccaagcggtccgccatcaacgacgcggccgactatctgaacagcgccatcgccaagcgcgccgccgaccacggcttcaccttcggcgacgtcaagagcaccttcaccggccatgagatctgctccagcagcacctggctgcacagtctcgacctgctgaacatcggccagtcctaccacccgaccgcggccggccagtccggcggctatctgccggtcatgaacagcgtggcctgagctcccacggcctgaatttttaaggcctgaatttttaaggcgaaggtgaaccggaagcggaggccccgtccgtcggggtctccgtcgcacaggtcaccgagaacggcacggagttggacgtcgtgcgcaccgggtcgcgcacctcgacggcgatctcgttcgagatcgttccgctcgtgtcgtacgtggtgacgaacacctgcttctgctgggtctttccgccgctcgccgggaaggacagcgtcttccagcccggatccgggacctcgcccttcttggtcacccagcggtactccacctcgaccggcacccggcccaccgtgaaggtcgccgtgaacgtgggcgcctgggcggtgggcggcgggcaggcaccggagtagtcggtgtgcacgccggtgaccgtcaccttcacggactgggccggcggggtcgtcgtaccgccgccgccaccgccgcctcccggagtggagcccgagctgtggtcgcccccgccgtcggcgttgtcgtcctcgggggttttcgaac

SEQ ID NO: 51 - DNA, 968 bp, Thermobifida fusca
ctgcagacacccgccccgccttctcccggatcgtcatgttcggcgactccctcagcgacaccggcaagatgtactccaagatgcgcggctacctgccgtcctccccgccgtactacgagggccgcttctcgaacggcccggtctggctggagcagctgacgaagcagttccccggcctgacgatcgccaacgaggccgaggggggcgcgaccgcagtcgcctacaacaagatctcctggaacccgaagtaccaggtcattaacaacctcgactacgaggtcacccagttcttgcagaaggactcgttcaagcccgacgacctggtcatcctgtgggtgggcgccaacgactacctggcctacggttggaacacggagcaggacgccaagcgggtgcgcgacgccatctcggacgcggcaaaccgcatggtcctgaacggcgcgaagcagatcctgctgttcaacctgcccgacctgggccagaacccgtccgcccgctcccagaaggtcgtcgaggccgtctcgcacgtgtccgcctaccacaacaagctgctcctcaacctcgcccggcagctcgccccgacgggcatggtcaagctgttcgagatcgacaagcagttcgcggagatgctgcgcgacccccagaacttcggcctgagcgacgtggagaacccgtgctacgacggcggctacgtgtggaagccgttcgccacccggtccgtctcgaccgaccggcagctgtcggccttctcgccccaggagcgcctggcgatcgctggcaacccgctcctggcacaggcggtagcttcgccgatggcccgccgctcggcctcgcccctcaactgcgagggcaagatgttctgggaccaggtccaccccaccaccgtggtccacgccgccctctcggagcgcgccgccaccttcatcgagacccagtacgagttcctcgcccactagtctagaggatcc

SEQ ID NO: 52 - DNA, 1365 bp, Streptomyces coelicolor
atgacccggggtcgtgacgggggtgcgggggcgccccccaccaagcaccgtgccctgctcgcggcgatcgtcaccctgatagtggcgatctccgcggccatatacgccggagcgtccgcggacgacggcagcagggaccacgcgctgcaggccggaggccgtctcccacgaggagacgccgcccccgcgtccaccggtgcctgggtgggcgcctgggccaccgcaccggccgcggccgagccgggcaccgagacgaccggcctggcgggccgctccgtgcgcaacgtcgtgcacacctcggtcggcggcaccggcgcgcggatcaccctctcgaacctgtacgggcagtcgccgctgaccgtcacacacgcctcgatcgccctggccgccgggcccgacaccgccgccgcgatcgccgacaccatgcgccggctcaccttcggcggcagcgcccgggtgatcatcccggcgggcggccaggtgatgagcgacaccgcccgcctcgccatcccctacggggcgaacgtcctggtcaccacgtactcccccatcccgtccgggccggtgacctaccatccgcaggcccggcagaccagctacctggccgacggcgaccgcacggcggacgtcaccgccgtcgcgtacaccacccccacgccctactggcgctacctgaccgccctcgacgtgctgagccacgaggccgacggcacggtcgtggcgttcggcgactccatcaccgacggcgcccgctcgcagagcgacgccaaccaccgctggaccgacgtcctcgccgcacgcctgcacgaggcggcgggcgacggccgggacacgccccgctacagcgtcgtcaacgagggcatcagcggcaaccggctcctgaccagcaggccggggcggccggccgacaacccgagcggactgagccggttccagcgggacgtgctggaacgcaccaacgtcaaggccgtcgtcgtcgtcctcggcgtcaacgacgtcctgaacagcccggaactcgccgaccgcgacgccatcctgaccggcctgcgcaccctcgtcgaccgggcgcacgcccggggactgcgggtcgtcggcgccacgatcacgccgttcggcggctacggcggctacaccgaggcccgcgagacgatgcggcaggaggtcaacgaggagatccgctccggccgggtcttcgacacggtcgtcgacttcgacaaggccctgcgcgacccgtacgacccgcgccggatgcgctccgactacgacagcggcgaccacctgcaccccggcgacaaggggtacgcgcgcatgggcgcggtcatcgacctggccgcgctgaagggcgcggcgccggtcaaggcgtag

SEQ ID NO: 53 - protein, 372 aa, Thermobifida fusca
VGSGPRAATRRRLFLGIPALVLVTALTLVLAVPTGRETLWRMWCEATQDWCLGVPVDSRGQPAEDGEFLLLSPVQAATWGNYYALGDSYSSGDGARDYYPGTAVKGGCWRSANAYPELVAEAYDFAGHLSFLACSGQRGYAMLDAIDEVGSQLDWNSPHTSLVTIGIGGNDLGFSTVLKTCMVRVPLLDSKACTDQEDAIRKRMAKFETTFEELISEVRTRAPDARILVVGYPRIFPEEPTGAYYTLTASNQRWLNETIQEFNQQLAEAVAVHDEEIAASGGVGSVEFVDVYHALDGHEIGSDEPWVNGVQLRDLATGVTVDRSTFHPNAAGHRAVGERVIEQIETGPGRPLYATFAVVAGATVDTLAGEVG

SEQ ID NO: 54 - protein, 18 aa, Aeromonas sp.
MKKWFVCLLGLIALTVQA

SEQ ID NO: 55 - protein, 29 aa, Bacillus subtilis
MRSKKLWISLLFALTLIFTMAFSNMSAQA

SEQ ID NO: 56 - protein, 29 aa, Bacillus licheniformis
MMRKKSFWFGMLTAFMLVFTMEFSDSASA

SEQ ID NO: 57 - DNA, 51 bp, Artificial Sequence
  Terminator sequence
cgggacttaccgaaagaaaccatcaatgatggtttcttttttgttcataaa

SEQ ID NO: 58 - DNA, 59 bp, Artificial Sequence
  Terminator sequence
caagactaaagaccgttcgcccgtttttgcaataagcgggcgaatcttacataaaaata

SEQ ID NO: 59 - DNA, 61 bp, Artificial Sequence
  Terminator sequence
acggccgttagatgtgacagcccgttccaaaaggaagcgggctgtcttcgtgtattattgt

SEQ ID NO: 60 - DNA, 54 bp, Artificial Sequence
  Terminator sequence
tcttttaaaggaaaggctggaatgcccggcattccagccacatgatcatcgttt

SEQ ID NO: 61 - DNA, 56 bp, Artificial Sequence
  Terminator sequence
gctgacaaataaaaagaagcaggtatggaggaacctgcttctttttactattattg

SEQ ID NO: 62 - DNA, 102 bp, Artificial Sequence
  Primer Plat5XhoI_FW
ccccgctcgaggcttttcttttggaagaaaatatagggaaaatggtacttgttaaaaattcggaatatttatacaatatcatatgtttcacattgaaagggg

SEQ ID NO: 63 - DNA, 35 bp, Artificial Sequence
  Primer EBS2XhoI_RV
tggaatctcgaggttttatcctttaccttgtctcc

SEQ ID NO: 64 - protein, 8 aa, Artificial Sequence
  Consensus sequence
MRRSRFLA

SEQ ID NO: 65 - protein, 8 aa, Artificial Sequence
  Consensus sequence
ALILLTLA

SEQ ID NO: 66 - protein, 5 aa, Artificial Sequence
  Consensus sequence
ARAAP

SEQ ID NO: 67 - protein, 11 aa, Artificial Sequence
  Consensus sequence
YVALGDSYSSG

SEQ ID NO: 68 - protein, 5 aa, Artificial Sequence
  Consensus sequence
GAGSY

SEQ ID NO: 69 - protein, 4 aa, Artificial Sequence
  Consensus sequence
SSGD

SEQ ID NO: 70 - protein, 15 aa, Artificial Sequence
  Consensus sequence
RSTKAYPALWAAAHA

SEQ ID NO: 71 - protein, 5 aa, Artificial Sequence
  Consensus sequence
SSFSF

SEQ ID NO: 72 - protein, 12 aa, Artificial Sequence
  Consensus sequence
ACSGARTYDVLA

SEQ ID NO: 73 - protein, 15 aa, Artificial Sequence
  Consensus sequence
LVSITIGGNDAGFAD

SEQ ID NO: 74 - protein, 6 aa, Artificial Sequence
  Consensus sequence
MTTCVL

SEQ ID NO: 75 - protein, 6 aa, Artificial Sequence
  Consensus sequence
SDSACL

SEQ ID NO: 76 - protein, 4 aa, Artificial Sequence
  Consensus sequence
TLPA

SEQ ID NO: 77 - protein, 9 aa, Artificial Sequence
  Consensus sequence
RLDSVYSAI

SEQ ID NO: 78 - protein, 4 aa, Artificial Sequence
  Consensus sequence
TRAP

SEQ ID NO: 79 - protein, 12 aa, Artificial Sequence
  Consensus sequence
ARVVVLGYPRIY

SEQ ID NO: 80 - protein, 4 aa, Artificial Sequence
  Consensus sequence
LGLS

SEQ ID NO: 81 - protein, 11 aa, Artificial Sequence
  Consensus sequence
TKRAAINDAAD

SEQ ID NO: 82 - protein, 12 aa, Artificial Sequence
  Consensus sequence
LNSVIAKRAADH

SEQ ID NO: 83 - protein, 7 aa, Artificial Sequence
  Consensus sequence
GFTFGDV

SEQ ID NO: 84 - protein, 7 aa, Artificial Sequence
  Consensus sequence
GHELCSA

SEQ ID NO: 85 - protein, 9 aa, Artificial Sequence
  Consensus sequence
PWLHSLTLP

SEQ ID NO: 86 - protein, 6 aa, Artificial Sequence
  Consensus sequence
SYHPTA

SEQ ID NO: 87 - protein, 13 aa, Artificial Sequence
  Consensus sequence
GHAAGYLPVLNSI

SEQ ID NO: 88 - protein, 232 aa, Aspergillus aculeatus
TTVYLAGDSTMAKNGGGSGTNGWGEYLASYLSATVVNDAVAGRSARSYTREGRFENIADVVTAGDYVIVEFGHNDGGSLSTDNGRTDCSGTGAEVCYSVYDGVNETILTFPAYLENAAKLFTAKGAKVILSSQTPNNPWETGTFVNSPTRFVEYAELAAEVAGVEYVDHWSYVDSIYETLGNATVNSYFPIDHTHTSPAGAEVVAEAFLKAVVCTGTSLKSVLTTTSFEGTC

SEQ ID NO: 89 - protein, 184 aa, Escherichia coli
ADTLLILGDSLSAGYRMSASAAWPALLNDKWQSKTSVVNASISGDTSQQGLARLPALLKQHQPRWVLVELGGNDGLRGFQPQQTEQTLRQILQDVKAANAEPLLMQIRLPANYGRRYNEAFSAIYPKLAKEFDVPLLPFFMEEVYLKPQWMQDDGIHPNRDAQPFIADWMAKQLQPLVNHDSLE

SEQ ID NO: 90 - protein, 308 aa, Aeromonas hydrophila
IVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPAATFIESQYEFLAH

SEQ ID NO: 91 - protein, 167 aa, Escherichia coli
LLILGDSLSAGYRMSASAAWPALLNDKWQSKTSVVNASISGDTSQQGLARLPALLKQHQPRWVLVELGGNDGLRGFQPQQTEQTLRQILQDVKAANAEPLLMQIRLPANYGRRYNEAFSAIYPKLAKEFDVPLLPFFMEEVYLKPQWMQDDGIHPNRDAQPFIADWM

SEQ ID NO: 92 - protein, 295 aa, Aeromonas hydrophila
IVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPA

SEQ ID NO: 93 - protein, 335 aa, Aeromonas hydrophila; identical to SEQ ID NO: 3

SEQ ID NO: 94 - protein, 318 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWNPKYQVYNNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 95 - protein, 50 aa, Artificial Sequence
  Consensus sequence
RPAFSRIVMFGDSLSDTGKMYSKMRGYLPSSPPYYEGRFSNGPVWLEQLT

SEQ ID NO: 96 - protein, 13 aa, Artificial Sequence
  Consensus sequence
FPGLTIANEAEGG

SEQ ID NO: 97 - protein, 79 aa, Artificial Sequence
  Consensus sequence
TAVAYNKISWNPKYQVINNLDYEVTQFLQKDSFKPDDLVILWVGANDYLAYGWNTEQDAKRVRDAISDAANRMVLNGAK

SEQ ID NO: 98 - protein, 23 aa, Artificial Sequence
  Consensus sequence
ILLFNLPDLGQNPSARSQKVVEA

SEQ ID NO: 99 - protein, 8 aa, Artificial Sequence
  Consensus sequence
SHVSAYHN

SEQ ID NO: 100 - protein, 38 aa, Artificial Sequence
  Consensus sequence
LLLNLARQLAPTGMVKLFEIDKQFAEMLRDPQNFGLSD

SEQ ID NO: 101 - protein, 7 aa, Artificial Sequence
  Consensus sequence
YVWKPFA

SEQ ID NO: 102 - protein, 5 aa, Artificial Sequence
  Consensus sequence
QLSAF

SEQ ID NO: 103 - protein, 22 aa, Artificial Sequence
  Consensus sequence
PQERLAIAGNPLLAQAVASPMA

SEQ ID NO: 104 - protein, 4 aa, Artificial Sequence
  Consensus sequence
RSAS

SEQ ID NO: 105 - protein, 24 aa, Artificial Sequence
  Consensus sequence
LNCEGKMFWDQVHPTTVVHAALSE

SEQ ID NO: 106 - protein, 5 aa, Artificial Sequence
  Consensus sequence
AATFI

SEQ ID NO: 107 - protein, 7 aa, Artificial Sequence
  Consensus sequence
QYEFLAH

SEQ ID NO: 108 - DNA, 1225 bp, Artificial Sequence
  XhoI insert containing the LAT-KLM3′ precursor gene
gcttttcttttggaagaaaatatagggaaaatggtacttgttaaaaattcggaatatttatacaatatcatatgtttcacattgaaaggggaggagaatcatgaaacaacaaaaacggctttacgcccgattgctgacgctgttatttgcgctcatcttcttgctgcctcattctgcagcttcagcagcagatacaagaccggcgtttagccggatcgtcatgtttggagatagcctgagcgatacgggcaaaatgtatagcaaaatgagaggctatcttccgtcaagcccgccgtattatgaaggccgctttagcaatggaccggtctggctggaacaactgacgaaacaatttccgggactgacgatcgctaatgaagcagaaggaggagcaacagcggtcgcctataacaaaatcagctgggacccgaaatatcaggtcatcaacaacctggactatgaagtcacacagtttcttcagaaagacagctttaaaccggatgatctggtcatcctttgggtcggcgccaatgattatctggcgtatggctggaacacagaacaagatgccaaaagagtcagagatgccatcagcgatgccgctaatagaatggtcctgaacggcgccaaacaaatcctgctgtttaacctgccggatctgggacaaaatccgagcgccagaagccaaaaagtcgtcgaagcagtcagccatgtcagcgcctatcataacaaactgctgctgaacctggcaagacaattggcaccgacgggaatggttaaattgtttgaaattgacaaacagtttgccgaaatgctgagagatccgcaaaattttggcctgagcgatgtcgaaaacccgtgctatgatggcggatatgtctggaaaccgtttgccacaagaagcgtcagcacggatagacaactgtcagcgtttagcccgcaagaaagactggcaatcgccggaaatccgcttttggcacaagcagttgcttcaccgatggcaagaagatcagcaagcccgctgaattgcgaaggcaaaatgttttgggatcaggtccatccgacaacagttgtccatgctgccctttcagaaagagcggcgacgtttatcgaaacacagtatgaatttctggcccatggctgagttaacagaggacggatttcctgaaggaaatccgtttttttattttaagcttggagacaaggtaaaggataaaacctcgag

SEQ ID NO: 109 - protein, 347 aa, Artificial Sequence
  Synthetic Construct
MKQQKRLYARLLTLLFALIFLLPHSAASAADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 110 - protein, 4 aa, Artificial Sequence
  Sequence motif
GDSX

SEQ ID NO: 111 - protein, 5 aa, Artificial Sequence
  Sequence motif
GXNDX